(19) United States
(12) Patent Application Publication
(10) Pub. No.: US 2009/0177561 A1
(43) Pub. Date: Jul. 9, 2009

(54) Method and System for Statement of Cash Flow

(76) Inventor: Han Yong KO, Seoul (KR)

Correspondence Address: PARK LAW FIRM, 3255 WILSHIRE BLVD, SUITE 1110, LOS ANGELES, CA, 90010, US

(21) Appl. No.: 12/211,016

(22) Filed: Sep. 15, 2008

(30) Foreign Application Priority Data
Sep. 14, 2007 (KR) 10-2007-93754

(51) Int. Cl. G06Q 10/00

(52) U.S. Cl. 705/30

(57) ABSTRACT

The present invention relates to a method and a system for providing a statement of cash flow and supplementary statements of the statement of cash flow, especially the method and the system for automatically providing the statement of cash flow by direct method, the method and the system for automatically providing the statement of cash flow by indirect method, and the method and the system for automatically providing the supplementary statements of the statement of cash flow.

### BACKGROUND OF THE INVENTION

1. Technical Field

The present invention relates to a method and a system for providing a statement of cash flow and supplementary statements of the statement of cash flow, especially the method and the system for automatically providing the statement of cash flow by direct method, the method and the system for automatically providing the statement of cash flow by indirect method, and the method and the system for automatically providing the supplementary statements of the statement of cash flow.

2. Background Art

There are direct method and indirect method in making the statement of cash flow, which are included in the main financial statements along with a balance sheet, a loss & profit statement, and a statement of appropriations of retained earnings.

The direct method shows cash flows from operating activities by a source of cash inflows and a use of cash outflows, and provides more useful information than indirect method in the predictability aspect by describing cash flows regarding the cost related to main profitable operations. Accordingly, the statement of cash flow by direct method further meets an original object of the statement of cash flow.

Since an original accounting system is based on accrual basis, it cannot make the statement of cash flow by direct method which can be made only by cash basis. In case of re-inputting all accounting information by cash basis, the statement of cash flow by direct method can be made, however, an increase in an accounting operation cost due to this can be too much burden for corporations.

The indirect method provides information with regard to a difference between current period net income and net cash flows from operating activities. Since information of the current period net income by the loss & profit statement is useful for evaluating and predicting future earning power, the information with regard to the difference between the current period net income and net cash flows from operating activities is also useful for analyzing and evaluating the corporations.

However, since the indirect method makes the statement of cash flow by reversely tracing non-cash account, which affects the current period net income in the accounting system by the prior accrual basis, an account settlement should be completed and the current period net income should be established. As a result, indirect method cannot provide an accounting operation and the statement of cash flow at the same time. Additionally, since indirect method requires additional information, which are not described in the balance sheet and the loss & profit statement, and related to the non-cash accounts (for example, information on depreciation of a manufacturing statement, etc.), the indirect method is difficult to be automated. At present, this is mostly made by external experts by manual procedures.

Accordingly, in a double-entry bookkeeping system, which is based on the accrual basis, the balance sheet, the loss & profit statement, and the statement of appropriations of retained earnings, which are included in four financial statements requiring external disclosure, can be automated. However, the statement of cash flow depends on the manual procedures by the external experts whether it is by direct method or the indirect method. Especially, the statements of cash flow by direct method used in business field are less than 1% in Korea (by the standard of 2003), and less than 3% in USA (by the standard of 1994). Since these statements of cash flow are not by direct method based on the cash basis, but by direct method, which is transformed from indirect method, there is no big difference between this statement of cash flow and the statement of cash flow by indirect method.

The fact that although the statement of cash flow is regarded as very useful and indispensable in four financial statements, an automation thereof is not possible, indirectly proves that there is a technical problem in the prior art. The technical problem in the prior art is that a single journalization and a dual system, which are essential for the automation, are not performed. An explanation regarding this will follow later on.

Recently, although International Accounting Standards Board (IASB) is under examination on a plan to use direct method (not direct method transformed from indirect method, but direct method based on the accounting operation of cash basis), which is predominant in terms of the usefulness, IASB has not made a decision yet, and most countries including USA all accept direct method and indirect method. Accordingly, if a method for automatically providing the statement of cash flow by direct method is developed, it will bring about a change of International Accounting Standards (IAS), a change of Korean accounting operation standards, then the statement of cash flow by direct method can be forced.

In conclusion, when considering reality, the method and the system for automatically making the statement of cash flow by using general accounting information (journalization information) without the dependency on the external experts whether the method is direct or indirect, are necessary. Especially, if an automation of the statement of cash flow by direct method, which is predominant in terms of the information effects, and which IASB is trying to force <if it is realized (that is, if cash flows information by direct method can be obtained from the accounting information system of the corporation without increasing the costs for making the financial statements of the corporation and the burden)>, are described, it will contribute to an augmentation of social benefits.

Also, regardless of the method whether it is direct or indirect, if an automation of the supplementary statements of the statement of cash flow, wherein detailed information with regard to the cash flow by date for all items, is possible, the effects will be double.

Japanese Laid-open Patent Publication No. 2001-067429 (hereinafter referred to as “cited reference 1”) describes a method to easily make the statement of cash flow by using a computer. However, it does not provide the statement of cash flow by direct method, and has a limit to go through complex steps such as a means for a table memory, a means for a summary of funds transaction, a means for a summary of loss & profit business, without directly using journalizing data in applying indirect method. Additionally, since the method in cited reference 3 has to go through steps of summarizing data as above, it is impossible to journalize and make the statement of cash flow by indirect method at the same time. Also, since the method in cited reference 1 reversely traces a non-cash account, it cannot make the supplementary statements of the statement of cash flow, which only can be made by directly tracking a cash account.

Meanwhile, Japanese Laid-open Patent Publication No. 2004-234063 (hereinafter referred to as “cited reference 2”) describes a method to easily make the statement of cash flow per month according to direct method. However, since the method uses a monthly summarized trial balance sheet, it has a limit of not providing the real-time statement of cash flow. Additionally, since the method in cited reference 2 has difficulty in precisely matching an account with cash of the statement of cash flow due to a complexity and a duplication of business data, it has disadvantage that many complex amendments should be made by the experts for the above difficulty. Additionally, the method in cited reference 2 does not provide the statement of cash flow by indirect method, and since it reversely traces the non-cash account, it cannot make the supplementary statements of the statement of cash flow, which only can be made by directly tracking the cash account.

Meanwhile, Korean Laid-open Patent Publication No. 10-2007-0031068 (hereinafter referred to as “cited reference 3”) describes a method to easily make the real-time statement of cash flow by direct method under the title of “a method and a system for automatically providing the statement of cash flow and a computer readable recording medium, which records a program for automatically providing the statement of cash flow.” However, firstly, this method disregards the fact that since the double-entry bookkeeping system based on the accrual basis has non-single journalizations, the statement of cash flow can be provided when the non-single journalization is converted into the single journalization. Accordingly, the method in cited reference 3 has a defect in automatically providing the statement of cash flow by direct method, since it does not provide a method that converts the prior journalization into the single journalization. That is, although cited reference 3 demonstrates a method for automatically making the statement of cash flow by direct method, by describing only single-journalization as an example, if only one non-single journalization is included, the above method is impossible to automatically make the statement of cash flow by direct method. Additionally, the method in cited reference 3 does not describe a concept of the single journalization. Since the concept of journalization is essential for automatically making the statement of cash flow, if an additional explanation thereof is not provided, the method has a theoretical defect in making the specification. Secondly, although cited reference 3 describes the method of directly tracing the cash accounts unlike cited references 1 and 2 which describe the method of reversely tracing the non-cash accounts, it disregards an important premise that <Regarding the journalization with regard to the cash account, although the cash in the debit and there is the cash in the credit, it is not allowed to input a net amount of cash of the debit or the credit by counterbalancing the cash of the debit or the credit>. The present invention describes this premise as an input rule, an explanation regarding this will follow later on. Thirdly, since the method in cited reference 3 does not describe a dual system of <account and object> which the present invention firstly introduces, but describes a single system of <account> of the double-entry bookkeeping system based on the prior accrual basis, the method in cited reference 3 has disadvantages that a) if a processing logic type is “deferred accrual,” “deferred settlement,” or “adjustment settlement,” since the <object> is not previously classified, if there is a plurality of objects on the same account, the real-time statement of cash flow cannot be provided; b) if there is one object on the same account, in case of not managing the balance per account, the real-time statement of cash flow cannot be provided; c) since <object> is not classified when cash expenditure occurs and an item of the statement of cash flow can be determined at the finishing time, the supplementary statements of the statement of cash flow cannot be made per accrual day. Accordingly, although the supplementary statements of the statement of cash flow, which approximately complies with an accounting concept and economic substance can be made, supplementary statements of the statement of cash flow, which precisely complies with the accounting concept and economic substance cannot be made; and d) the statement of cash flow and the supplementary statements of the statement of cash flow by indirect method cannot be made.

That is, cited reference 3 describes the method of making the item of the statement of cash flow, which precisely complies with the accounting concept and economic substance at <established point>, whereas the present invention describes the method of making the items of the statement of cash flow, which precisely complies with the accounting concept and economic substance at <income and expenditure point>. However, since a <date>, which supplementary statements of the statement of cash flow need, is <income and expenditure point>, the item of the statement of cash flow at <income and expenditure point> in cited reference 3 has a problem, since it does not precisely comply with the accounting concept and economic substance, but approximately complies with the accounting concept and economic substance. For example, the present invention precisely classifies advance payments for purchasing equipment as <cash flows from investing activities-cash outflows for investing activities-acquisition of equipment> at expenditure point, whereas cited reference 3 classifies the advance payments for purchasing equipment as <cash flows from operating activities-the others-increase of advance payments> at expenditure point and it can classify the advance payments as <cash flows from investing activities-cash outflows for investing activities-acquisition of equipment> only at established point (that is, an inflow point of equipment). Accordingly, since the description of the statement of cash flow in cited reference 3 is not precisely consistent with cash inflows and cash outflows, cited reference 3 has a problem in terms of the accounting concept and the economic substance.

This also shows that cited reference 3 cannot solve a problem of the prior accounting system (the single system of the single account) which only journalizes with the <advance payments>. However, the present invention overcomes this problem by an accounting system (a dual system of the account/object) considering the statement of cash flow, which journalizes the <advance payments/equipment>. For your reference, this dual system is only used in case of a non-stated account, and an explanation regarding this will follow later on.

Additionally, the method in cited reference 3 needs to manage cash flow balance information, balance changing history, and cash flow business information and has a disadvantage of including a complex logic of “deferred accrual,” “deferred settlement,” or “adjustment settlement.” However, the present invention avoids this complex logic by noticing that a key of making the statement of cash flow by direct method is to separate the single journalization in which the cash is included. That is, the present invention derives the statement of cash flow by a simple rule that if the debit is the cash and the credit is not the cash, decide them as the item of the statement of cash flow of cash inflows, if the debit is not the cash and the credit is the cash, decide them as the item of the statement of cash flow item of cash outflow, and if the debit and the credit are all cash or they are not cash, decide them as a non-related item of the statement of cash flow. When automatically providing the real-time cash flows from operating activities by indirect method of the present invention, the single journalization wherein the cash is not included should be used, and when automatically providing the real-time cash flows from investing activities by direct method and indirect method, cash flows from financing activities by direct method and indirect method, and cash flows from operating activities by direct method, only the single journalization wherein the cash is included is needed. An explanation regarding this will follow later on.

As mentioned above, the prior art does not provide a system and a method which automatically provide the real-time statement of cash flow and the supplementary statements of the statement of cash flow by direct and indirect method by inputting the prior non-single journalization, and at the same time, converting it into the single journalization by using a computer system. Additionally, there were no system and method, which provide the supplementary statements of the statement of cash flow wherein the cash flow per date is perfectly consistent with the accounting concept and the economic substance by a manner of additionally appointing a related object in case of a non-stated account at cash income and cash expenditure point, by introducing the non-stated account.

### SUMMARY OF THE INVENTION

### Technical Problem

As the present invention is to overcome these technical limits of the prior art, an object of the present invention is to provide the method and the system that automatically convert the prior general journalization (that is, the prior non-single journalization or the prior single journalization) into the single journalization without depending on the manual procedures of the accounting experts, and as the dual system of <account> and <object>, not the prior single system of only <account>, the present invention also provides the method and the system for automatically providing the statement of cash flow and supplementary statements of the statement of cash flow, which can automatically provide the statement of cash flow and supplementary statements of the statement of cash flow by direct method or indirect method without depending on the manual procedures of the accounting experts at cash income and cash expenditure point (in case of indirect method, accrual point of the item of the statement of cash flows from operating activities is included) upon inputting the general accounting information.

### Problem-Solving Means

The method for automatically providing the statement of cash flow and supplementary statements of the statement of cash flow of the present invention to achieve the above object is connected to communicate with user interfaces through a communication network, also connected to communicate with an external journalization operation system in which an account information, an accounting information, an item of the statement of cash flow according to a resulting value of the first, second, and third classification (hereinafter referred to as “the item of the statement of cash flow”), and available single journalization information become database and are stored in advance. The method for automatically providing the statement of cash flow and supplementary statements of the statement of cash flow, which are embedded by the system for automatically providing the statement of cash flow and supplementary statements of the statement of cash flow wherein the user information becomes database and is stored in advance, and cash outflows information of the statement of cash flow and cash inflows information of the statement of cash flow for making the statement of the cash flow are included, comprises the steps of a) approving a login of the user with regard to the system; b) ensuring the accounting information, which has journalization data, obtained from the journalization operation of the external journalization operation system by the dual system of “account” and “object”; c) a step of “an establishing mode of the item of the statement of cash flow,” which classifies the journalization data into the corresponding item of the statement of cash flow; d) a step of “a mode of converting the journalization into the single journalization,” which converts the journalization data into the “single journalization”; e) a step of “a making mode,” which stores the single journalization data in “cash outflows DB of the statement of cash flow or cash inflows DB of the statement of cash flow”; f) automatically generating the statement of cash flow and supplementary statements of the statement of cash flow by direct method or indirect method, and outputting the statement of cash flow and supplementary statements of the statement of cash flow in a prescribed format according to a command to output the statement of cash flow and supplementary statements of the statement of cash flow.

Meanwhile, the system for automatically providing the statement of cash flow and the supplementary statements of the statement of cash flow of the present invention to achieve the above object comprises cash outflows information database (DB) of the statement of cash flow, cash inflows information DB of the statement of cash flow, cash flow management server, information DB of the user, and a web server. Peripheral systems, which are connected with this system, comprise a plurality of user interfaces, the communication network, and the journalization operation system.

According to the present invention, it automatically provides the statement of cash flow and the supplementary statements of the statement of cash flow by direct method and indirect method by using the general accounting information without depending on the manual procedures of the accounting experts, and also provides the method and the system for automatically providing the statement of cash flow and supplementary statements of the statement of cash flow, which can provide the real-time statement of cash flow and supplementary statements of the statement of cash flow at the time of operating the journalization.

### EFFECTS OF INVENTION

According to the present invention, it automatically provides the statement of cash flow and the supplementary statements of the statement of cash flow by direct method and indirect method by using the general accounting information without depending on the manual procedures of the accounting experts, and also provides the method and the system for automatically providing the statement of cash flow and supplementary statements of the statement of cash flow, which can provide the real-time statement of cash flow and supplementary statements of the statement of cash flow at the time of operating the journalization.

### DETAILED DESCRIPTION EMBODIMENTS OF THE INVENTION

### Detailed Description

First of all, definitions of the main expressions to help you understand the present invention are as follows:

An “inconsistent account” means an account of which an account title is inconsistent with an object title. Especially, since advance payments, non-trade receivables, accounts payable not trade, advance received, deposits payable, prepaid expenses, accrued income, accrued charges, and deferred income have more than one related stated accounts, the item of the statement of cash flow cannot be automatically appointed with only one account. Accordingly, it is necessary to appoint the <object> in addition to the <account> by all means. This is referred to as a <non-stated account> among the inconsistent accounts, and an explanation regarding this is as follows. The inconsistent account not only indicates the non-stated account, but also indicates all cases of which the account title and the object title are inconsistent. For example, there are bond discount, premium on bonds, and bond expenses, which are classified as the object of bond, and depreciation allowance on office equipment and depreciation on office equipment, which are classified as the object of equipment.

A “non-stated account” since advance payments, non-trade receivables, accounts payable not trade, advance received, deposits payable, prepaid expenses, accrued income, accrued charges, and deferred income have more than one related stated accounts, the item of the statement of cash flow cannot be automatically appointed with only one account, and it is necessary to appoint the <object> in addition to the <account> by all means. For example, if the advance payments can be related with merchandise or equipment, cash flows from operating activities (the first classification)/cash outflows purchase and for employees (the second classification)/merchandise purchase (the third classification), or cash flows from investing activities (the first classification)/cash outflows from investing activities (the second classification)/acquisition of equipment (the third classification) can be appointed, only when the account like advance payments and the object like merchandise and equipment are provided. This non-stated account can be fluid, for example, if the accounts receivable is described only as a sale in the statement of cash flow, the accounts receivable is not the non-stated accounts. However if the sale is divided into merchandise sale, goods sale, and fees income, the accounts receivable is classified as the non-stated account in the statement of cash flow. So, only if one of merchandise sale, goods sale, and fees income is appointed as the object, the item of the statement of cash flow can be appointed.

An “object” is <the second account> which mediates the account with the statement of cash flow. In case of the consistent account, the object is consistent with the account, and in case of the inconsistent account, since the object is inconsistent with the account, an additional object should be established to appoint the related item of the statement of cash flow. As a result, a characteristic of the present invention is that the related item of the statement of cash flow is appointed by the object.

A “dual system” is a new accounting system, which performs an error correction journalization when one of the account and the object is changed due to the above two factors. If one of the account and the object is changed, the error correction journalization should be performed with the original date. Under the dual system, the error correction journalization by two factors is obligatory for deriving the precise statement of cash flow.

A “single system” is the prior accounting system, which performs the error correction journalization by a single factor of the account. Although the error correction journalization by two factors can be performed under the single system, it is not obligatory.

A “single journalization” is the smallest unit of the journalization which cannot be divided anymore, and has only one account in the debit and only one account in the credit. This single journalization is an essential element to provide a clue for directly tracing the cash (a contra account of the single journalizaed cash account) for the present invention, which uses the method of directly tracing the cash account, unlike the prior method for making the statement of cash flow of reversely tracing the non-cash account.

A “non-single journalization” is a journalization wherein the debit or the credit has more than one account.

A “general journaliation” is the prior journalization, which can include the non-single journalization or the single-journalization.

A “conversion of the journalization into the single journalization” is a process of converting the prior journalization into a group of the single journalization.

A “general mode” represents the journalization, which is performed in a normal business processing.

A “cancel mode” is the error correction journalization, and represents a reverse journalization of the journalization performed in the normal business processing.

“Supplementary statements of the statement of cash flow” are supplementary statements, which describe the detailed information for each item of the statement of cash flow per date.

The “item of the statement of cash flow” is an abbreviation of the item of the statement of cash flow according to the resulting values of the first, the second, and the third classification. In other words, the item of the statement of cash flow for cash outflows of the statement of cash flow regarding stocks and bonds is cash flows from investing activities (the first classification), cash outflows from investing activities (the second classification), and acquisition of stocks and bonds (the third classification).

Additionally, in order to help understanding of the present invention, simple rules for automatically making the real-time statement of cash flow and supplementary statements of the statement of cash flow by direct method and indirect method while precisely reflecting the accounting concept and economic substance are as follows: Meanwhile, a person skilled in the art can notice that the first, the second, and the third rules also exist in the prior accounting operation. That is, if the above rules are not observed, that accounting operation is also wrong in the prior accounting operation. The fourth rule is an added rule since the present invention firstly introduces the concept of the object. Also, the fifth rule is added since the present invention relates to the method, which directly tracing the cash account.

Firstly, journalize by the date of income and expenditure date at the time of incoming and expending the cash.

Secondly, journalize by the date of accrual if there are no cash income and cash expenditure.

Thirdly, the error correction journalization is performed by going back to the beginning date (the date of cash income and cash expenditure or the accruing date) at the cancel mode.

Fourthly, the error correction journalization should be performed even if the object is changed.

Fifthly, with regard to the journalization of the cash account, although there is the cash in the debit and the cash in the credit, it is not allowed to only describe the netting amount of the cash account of the debit or the credit by counterbalancing the debit and the credit.

Additionally, in order to help understanding of the present invention, major premises, which are necessary for the present invention to be theoretically realized is as follows:

Firstly, any prior journalizations can be divided into the single journalization. For your reference, this premise is necessary for realizing the method for making the statement of cash flow, which directly traces the cash account, and also necessary for realizing the method for making the statement of cash flow wherein the statement of cash flow item is established in advance for all accounts. Since a person skilled in the art can easily understand this premise, the detailed description thereof will be omitted.

Secondly, the inconsistent account can establish the object by all means. For your reference, this premise is necessary for realizing the method of making the statement of cash flow, which assumes the dual system of the account and the object. Since a person skilled in the art can easily understand this premise, the detailed description thereof will be omitted.

Thirdly, a definition of cash of the balance sheet is consistent with a definition of cash of the statement of cash flow. This premise is not absolute. That is, although the definitions of cash of the balance sheet and cash of the statement of cash flow are inconsistent, an adjustment is possible by a method which differently classifies inconsistent parts. Meanwhile, for the present invention, the cash of the balance sheet and the cash of the statement of cash flow will be regarded as being consistent for the sake of convenience. For your reference, according to Korean business accounting standards, the cash and cashable assets of the balance sheet mean the cash account of the statement of cash flow.

Additionally, in order to help the understanding of the present invention, a principle of converting the non-single journalization into the single journalization, which is one of the main characteristics of the present invention, is as follows:

Firstly, perform the following step by using the object information of each account of the non-single journalization. First of all, select an optional account, not the <cash> account, in the <debit>. Then, perform the next step. If there are no other optional accounts except the <cash> account in the <debit> any more, perform the fifth step, omitting the second, the third, and the fourth steps.

Secondly, if there is an account of which the object is the same with the object of the corresponding account in the <credit>, derive an <account combination of one single journalization> and perform the next step. If there is no account of which the object is the same with the object of the corresponding account in the <credit>, the <credit> derives the <account combination of one single journalization> in which the <cash> account is located, and an amount of the single journalization is the amount of the optional account in the <debit>.

Thirdly, a smaller one between an amount of the <debit> and an amount of the <credit> in the <account combination of one single journalization> is an <amount of the present single journalization>. Subtract the <amount of the present single journalization> from the amounts (or balance) of the <debit> and <credit>. If balance of the <debit> is not 0, go back to the second step and perform the next step. If balance of the <debit> is 0, select another optional account except the <cash> account in the <debit>, then go back to the second step and perform the next step. If balance of the <debit> is 0, and there are no other optional accounts except the <cash> account in the <debit>, perform the next step.

Fourthly, select an optional account except the <cash> account in the <credit> and perform the next step. If there is no optional account except the <cash> account in the <credit>, the <conversion of the non-single journalization into the single journalization> is completed.

Fifthly, the <debit> derives the <account combination of one single journalization> wherein the <cash> account is located, and the amount of the present single journalization becomes the amount of the optional account in the <credit>. Additionally, select other optional accounts except the <cash> account in the <credit>, then go to the fourth step and perform the next step. If there are no other optional accounts except the <cash> account in the <credit> anymore, the <conversion of the non-single journalization into the single journalization> is completed.

Sixthly, select an optional account except the <cash> account in the <credit>, and performs the fifth step. If there are no optional accounts except the <cash> account in the <credit>, derive the <account combination of one single journalization> wherein the accounts in the <debit> and the <credit> are the <cash>, make the amount of the present single journalization with the amount of the <debit> (or the <credit>), then the <conversion of the non-single journalization into the single journalization> is completed.

Additionally, in order to help the understanding of the present invention, a process of deriving cash flows from operating activities by indirect method, which is one of the main technical characteristics of the present invention, is as follows:

Firstly, cash flows from operating activities, cash flows from investing activities, and cash flows from financing activities by direct method, and cash flows from investing activities and cash flows from financing activities by indirect method can be derived from the single journalization wherein the cash account, which the corporation previously trades, is included.

Secondly, a total amount of cash flows from operating activities by indirect method can be derived from the single journalization wherein the cash account, which the corporation previously trades, is included.

Thirdly, detailed information of cash flows from operating activities by indirect method can be derived from the single journalization wherein the cash account, which the corporation previously trades, is included, and a part of the single journalization wherein the cash account is not included.

Fourthly, a cause of a difference between the second and the third step is that the current period net income should be included in the detailed information, and in order to make the amount of the current period net income included in detailed information of cash flows from operating activities by indirect method to be consistent with the amount of the current period net income of the profit and loss statement, the single journalization wherein the cash account, which the corporation previously trades, is included and a part of the single journalization wherein the cash account is not included (that is, the item of the cash flow, which is classified as cash flows from operating activities of the constitutional account of the single journalization wherein the cash account is not included, should be considered) should be considered. For example, there can be the journalization wherein accounts receivable is 100 won in the <debit>, and gains on foreign currency translation are 100 won in the <credit>. A total amount of cash flows from operating activities is 0 won through a)<debit> cash flows from operating activities/assets from operating activities, change of debt/increase of accounts receivable[(−) cash flows from operating activities]; b)<credit> cash flow from operating activities/current period net income/current period net income[(+) cash flows from operating activities]; c)<credit> cash flows from operating activities/subtraction of an income which has no cash inflows/gains on foreign currency translation[(−)cash flows from operating activities]; d)<credit> cash flows from operating activities/assets from operating activities, change of debt/decrease of accounts receivable[(+)cash flows from operating activities]. Detailed information of cash flows from operating activities can comprise a) assets from operating activities, change of debt/increase of accounts receivable[(−)100]; b) current period net income/current period net income[(+)100]; c) subtraction of the income which has no cash inflows/gains on foreign currency translation[(−)100]; d) assets from operating activities, change of debt/decrease of accounts receivable[(+)100]. Current period net income 100 won of the statement of cash flow is precisely consistent with current period net income 100 won of the loss and profit statement.

Preferable examples of the present invention are explained by referring to the drawings, enclosed herewith. FIG. 3 of the present invention is a broad block diagram of a system for automatically providing the statement of cash flow and supplementary statements of the statement of cash flow (100) and peripheral systems thereof according to the preferable examples of the present invention. The system for automatically providing the statement of cash flow and supplementary statements of the statement of cash flow (100) can comprise cash outflows information database (DB) of the statement of cash flow (110), cash inflows information DB of the statement of cash flow (120), cash flows management server (150), information DB of the user (160), and web server (170). The peripheral systems which are connected with the system (100) can include a plurality of user interfaces (181, 182, 183), a communication network (200), and a journalization operation system (300).

The journalization operation system (300), a passive, an automatic or a semi-automatic system, is a system which generates a group of the single journalization through a series of processes, by using the journalization data inputted by the user, based on the item information of the statement of cash flow (hereinafter referred to as “information of the item of the statement of cash flow”) according to the previously prepared account information and the resulting values of the first, the second, and the third classification, and stores it.

A plurality of account information per debit and credit, which is previously prepared, is stored in the account information DB (310) of the journalization operation system (300). The account information generally comprises a division of debit or credit, an account, a code data of the object. The accounting information DB generally stores the accounting information generated through the passive, semi-automatic or automatic journalization operation process by the journalization operation server (350).

FIG. 9 of the present invention illustrates a constitutional example of the accounting information according to the preferable examples of the present invention. The accounting information is the information which orderly collects the journalization data during a specific period, and generally comprises a journalization number, a business date (or business time), the account number, the division of debit or credit, the account, the object, the item business amount, as illustrated in FIG. 9. A business summary can be further included in the item of the accounting information depending on the examples. The information of the item of the statement of cash flow which corresponds to a plurality of the accounts per the debit and credit (previously prepared) is stored in the information DB of the item of the statement of cash flow (330 and 350). The information of the item of the statement of cash flow generally comprises the code data of the first classification, the second classification, and the third classification.

The journalization operation server (350) can be connected with the user interfaces (181, 182, 183) by passing the communication network (200) through the web server (for example, 170). The journalization operation server (350) establishes (passively, semi-automatically, or automatically) the account per debit and credit corresponding to the business summary, inputted through the user interfaces (that is, inputted or selected by the user) by using the account information stored in the accounting information DB (310), generates the accounting information by performing the journalization operation with the corresponding business data, and stores it in the accounting information DB (320). Here, since the accounting information generally comprises the account number, the account title, the object title, a value of the division of debit or credit, and business amount data, it is necessary to notice that the accounting information DB (320) can be associated with information DB of the item of the statement of cash flow by direct method (330), information DB of the item of the statement of cash flow by indirect method (335), temporary DB of the journalization (351), temporary DB of the copied journalization (352), temporary DB of the single journalization which waits to be inputted in the making mode (353). That is, the accounting information data is (passively, semi-automatically or automatically) established and transformed to the item of the statement of cash flow and the group of the single journalization by a series of processes. The journalization operation server (350) provides the accounting information, the information of the item of the statement of cash flow, and information of the group of the single journalization to the cash flow operation server (150).

The information of the item of the statement of cash flow by the first, the second, and the third classification based on the accounting title, the object title, and the value of the division of debit or credit is stored in the item information DB of the statement of cash flow by direct method (330) and the item information DB of the statement of cash flow by indirect method (335). FIGS. 20, 21, 22 and 23 are the drawings which illustrate examples that the item information DB of the statement of cash flow moves together with the journalization operation server according to the preferable examples of the present invention. When referring to FIGS. 20, 21, 22, and 23 of the present invention, inputted account and the object can have the information of the item of the statement of cash flow. Please refer to FIGS. 20, 21, 22, and 23 for the examples of specific information of the item of the statement of cash flow. Additionally, the inventor proves an important premise that it is possible to establish the item of the statement of cash flow for all accounts in advance, by directly performing the establishment of the item of the statement of cash flow regarding the main account of the balance sheet and the loss and profit statement. Since a person skilled in the art seems to understand an important premise that an establishment of the item of the statement of cash flow for all accounts in advance is possible by referring to these examples, more detailed description thereof is omitted.

One journalization completed by the dual system is stored in the temporary DB of the journalization (351). Additionally, FIG. 12 of the present invention is a drawing which illustrates the constitutional example of the temporary DB of the journalization according to the preferable examples of the present invention.

The single journalization, which goes through a series of processes with regard to one journalization which is being drafted, is temporarily stored in the temporary DB of the single journalization which waits to be inputted in the making mode (353). Additionally, FIG. 17 of the present invention is a drawing which illustrates the constitutional example of the temporary DB of the single journalization which waits to be inputted in the making mode according to the preferable examples of the present invention.

In cash outflows information DB of the statement of cash flow by direct method (110) and cash inflows information DB of the statement of cash flow by direct method (120), after the single journalization of the temporary DB of the single journalization which waits to be inputted in the making mode is called one by one, except the case that both debit and credit are all cash accounts, or they are not cash accounts, if only the credit is the cash account, the information of the item of the statement of cash of the debit is stored in cash outflows information DB of the statement of cash flow by direct method, and if only the debit is the cash account, the information of the item of the statement of cash flow is stored in cash inflows information DB of the statement of cash flow by direct method. FIGS. 25 and 26 are the drawings which illustrate the constitutional examples of cash outflows information DB of the statement of cash flow by direct method and cash inflows information DB of the statement of cash flow by direct method.

In cash outflows information DB of the statement of cash flow by indirect method (130) and cash inflows information DB of the statement of cash flow by indirect method (140), after the single journalization of the temporary DB of the single journalization which waits to be inputted in the making mode by indirect method (358-1) is called one by one, except the case that both debit and credit are cash accounts, if only the credit is the cash account, the information of the item of the statement of cash flow of the debit is stored in cash outflows information DB of the statement of cash flow by indirect method, and if only the debit is the cash account, the information of the item of the statement of cash flow of the credit is stored in cash inflows information DB of the statement of cash flow by indirect method. If both debit and credit are not cash accounts, the information of the item of the statement of cash flow of the debit is stored in the temporary DB of cash outflows from operating activities of the statement of cash flow by indirect method in a non-cash business (135), and information of the item of the statement of cash flow of the credit is stored in the temporary DB of cash inflows from operating activities of the statement of cash flow by indirect method in a non-cash business (145). The information of the item of the statement of cash flow stored in the temporary DB of cash outflows from operating activities of the statement of cash flow by indirect method in the non-cash business and temporary DB of cash inflows from operating activities of the statement of cash flow by indirect method in the non-cash business is stored in cash outflows information DB of the statement of cash flow by indirect method (130) and cash inflow information DB of the statement of cash flow by indirect method (140), after investing activities and financial activities are removed. FIGS. 26 and 27 of the present invention are the drawings which illustrate the constitutional example of the cash outflows information DB of the statement of cash flow by indirect method and cash inflow information DB of the statement of cash flow by indirect method according to the preferable examples of the present invention.

A process of making the statement of cash flow by indirect method is basically the same with that of making the statement of cash flow by direct method. However, for the sake of convenience, the process of making the statement of cash flow by indirect method will be separately explained. Accordingly, the journalization operation system (300) separately includes the temporary DB of the journalization by indirect method (351-1), the temporary DB of the copied journalization by indirect method (352-1), and the temporary DB of the single journalization which waits to be inputted in the making mode by indirect method (353-1), and the cash flow management server (150) also separately includes the information DB of the item of the statement of cash flow by indirect method (335), cash outflows DB of the statement of cash flow by indirect method (130), and cash inflows DB of the statement of cash flow by indirect method (140) according to the first, the second, and the third resulting values, separately from the constitutions for making the statement of cash flow by direct method, as described in FIG. 3. However, since a person skilled in the art can easily conceive the manner of incorporating and comprising from the method of giving different codes for direct method and indirect method by referring to the above explanation, the detailed description thereof is omitted.

Since a process of making the statement of cash flow by indirect method is basically the same with that by direct method, we will firstly explain the method for making the statement of cash flow by direct method, then additionally explain different parts of the method of making the statement of cash flow by indirect method from the method by direct method in the corresponding part.

Information for identifying the user (that is, the user information) (for example, user ID, pin number, mobile number, and address, etc.) is stored in the information DB of the user (160).

A communication network (200) can be LAN in a corresponding corporation, or an internet using HTTP (Hyper Text Transfer Protocol). As the communication network (200), various communication networks such as a wireline communication network or a digital satellite network, and a wireless mobile communication network can be used in a physical meaning. An individual computer wherein a web browser is established is a representative of the user interfaces. However, various connection instruments having a function of inputting or reading necessary data by connecting to the web server, for example, a mobile communication terminal, kiosk, an information terminal for an individual such as PDA, and a digital TV, can be used.

The web server (170) mediates the user to access and login to the system (100) (or the system (300)), search necessary information or input the necessary information, through the user interfaces (181 (for example, the mobile communication terminal, 182 (for example, PDA), 183 (for example, the individual PC), and the communication network (200).

According to the examples of the present invention as mentioned above, the method for automatically providing the statement of cash flow and supplementary statements of the statement of cash flow, which is connected to communicate with the user interfaces (for example, 181, 182, 183) through the communication networks (200), connected to communicate with the external journalization operation system (300) wherein the account information, accounting information, information of the item of the statement of cash flow according to the resulting values of the first, the second, and the third classification become database and are stored in advance, and embodied by the system (100) (of the cash flow management server (150)) for automatically providing the statement of cash flow and supplementary statements of the statement of cash flow wherein the user information becomes database and is stored in advance, and cash inflows information of the statement of cash flow and cash inflows information of the statement of cash flow for making the statement of cash flow are included, is performed.

Meanwhile, according to other examples of the present invention, the journalization operation system (300) of FIG. 3 and the system (100) for automatically providing the statement of cash flow and the supplementary statements of the statement of cash flow are all stored in one PC. Under these circumstances, a recording medium (for example, CD which records a program) which records a computer program for automatically providing the statement of cash flow and the supplementary statements of the statement of cash flow to operate PC so that the method [for example: the method wherein the steps (S410˜S453) in FIG. 4 are included] for automatically providing the statement of cash flow and the supplementary statements of the statement of cash flow can be embodied, through the system (100) for automatically providing the statement of cash flow and supplementary statements of the statement of cash flow in this PC. For example, the system and the program for operating the system (100) for automatically providing the statement of cash flow and the supplementary statements of the statement of cash flow can be provided in the form of ASP or a package. Accordingly, a system structure of FIG. 3 of the present invention should be understood as one example, and it is necessary to notice that other systems can be embodied according to the examples of the present invention. Meanwhile, we are trying to explain the method and the system for automatically providing the statement of cash flow and the supplementary statements of the statement of cash flow, by referring to FIG. 3 as one of the preferable examples of the present invention,

FIG. 4 illustrates an embodiment process of the method for automatically providing the statement of cash flow and the supplementary statements of the statement of cash flow according to the preferable examples of the present invention. From now on, we are trying to explain the embodiment process of the method for automatically providing the statement of cash flow according to the preferable examples of the present invention by referring to the enclosed drawings. A process of approving an access/login for the system (100) of the user (by the cash flow management server (150)) is performed in step (S410). This process, for example, is a basic process for the user to use the system after registering the ID and pin number of the user at the data input box, provided by the web server through the communication network (200) by passing the user interface (for example: 183), and receiving an approval for using the system (100) from the system administrator.

The [journalization operation server (350)] makes <data of the single journalization which waits to be inputted in the making mode> obtained by the journalization operation system (300) from the inputted journalization data database and stores it in step (S420). Herein, the meaning of making DB and storing is that the information is stored in the corresponding DB as a prescribed format.

FIG. 5 of the present invention illustrates a detailed constitutional example of an input mode (S420) of FIG. 4 according to the preferable examples of the present invention. Hereinafter, we will explain a process of step (S420) according to the preferable examples of the present invention in detail. The date is inputted in step (S510). The account number, the division of debit or credit, the account title, the summary, and the amount are inputted in step (S511). In step (S515), if the value of the division of debit or credit is the debit, a processing route is determined to step (S520), and if the value of the division of debit or credit is the credit, the processing route is determined to step (S525).

An <establishing mode of the item of the statement of cash flow in the debit and the credit> is performed in step (S520) and step (S525). In order to perform the establishing mode of the item of the statement of cash flow in the debit and the credit, an important premise should be established as follows: That is, “it is possible for all accounts to establish the item of the statement of cash flow in advance.” In other words, “the item of the statement of cash flow which corresponds to all accounts is individually one.” Based on this premise, FIGS. 20 and 21 illustrate the establishing mode of the item of the statement of cash flow in the debit and the credit in the manner of previously establishing the item of the statement of cash flow for each account. A person skilled in the art can easily understand the meaning of the inconsistent account, and a possibility of establishing the corresponding item of the statement of cash flow as an addition of the object in case of the inconsistent account (especially, the non-stated account). Since the concepts of the inconsistent account, the non-stated account, and the object are firstly introduced by the inventor of the present invention to automatically make the real-time statement of cash flow, the above concepts are not necessary for the prior accounting system which does not premise the statement of cash flow.

According to the division of debit or credit, in case of the debit, the processing route is determined to step (S520), and in case of the credit, the processing route is determined to step (S525). In step (S520) and step (S525), depending on the account title, if the account titles are consistent, the corresponding item of the statement of cash flow is established and goes to step (S528), and if the account titles are inconsistent, the processing route is established to the next account, and judges whether the account titles are consistent or not. At this time, if the account title is the inconsistent account (especially, the non-stated account), the object should be additionally inputted. This object is described as the account of the related balance sheet and account of the related loss and profit statement in step (S520) and step (S525). For your reference, in case of the consistent account, the account title will be the object title. Additionally, in case of the stated account (the inconsistent account), since the object title which is established in advance can be automatically inputted, it is not necessary to additionally input the object.

In FIG. 25 explaining the input mode of the statement of cash flow by indirect method, the <establishing mode of the item of the statement of cash flow in the debit and the credit> is performed in step (S2520) and step (S2525), and FIGS. 22 and 23 illustrate the above matter. A difference between the <establishing mode of the item of the statement of cash flow in the debit and the credit> by direct method and the <establishing mode of the statement of cash flow in the debit and the credit> by indirect method will be demonstrating methods of cash flows from operating activities. Demonstrating methods of cash flows from investing activities and cash flows from financing activities are the same in direct method and indirect method. Accordingly, different parts in FIGS. 20 and 22, and FIGS. 21 and 23 are only related to cash flows from operating activities. For your reference, since cash flows from operating activities by indirect method include assets from operating activities and change in debit, the non-cash business (that is, a business in which the cash account is not included in the debit and the credit) should be considered in making the statement of cash flow according to indirect method. An explanation regarding this will follow later on.

Going back to the process of making the statement of cash flow by direct method, a process of storing all outputted information from the above steps regarding the inputted accounts in the <temporary DB of the journalization (351)> of FIG. 3 is performed in step (S528). Then, proceed to step (S530).

A judgment whether an input of the journalization is completed is performed in step (S530). If an additional account should be inputted since the input of one journalization is not completed, proceed to step (S511). If the input of the journalization is completed, proceed to step (S531).

A total amount of the debit amount and the credit amount of the temporary DB of the journalization (351) is established in step (S531). Then, proceed to step (S532).

A judgment whether the total amount of the debit is consistent with the total amount of the credit is performed in step (S532). If the total amount of the debit is inconsistent with the total amount of the credit, proceeds to step (S533) and performs an analysis of a cause of the inconsistency and an amendment, by describing the inputted contents, amending the contents, and inputting the additional contents. Since a person skilled in the art can easily embody the logic corresponding to step (S533), the detailed description thereof will be omitted. If the total amount of the debit is consistent with the total amount of the credit, proceed to step (S534).

The inputted journalization is stored in the temporary DB of the journalization (351) in step (S534). FIG. 12 of the present invention illustrates an example of the data, inputted by the above processes and stored in the temporary DB of the journalization. Then, proceed to step (S570) and performs <the mode of converting the journalization into the single journalization>.

When the statement of cash flow is made by indirect method, other processes are the same with the processes by direct method, except that <the establishing mode of the item of the statement of cash flow (debit)> and <the establishing mode of the item of the statement of cash flow (credit)> should be changed to <the establishing mode of the item of the statement of cash flow by indirect method (debit)> and <the establishing mode of the item of the statement of cash flow by indirect method (credit)>, and the statement of cash flow is not stored in the <temporary DB of the journalization>, but stored in the <temporary DB of the journalization by indirect method>.

We explained the detailed constitutional examples of the steps from (S510) to (S534) by referring to FIG. 5 of the present invention. The [journalization operation server (350)] makes a <single journalization list data> obtained from the journalization operation system (300) database and stores in step (S570).

The <mode of converting the journalization into the single journalization> is performed in step (S570). FIG. 6 of the present invention illustrates the <mode of converting the journalization into the single journalization>, and an explanation thereof will follow. The object of the <mode of converting the journalization into the single journalization> is to transform the <present journalization> in the form that one account in the debit and one account in the credit (hereinafter referred to as “single journalization) by re-journalizing the <present journalization> which is focused on the <account>, to focus on the <object>.

A process of preparing the <temporary DB of the copied journalization (S352)> which copies the <temporary DB of the journalization (S351)> is performed in step (S605). Then, proceed to step (S610).

A <non-cash non-cash mode> is performed in step (S610). FIG. 7 of the present invention illustrates the <non-cash non-cash mode>, and an explanation regarding this will follow: The object of the <non-cash non-cash mode> includes a procedure of adding 0.1 to the account number of the cash account of the debit, a procedure of deriving the single journalization of the non-cash account of the credit, which has the same object with the non-cash account of the debit, and a procedure of adding 0.1 to the account number of the cash account of the credit, which has the same object with the non-cash account of the debit. For this, a process of calling one account by the order of an account number in the <debit> of the <temporary DB of the copied journalization> is performed in step (S710). Then, proceed to step (S720).

A judgment whether the called account is the <cash> account or not is performed in step (S720). If the called account is the <cash> account, proceed to step (S725) and renew the account number of the <present cash account> by adding 0.1 to the account number of the <present cash account>. Then, proceed to step (S790). If the called account is not the <cash> account, proceed to step (S730).

A judgment whether there is an account in the <debit> which has <positive number> account with the same object as the object of the called account is performed in step (S730). If there is the account in the <debit> which has the <positive number> account with the same object as the called account, proceed to step (S735).

A process of calling the account of the <credit> is performed in step (S735). Then, proceed to step (S740).

A judgment whether the called account is the <cash> account or not is performed in step (S740). If the called account is the <cash> account, proceed to step (S745) and renew the account number of the <present cash account> by adding 0.1 to the account number of the <present cash account>. Then, proceed to step (S730). If the called account is not the <cash> account, proceed to step (S750).

A process of establishing the <debit> of the <present single journalization> with the called <debit> account, and the <credit> of the <present single journalization> with the called <credit> account is performed in step (S750). Then, proceed to step (S755).

A process of calling the amount of the debit account and the amount of credit account of the <present single journalization> from the <temporary DB of the copied journalization> is performed in step (S755). Then, proceed to step (S760).

A process of comparing the amount of the called debit account with the amount of called credit account is performed in step (S760). If the amount of the debit account is the same with the amount of the credit account, proceed to step (S761).

A process of establishing the <amount> of the <present single journalization> with the <amount> of the <credit> account is performed in step (S761). Then, proceed to step (S762).

A process of storing the <present single journalization> in the <temporary DB of the single journalization which waits to be inputted in the making mode> is performed in step (S762). Then, proceed to step (S763).

A process of removing the <present credit account> from the <temporary DB of the copied journalization> is performed in step (S763). Then, proceed to step (S780).

If the amount of the debit account is not the same with the amount of the credit account in step (S760), proceed to step (S770).

A judgment whether the amount of the called debit account is smaller than the amount of the called credit account is performed in step (S770). If the amount of the called debit account is bigger than the amount of the called credit account, proceed to step (S771).

A process of renewing the <amount> of the <debit> account of the <temporary DB of the copied journalization> with balance that the <amount> of the called <credit> account is subtracted from the <amount> of the called <debit> account is performed in step (S771). Then, proceed to step (S772).

A process of establishing the <amount> of the <present single journalization> with the <amount> of the <credit> account is performed in step (S772). Then, proceed to step (S773)

A process of storing the <present single journalization> in the <the temporary DB of the single journalization which waits to be inputted in the making mode> is performed in step (S773). Then, proceed to step (S774).

A process of removing the <present credit account> from the <temporary DB of the copied journalization> is performed in step (S774). Then, proceed to step (S730).

If the amount of the debit account is smaller than the amount of the credit account in step (S770), proceed to step (S775).

A process of renewing the <amount> of the <credit> account of the <temporary DB of the copied journalization> with balance that the <amount> of called the <debit> account is subtracted from the <amount> of the called <credit> account is performed in step (S775). Then, proceed to step (S776).

A process of establishing the <amount> of the <present single journalization> with the <amount> of the <debit> account is performed in step (S776). Then, proceed to step (S777).

A process of storing the <present single journalization> in the <the temporary DB of the single journalization which waits to be inputted in the making mode> is performed in step (S777). Then, proceed to step (S780).

A process of removing the <present debit account> from the <temporary DB of the copied journalization> is performed in step (S780). Then, proceed to step (S790).

A judgment whether there is the <debit> account having the <positive number> account which will be additionally called in the <temporary DB of the copied journalization> is performed in step (S790). If it exists, proceed to step (S710).

If there is no <credit> account having the <positive number> account with the same object as the object of the called account in step (S730), proceed to step (S737), and perform the <non-cash cash mode>. FIG. 14 of the present invention illustrates a resulting value of the <non-cash non-cash mode> with regard to <account number 1> based on the data of FIG. 13.

The <non-cash cash mode> is performed in step (S810). FIG. 8 of the present invention illustrates the <non-cash cash mode>, and an explanation regarding this will follows. The object of the <non-cash cash mode> includes a procedure of deriving the single journalization of the cash account of the credit having the same object with the non-cash account of the debit, and a procedure of deriving a case that the amounts of the debit and credit are inconsistent when journalizing the <present journalization> into the object of the debit account and the object of the credit account, correcting the inconsistency, and re-performing the <mode of converting the journalization into the single journalization> from the beginning. For this, a process of judging whether there is the <cash> account in the <credit> having the <demical> account number with the same object as the object of the called account is performed in step (S810). If there is the <cash> account in the <credit> having the <demical> account number with the same object as the object of the called account, proceed to step (S820).

A process of calling the <cash> account of the <credit> having the <demical> account number with the same object as the object of the called account in the order of the account number is performed in step (S820). Then, proceed to step (S825).

A process of comprising the <debit> of the <present single journalization> with the called <debit> account, and the <credit> of the <present single journalization> with the called <credit><cash> account is performed in step (S825). Then, proceed to step (S830).

A process of calling the amounts of the debit account and the credit account of the <present single journalization> by the <temporary DB of the copied journalization> is performed in step (S830). Then, proceed to step (S840).

A judgment whether the amount of the called debit account is the same with the amount of the credit account is performed in step (S840). If the above amounts are the same, proceed to step (S845).

A process of establishing the <amount> of the <present single journalization> with the <amount> of the <credit> account is performed in step (S845). Then, proceed to step (S847).

A process of storing <present single journalization> in the <the temporary DB of the single journalization which waits to be inputted in the making mode> is performed in step (S847). Then, proceed to step (S848).

A process of removing the <present credit account> from the <temporary DB of the copied journalization> is performed in step (S848). Then, proceed to step (S880), and return to the <non-cash non-cash mode>.

If the amount of the called debit account is different from the amount of the credit account, proceed to step (S850).

A judgment whether the amount of the called debit account is smaller than the amount of the credit account is performed in step (S850). If the amount of the called debit account is bigger than the amount of the credit account, proceed to step (S851).

A process of renewing the <amount> of the <debit> account of the <temporary DB of the copied journalization> with balance that the <amount> of the <credit> account is subtracted from the <amount> of the called <debit> account is performed in step (S851). Then, proceed to step (S852).

A process of establishing the <amount> of the <present single journalization> with the <amount> of the <credit> account is performed in step (S852). Then, proceed to step (S853).

A process of storing the <present single journalization> in the <the temporary DB of the single journalization which waits to be inputted in the making mode> is performed in step (S853). Then, proceed to step (S854).

A process of removing the <present credit account> from the <temporary DB of the copied journalization> is performed in step (S854). Then, proceed to step (S810).

If the amount of the called debit account is smaller than the amount of the credit account, proceed to step (S855).

A process of renewing the <amount> of the <credit> account of the <temporary DB of the copied journalization> with balance that the <amount> of the <debit> account is subtracted from the <amount> of the called <credit> account is performed in step (S855). Then, proceed to step (S856).

A process of establishing the <amount> of the <present single journalization> with the <amount> of the <debit> account is performed in step (S856). Then, proceed to step (S857).

A process of storing the <present single journalization> in the <the temporary DB of the single journalization which waits to be inputted in the making mode> is performed in step (S857). Then, proceed to step (S880) and return to the <non-cash non-cash mode>.

If there is no <cash> account in the <credit> having the <demical> account number with the same object as the object of the called account in step (S810), proceed to step (S815).

A process of analyzing the reason why there is no <cash> account of the <credit> having the <demical> account number with the same object as the object of the called account, or the account of the <credit> having the <positive number> account number, correcting this, and renewing the information of the <temporary DB of the journalization> is performed in step (S815). Then, proceed to step (S927).

A process of removing all information of the <the temporary DB of the single journalization which waits to be inputted in the making mode> is performed in step (S817). Then, proceed to step (S818).

A process of removing all information of the <temporary DB of the copied journalization> is performed in step (S818). Then, proceed to step (S531), and re-perform the <mode of converting the journalization into the single journalization> from the beginning.

If there is no <debit> account having the <positive number> account number which will be additionally called from the <temporary DB of the copied journalization> in step (S890), proceed to step (S620), then the <non-cash non-cash mode> is finished, and the <cash non-cash mode> is performed. FIG. 15 of the present invention illustrates resulting values of the <non-cash non-cash mode> and the <non-cash cash mode> with regard to <account number 1> based on the data of FIG. 13.

The <cash non-cash mode> is performed in step (S910). FIG. 9 of the present invention illustrates the <cash non-cash mode>, and an explanation regarding this will follow. The object of the <cash non-cash mode> includes a procedure of adding 0.1 to the account number of the cash account of the credit, a procedure of deriving the single journalization of the non-cash account of the credit having the same object with the cash account of the debit, and a procedure of deriving a case that the amounts of the debit and the credit are inconsistent when the <present journalization> is journalized into the object of the debit account and the object of the credit account, correcting the inconsistency, and re-performing the <mode of converting the journalization into the single journalization> from the beginning. For this, a process of calling one account from the <credit> of the <temporary DB of the copied journalization> in the order of the <positive number> account number is performed in step (S910). Then, proceed to step (S915).

A judgment whether the called account is the <cash> account is performed in step (S915). If the called account is the <cash> account, proceed to step (S917).

A process of renewing the account number of the <cash> by adding 0.1 to the account number of the present <cash> account is performed in step (S917). Then, proceed to step (S970).

If the called account is not the <cash> account in step (S915), proceed to step (S920).

A judgment whether there is the <cash> account of the <debit> having the <demical> account number with the same object as the object of the called account is performed in step (S920). If there is no <cash> account in the <debit> having the <demical> account number with the same object as the object of the called account, proceed to step (S926).

A process of analyzing the reason why there is no <cash> account of the <debit> having the <demical> account number with the same object as the object of the called account, or the account of the <debit> having the <positive number> account number, correcting this, and renewing the information of the <temporary DB of the journalization> is performed in step (S926). Then, proceed to step (S927).

A process of removing all information of <the temporary DB of the single journalization which waits to be inputted in the making mode> is performed in step (S927). Then, proceed to step (S928).

A process of removing all information of the <temporary DB of the copied journalization> is performed in step (S928). Then, proceed to step (S531), and finally re-perform the <mode of converting the journalization into the single journalization> from the beginning.

If there is the <cash> account of the <debit> having the <demical> account number with the same object as the object of the called account in step (S920), proceed to step (S925).

A process of calling the <debit><cash> account is performed in step (S925). Then, proceed to step (S930).

A process of comprising the <credit> of the <present single journalization> with the called <credit> account, and the <debit> of the <present single journalization> with the called <debit><cash> account is performed in step (S930). Then, proceed to step (S935).

A process of calling the amounts of the debit account and the credit account of the <present single journalization> from the <temporary DB of the copied journalization> is performed in step (S935). Then, proceed to step (S940).

A judgment whether the amount of the called debit account is the same with the amount of the credit account is performed in step (S940). If the amount of the called debit account is the same with the amount of the credit account, proceed to step (S945).

A process of establishing the <amount> of the <present single journalization> with the <amount> of the <credit> account is performed in step (S945). Then, proceed to step (S947).

A process of storing the <present single journalization> in the <the temporary DB of the single journalization which waits to be inputted in the making mode> is performed in step (S947). Then, proceed to step (S948).

A process of removing the <present debit account> from the <temporary DB of the copied journalization> is performed in step (S948). Then, proceed to step (S960).

If the amount of the called debit account is different from the amount of the credit account in step (S940), proceed to step (S950).

A judgment whether the amount of the called credit account is smaller than the amount of the debit account is performed in step (S950). If the amount of the called credit account is bigger than the amount of the debit account, proceed to step (S951).

A process of renewing the <amount> of the <credit> account of the <temporary DB of the copied journalization> with balance that the <amount> of the <debit> account is subtracted from the <amount> of the called <credit> account is performed in step (S951). Then, proceed to step (S952).

A process of establishing the <amount> of the <present single journalization> with the <amount> of the <debit> account is performed in step (S952). Then, proceed to step (S953).

A process of storing the <present single journalization> in the <the temporary DB of the single journalization which waits to be inputted in the making mode> is performed in step (S953). Then, proceed to step (S954).

A process of removing the <present debit account> from the <temporary DB of the copied journalization> is performed in step (S954). Then, proceed to step (S920).

If the amount of the called credit account is smaller than the amount of the debit account in step (S950), proceed to step (S955).

A process of renewing the <amount> of the <debit> account of the <temporary DB of the copied journalization> with balance that the <amount> of the <credit> account is subtracted from the <amount> of the called <debit> account is performed in step (S955). Then, proceed to step (S956).

A process of establishing the <amount> of the <present single journalization> with the <amount> of the <credit> account is performed in step (S956). Then, proceed to step (S957).

A process of storing the <present single journalization> in the <the temporary DB of the single journalization which waits to be inputted in the making mode> is performed in step (S957). Then, proceed to step (S960).

A process of removing the <present credit account> from the <temporary DB of the copied journalization> is performed in step (S960). Then, proceed to step (S970).

A judgment whether there is the <credit> account having the <positive number> account number which will be additionally called from the <temporary DB of the copied journalization> is performed in step (S970). If there is the <credit> account having the <positive number> account number which will be additionally called from the <temporary DB of the copied journalization>, proceed to step (S910). If there is no <credit> account having the <positive number> account number which will be additionally called from the <temporary DB of the copied journalization>, proceed to step (S630), then, the <cash non-cash mode> is finished, and the <cash cash mode> is performed. FIG. 16 of the present invention illustrates resulting values of the <non-cash non-cash mode>, <non-cash cash mode> and <cash non-cash mode> based on the data of FIG. 13.

The <cash cash mode> is performed in step (S1010). FIG. 10 of the present invention illustrates the <cash cash mode>, an explanation regarding this will follow. The object of the <cash cash mode> includes a procedure of deriving the single journalization of the cash account of the credit having the same object with the cash account of the debit, and a procedure of deriving a case that the amounts of the debit and the credit are inconsistent when the <present journalization> is journalized into the object of the debit account and the object of the credit account, correcting the inconsistency, and re-performing the <mode of converting the journalization into the single journalization> from the beginning. For this, a judgment whether there is the <debit><cash> account having the <demical> account number in the <temporary DB of the copied journalization> is performed in step (S1010). If it does not exist, proceed to step (S1014).

A judgment whether there is the <credit><cash> account having the <demical> account in the <temporary DB of the copied journalization> is performed in step (S1014). If it does not exist, proceed to step (S640). If it exists, proceed to step (S1017).

A process of analyzing the reason why there is no <cash> account of the <credit> having the <demical> account number with the same object as the object of the called account, or the account of the <credit> having the <positive number> account number, correcting this, and renewing the information of the <temporary DB of the journalization> is performed in step (S1017). Then, proceed to step (S1018).

A process of removing all information of the <the temporary DB of the single journalization which waits to be inputted in the making mode> is performed in step (S1018). Then, proceed to step (S1019).

A process of removing all information of the <temporary DB of the copied journalization> is performed in step (S1019). Then, proceed to step (S531), and re-perform the <mode of converting the journalization into the single journalization> from the beginning.

If there is the <debit><cash> account having the <demical> account number in the <temporary DB of the copied journalization> in step (S1010), proceed to step (S1015).

A judgment whether there is the <credit><cash> account having the <demical> account number in the <temporary DB of the copied journalization> is performed in step (S1015). If it does not exist, proceed to step (S1017). If it exists, proceed to step (S1020).

A process of calling one <cash> account from the <debit> of the <temporary DB of the copied journalization> in the order of the <demical> account number is performed in step (S1020). Then, proceed to step (S1025).

A judgment whether there is the <credit><cash> account having the <demical> account number with the same object as the object of the called <cash> account is performed in step (S1025). If it does not exist, proceed to step (S1017). If it exists, proceed to step (S1030).

A process of calling the <credit><cash> account is performed in step (S1030). Then, proceed to step (S1035).

A process of comprising the <debit> of the <present single journalization> with the called <debit><cash> account, and the <credit> of the <present single journalization> with the called <credit><cash> account is performed in step (S1035). Then, proceed to step (S1040).

A process of calling the amounts of the debit account and the credit account of the <present single journalization> from the <temporary DB of the copied journalization> is performed in step (S1040). Then, proceed to step (S1045).

A judgment whether the amount of the called debit account is the same with the amount of the credit account is performed in step (S1045). If the above amounts are the same, proceed to step (S1046).

A process of establishing the <amount> of the <present single journalization> with the <amount> of the <credit> account is performed in step (S1046). Then, proceed to step (S1047).

A process of storing the <present single journalization> in the <the temporary DB of the single journalization which waits to be inputted in the making mode> is performed in step (S1047). Then, proceed to step (S1048).

A process of removing the <present credit account> from the <temporary DB of the copied journalization> is performed in step (S1048). Then, proceed to step (S1060).

If the amount of the called debit account is different from the amount of the credit account in step (S1045), proceed to step (S1050).

A judgment whether the amount of the called debit account is smaller than the amount of the credit account is performed in step (S1050). If the amount of the called debit account is bigger than the amount of the credit account, proceed to step (S1051).

A process of renewing the <amount> of the <debit> account of the <temporary DB of the copied journalization> with balance that the <amount> of the <credit> is subtracted from the called <debit> account is performed in step (S1051). Then, proceed to step (S1052).

A process of establishing the <amount> of the <present single journalization> with the <amount> of the <credit> account is performed in step (S1052). Then, proceed to step (S1053).

A process of storing the <present single journalization> in the <the temporary DB of the single journalization which waits to be inputted in the making mode> is performed in step (S1053). Then, proceed to step (S1054).

A process of removing the <present credit account> from the <temporary DB of the copied journalization> is performed in step (S1054). Then, proceed to step (S1025).

If the amount of the called debit account is smaller than the amount of the debit account in step (S1050), proceed to step (S1055).

A process of renewing the <amount> of the <credit> account of the <temporary DB of the copied journalization> with balance that the <amount> of the <debit> account is subtracted from the <amount> of the called <credit> account is performed in step (S1055). Then, proceed to step (S1056).

A process of establishing the <amount> of the <present single journalization> with the <amount> of the <debit> account is performed in step (S1056). Then, proceed to step (S1057).

A process of storing the <present single journalization> in the <the temporary DB of the single journalization which waits to be inputted in the making mode> is performed in step (S1057). Then, proceed to step (S1060).

A process of removing the <present debit account> from the <temporary DB of the copied journalization> is performed in step (S1060). Then, proceed to step (S1070).

A judgment whether there is the <debit><cash> account having the <demical> account number which will be additionally called in the <temporary DB of the copied journalization> is performed in step (S1070). If it exists, proceed to step (S1020). If it does not exist, proceed to step (S1080).

A judgment whether there is the <credit><cash> account having the <demical> account number in the <temporary DB of the copied journalization> is performed in step (S1080). If it exists, proceed to step (S1085).

A process of analyzing the reason why there is no <cash> account of the <credit> having the <demical> account number with the same object as the object of the called account, or the account of the <credit> having the <positive number> account number, correcting this, and renewing the information of the <temporary DB of the journalization> is performed in step (S1085). Then, proceed to step (S1087).

A process of removing all information of the <the temporary DB of the single journalization which waits to be inputted in the making mode> is performed in step (S1087). Then, proceed to step (S1088).

A process of removing all information of the <temporary DB of the copied journalization> is performed in step (S1088). Then, proceed to step (S531), and re-perform the <mode of converting the journalization into the single journalization> from the beginning.

If there is no <credit><cash> account having the <demical> account number in the <temporary DB of the copied journalization> in step (S1080), the <cash cash mode> and <mode of converting the journalization into the single journalization> are completed. FIG. 17 of the present invention illustrates resulting values of the <non-cash non-cash mode>, <non-cash cash mode>, <cash non-cash mode>, and <cash cash mode> based on the data of FIG. 13.

A judgment whether there is journalization which needs to be additionally inputted is performed in step (S580). If the journalization to be additionally inputted exists, proceed to the processing route of step (S510). If the journalization to be additionally inputted does not exist, the <input mode> is completed. FIG. 19 of the present invention illustrates resulting value of the above processing based on the data of FIG. 18 (corresponding to journalization number 2).

The detailed constitutional example of step (S420) is explained by referring to FIGS. 5, 6, 7, 8, 9, and 10. After that, the [cash flow management server (150)] makes <cash outflows information data of the statement of cash flow by direct method> and <cash inflows information data of the statement of cash flow by indirect method>, which are obtained by the operation of the system (100) for automatically providing the statement of cash flow and supplementary statements of the statement of cash flow, database and stores it in step (S430).

The <making mode> is performed in step (S430). FIG. 28 of the present invention illustrates the <making mode>, and an explanation regarding this will follow. The object of the <making mode> is to derive <cash outflows DB of the statement of cash flow by direct method (110)> and <cash inflows DB of the statement of cash flow by direct method (120)> based on the <the temporary DB of the single journalization which waits to be inputted in the making mode>. For this, a process of calling one single journalization from the <the temporary DB of the single journalization which waits to be inputted in the making mode> is performed in step (S1110). Then, proceed to step (S1120).

A judgment whether the <debit> account of the called single journalization is the <cash> is performed in step (S1120). If the <debit> account of the called single journalization is the <cash>, proceed to the processing route of step (S1130). If the <debit> account of the called single journalization is not the <cash>, proceed to the processing route of step (S1125).

A judgment whether the <credit> account of the called single journalization is the <cash> is performed in step (S1125). If the <credit> account of the called single journalization is the <cash>, proceed to the processing route of step (S1126). If the <credit> account of the called single journalization is not the <cash>, proceed to the processing route of step (S1160).

A process of storing the information of the <debit> account of the called single journalization in the <cash outflows DB of the statement of cash flow by direct method (110)> of FIG. 3 is performed in step (S1126). Then, proceed to step (S1160).

A judgment whether <credit> account of the called single journalization is the <cash> is performed in step (S1130). If the <credit> account of the called single journalization is not the <cash>, proceed to the processing route of step (S1135). If the <credit> account of the called single journalization is the <cash>, proceed to the processing route of step (S1160). For your reference, if a case that both <debit> and <credit> are all <cash> accounts is proceeded with the processing route of step (S1160), and is stored in an <additional DB> without removing the <present journalization>, the present invention can provide an information with regard to difference parts between the <supplementary statements of the statement of cash flow> and <bankbook and cash business history> which will be explained later. Accordingly, since the supplementary statements of the statement of cash flow can be perfectly consistent with the <bankbook and cash business history>, it is very useful for the inner management object, and this is one of the effects which is firstly introduced due to the present invention.

A process of storing the <credit> account of the called single journalization in the <cash inflows DB of the statement of cash flow by direct method (120)> of FIG. 3 is performed in step (S1135). Then, proceed to step (S1160).

In FIG. 31 of the present invention illustrating the <making mode> of the statement of cash flow by indirect method, if the <debit> account of the called single journalization is not the <cash> and the <credit> account is also not the <cash> (that is, in case of non-cash business), proceed to the processing route of step (S2140). For your reference, since the non-cash business is nothing to do with making the statement of cash flow by direct method, steps from (S2140) to (S2156) of FIG. 31 are omitted.

The information of the <debit> account of the called single journalization is stored in the <temporary DB of cash outflows from operating activities of the statement of cash flow by indirect method in the non-cash business (135)> in step (S2140). Then, proceed to step (S2142).

The information on the <investing activities> and <financing activities> among the information stored in the <temporary DB of cash outflows from operating activities of the statement of cash flow by indirect method in the non-cash business> are removed in step (S2142). Then, proceed to step (S2144).

The information of the <debit> account information performed from the above processes is stored in the <cash outflows DB of the statement of cash flow by indirect method (130)> in step (S2144). Then, proceed to step (S2146).

A process of removing all information stored in the <temporary DB of cash outflows from operating activities of the statement of cash flow by indirect method in the non-cash business> is performed in step (S2146). Then, proceed to step (S2150).

The information of the <credit> account information of the called single journalization is stored in the <temporary DB of cash inflows from operating activities of the statement of cash flow by indirect method in the non-cash business (145)> in step (S2150). Then, proceed to step (S2152).

The information on the <investing activities> and <financing activities> among the information stored in the <temporary DB of cash inflows from operating activities of the statement of cash flow by indirect method in the non-cash business> are removed in step (S2152). Then, proceed to step (S2154).

The information of the <credit> account information performed from the above processes is stored in the <cash inflows DB of the statement of cash flow by indirect method (140)> in step (S2154). Then, proceed to step (S2156).

A process of removing all information stored in the <temporary DB of cash inflows from operating activities of the statement of cash flow by indirect method in the non-cash business> is performed in step (S2156). Then, proceed to step (S2160).

Returning to the method of making the statement of cash flow by direct method, a process of removing the called single journalization from the <the temporary DB of the single journalization which waits to be inputted in the making mode> in step (S1160). Then, proceed to step (S1170).

A judgment whether there is the single journalization which will be additionally called in the <the temporary DB of the single journalization which waits to be inputted in the making mode> is performed in step (S1170). If there is the single journalization which will be additionally called in the <the temporary DB of the single journalization which waits to be inputted in the making mode> exists, proceed to the processing route of step (S1110). If there is no single journalization which will be additionally called in the <the temporary DB of the single journalization which waits to be inputted in the making mode> does not exist, the <making mode> is completed. FIGS. 29 and 30 of the present invention illustrate resulting values of the above process based on the data of FIGS. 17 and 19.

The detailed constitutional example of step (S430) is explained by referring to FIG. 28 (and FIG. 31). A process of outputting the statement of cash flow by direct method when the command to provide the statement of cash flow by direct method is given, by using <cash outflows information data of the statement of cash flow by direct method> and <cash inflows information data of the statement of cash flow by direct method>, which are obtained from the operation of the system (100) for automatically providing the statement of cash flow and the supplementary statements of the statement of cash flow by the [cash flow management server (150)] is performed in steps (S440) and (S450).

The <output mode of the statement of cash flow by direct method> is performed in steps (S440) and (S450). The (cash flow management server (150)) judges whether there is the command to provide the statement of cash flow by direct method or not in step (S440), and if there is the command, proceed to step (S450), and if there is no command (the command to provide the statement of cash flow by direct method), proceed to step (S441). If there is the command to provide the statement of cash flow by direct method (for example, a case that there is a request signal from the user interface or a command signal which is previously established in the cash flow management server (150)) in step (S440), the [cash flow management server (150)] automatically generates the statement of cash flow by direct method based on cash outflows information DB of the statement of cash flow by direct method and cash inflows information DB of the statement of cash flow by direct method, and outputs the statement of cash flow by direct method in a prescribed format in step (S451).

FIG. 32 of the present invention is a drawing which illustrates the detailed constitutional example of step (S450) of FIG. 4 according to the preferable examples of the present invention. When referring to FIG. 32 of the present invention, the output period is inputted in step (S1210). Then, a step of generating copies of cash outflows information DB of the statement of cash flow by direct method and cash inflows information DB of the statement of cash flow by direct method is performed in step (S1220). Then, a process of arranging the above copies in the order of the date is performed in step (S1230). Then, a process of deleting the arranged copies except the output period is performed in step (S1240). Then, a process of arranging the deleted copies except the output period by the order of 1) the item of the statement of cash flow item by the first classification, 2) the item of the statement of cash flow item by the second classification, 3) the item of the statement of cash flow item by the third classification, and 4) the date is performed in step (S1250). Then, a process of calculating the total amount per item of the statement of cash flow of the orderly arranged copies is performed in step (S1260). This total amount per item of the statement of cash flow is all performed in the first classification, the second classification, and the third classification. By automatically generating the statement of cash flow by direct method, by using the result obtained from the above processes, that is the data of the total amount per item of the statement of cash flow of the copies, and outputting it in step (S1270), a process of step (S450) is completed. Since a person skilled in the art can design a processing logic or a program so that (the cash flow management server (150)) of the system (100) can automatically perform step (S1270) based on the above explanation, the detailed description thereof is omitted. FIG. 33 (and FIG. 34) of the present invention are the drawings which illustrate the example of the statement of cash flow by direct method, generated and outputted according to the preferable examples of the present invention based on the data of FIGS. 29 and 30. Since a person skilled in the art can fully embody the constitution of automatically collecting the data, which correspond to each item of the statement of cash flow by direct method, based on the result of step (S430), and outputting it, the detailed explanation regarding this is omitted.

An <outputting mode of the statement of cash flow by indirect method> is performed in step (S441) and step (S451). After the (cash flow management server (150)) judges whether there is the command to provide the statement of cash flow by indirect method in step (S441), if there is the command, proceed to step (S451), and if there is no command (the command to provide the statement of cash flow by indirect method), proceed to step (S442). If there is the command to provide the statement of cash flow by indirect method (for example, if there is a request signal from the user interface or a command signal previously established in the cash flow management server (150)) in step (S441), the [cash flow management server (150)] automatically generates the statement of cash flow by indirect method based on cash outflows information DB of the statement of cash flow by indirect method and cash inflows information DB of the statement of cash flow by indirect method, and outputs the statement of cash flow by indirect method in a prescribed format in step (S451).

FIG. 35 of the present invention is a drawing which illustrates the detailed constitutional example of step (S451) of FIG. 4 according to the preferable examples of the present invention. When referring to FIG. 35 of the present invention, the output period is inputted in step (S1310). Then, a step of generating copies of cash outflows information DB of the statement of cash flow by indirect method and cash inflows information DB of the statement of cash flow by indirect method is performed in step (S1320). Then, a process of arranging the above copies in the order of the date is performed in step (S1330). Then, a process of deleting the arranged copies except the output period is performed in step (S1340). Then, a process of arranging the deleted copies except the output period by the order of 1) the item of the statement of cash flow item by the first classification, 2) the item of the statement of cash flow item by the second classification, 3) the item of the statement of cash flow item by the third classification, and 4) the date is performed in step (S1350). Then, a process of calculating the total amount per item of the statement of cash flow of the orderly arranged copies is performed in step (S1360). This total amount per item of the statement of cash flow is all performed in the first classification, the second classification, and the third classification. By automatically generating the statement of cash flow by indirect method, by using the result obtained from the above processes, that is the data of the total amount of the item of the statement of cash flow of the copies, and outputting it in step (S1370), a process of step (S451) is completed. Since a person skilled in the art can design a processing logic or a program so that (the cash flow management server (150)) of the system (100) can automatically perform step (S1370) based on the above explanation, the detailed description thereof is omitted. FIG. 36 (and FIG. 37) of the present invention are the drawings which illustrate the example of the statement of cash flow by indirect method, generated and outputted according to the preferable examples of the present invention based on the data of FIGS. 26 and 27. Since a person skilled in the art can fully embody the constitution of automatically collecting the data, which correspond to each item of the statement of cash flow by indirect method, based on the result of step (S430), and outputting it, the detailed explanation regarding this is omitted.

An <outputting mode of the supplementary statements of the statement of cash flow by direct method> is performed in step (S442) and step (S452). After the (cash flow management server (150)) judges whether there is the command to provide supplementary statements of the statement of cash flow by direct method in step (S442), if there is the command, proceed to step (S452), and if there is no command (the command to provide supplementary statements of the statement of cash flow by direct method), proceed to step (S443). If there is the command to provide supplementary statements of the statement of cash flow by direct method (for example, if there is a request signal from the user interface or a command signal previously established in the cash flow management server (150)) in step (S442), the [cash flow management server (150)] automatically generates supplementary statements of the statement of cash flow by direct method based on cash outflows information DB of the statement of cash flow by direct method and cash inflows information DB of the statement of cash flow by direct method, and outputs supplementary statements of the statement of cash flow by direct method in a prescribed format in step (S452).

FIG. 38 of the present invention is a drawing which illustrates the detailed constitutional example of step (S452) of FIG. 4 according to the preferable examples of the present invention. When referring to FIG. 38 of the present invention, the output period is inputted in step (S1410). Then, a step of generating copies of cash outflows information DB of the statement of cash flow by direct method and cash inflows information DB of the statement of cash flow by direct method is performed in step (S1420). Then, a process of arranging the above copies in the order of the date is performed in step (S1430). Then, a process of deleting the arranged copies except the output period is performed in step (S1440). Then, a process of arranging the deleted copies except the output period by the order of 1) the item of the statement of cash flow item by the first classification, 2) the item of the statement of cash flow item by the second classification, 3) the item of the statement of cash flow item by the third classification, and 4) the date is performed in step (S1450). By automatically generating supplementary statements of the statement of cash flow by direct method, by using the result obtained from the above processes, that is the data of the total amount per item of the statement of cash flow of the copies, and outputting it in step (S1480), a process of step (S452) is completed. Since a person skilled in the art can design a processing logic or a program so that (the cash flow management server (150)) of the system (100) can automatically perform step (S1480) based on the above explanation, the detailed description thereof is omitted. FIG. 39 (and FIG. 40) of the present invention are the drawings which illustrate the example of supplementary statements of the statement of cash flow by direct method, generated and outputted according to the preferable examples of the present invention based on the data of FIGS. 29 and 30. Since a person skilled in the art can fully embody the constitution of automatically collecting the data, which correspond to each item of supplementary statements of the statement of cash flow by direct method, based on the result of step (S430), and outputting it, the detailed explanation regarding this is omitted.

An <outputting mode of the supplementary statements of the statement of cash flow by indirect method> is performed in step (S443) and step (S453). After the (cash flow management server (150)) judges whether there is the command to provide supplementary statements of the statement of cash flow by indirect method in step (S443), if there is the command, proceed to step (S453), and if there is no command (the command to provide supplementary statements of the statement of cash flow by indirect method), the process is completed. If there is the command to provide supplementary statements of the statement of cash flow by indirect method (for example, if there is a request signal from the user interface or a command signal previously established in the cash flow management server (150)) in step (S443), the [cash flow management server (150)] automatically generates supplementary statements of the statement of cash flow by indirect method based on cash outflows information DB of the statement of cash flow by indirect method and cash inflows information DB of the statement of cash flow by indirect method, and outputs supplementary statements of the statement of cash flow by indirect method in a prescribed format in step (S453).

FIG. 41 of the present invention is a drawing which illustrates the detailed constitutional example of step (S453) of FIG. 4 according to the preferable examples of the present invention. When referring to FIG. 41 of the present invention, the output period is inputted in step (S1510). Then, a step of generating copies of the cash outflows information DB of the statement of cash flow by indirect method and cash inflows information DB of the statement of cash flow by indirect method is performed in step (S1520). Then, a process of arranging the above copies in the order of the date is performed in step (S1530). Then, a process of deleting the arranged copies except the output period is performed in step (S1540). Then, a process of arranging the deleted copies except the output period by the order of 1) the item of the statement of cash flow item by the first classification, 2) the item of the statement of cash flow item by the second classification, 3) the item of the statement of cash flow item by the third classification, and 4) the date is performed in step (S1550). By automatically generating supplementary statements of the statement of cash flow by indirect method, by using the result obtained from the above processes, that is the data of the total amount per item of the statement of cash flow of the copies, and outputting it in step (S1580), a process of step (S453) is completed. Since a person skilled in the art can design a processing logic or a program so that (the cash flow management server (150)) of the system (100) can automatically perform step (S1580) based on the above explanation, the detailed description thereof is omitted. FIG. 42 (and FIG. 43) of the present invention are the drawings which illustrate the example of supplementary statements of the statement of cash flow by indirect method, generated and outputted according to the preferable examples of the present invention based on the data of FIGS. 26 and 27. Since a person skilled in the art can fully embody the constitution of automatically collecting the data, which correspond to each item of supplementary statements of the statement of cash flow by indirect method, based on the result of step (S430), and outputting it, the detailed explanation regarding this is omitted.

Hereby, a process of embodying the method for automatically providing the statement of cash flow and the supplementary statements of the statement of cash flow according to the preferable examples of the present invention is completed.

FIGS. 34, 37, 40, and 43, which are additionally enclosed, are new forms of statement of cash flow which connect the statement of cash flow and supplementary statements of the statement of cash flow through a <supplementary statements number>. Since the information user can easily find the statement of cash flow and related supplementary statements of the statement of cash flow through this statement of cash flow and the supplementary statements of the statement of cash flow, and also find the related date of cash income and cash expenditure, related account number, and the reference number with regard to the related written income resolutions and written expenditure resolutions from the supplementary statements of the statement of cash flow, a usefulness of this new forms of the statement of cash flow may be maximum. To make the accrual dates of cash income and cash expenditure and the actual accrual dates be the same with the dates described in the statement of cash flow, the information described in the statement of cash flow should be determined at the time of inputting the accounting information. The present invention firstly introduces the above process, and it also firstly provides the statement of cash flow and supplementary statements of the statement of cash flow in this form.

Although the present invention explains the specific examples, a person skilled in the art can certainly change the design of the invention without deviating from the scope of the present invention, which is defined by the claims below. Especially, although the present invention explains the item of the statement of cash flow by the minimum divisional indication, which the business accounting standards require, Korea Accounting Standards Board, which takes charge of an enactment of Korean accounting operation standards, encourages to classify more specifically than the required minimum divisional indication when describing cash flows from operating activities by direct method. A person skilled in the art can easily understand that the present invention can be easily transformed to the method of specifically classifying and reporting.

### BRIEF DESCRIPTION OF THE DRAWINGS

FIG. 1 is a drawing of a broad example of the statement of cash flow by the prior direct method.

FIG. 2 is a drawing of a broad example of the statement of cash flow by the common indirect method

FIG. 3 is a broad block diagram of a system for automatically providing the statement of cash flow and supplementary statements of the statement of cash flow and peripheral systems thereof according to the preferable examples of the present invention.

FIG. 4 is a drawing of an embodiment process of the method for automatically providing the statement of cash flow according to the preferable examples of the present invention.

FIG. 5 is a drawing of an input mode for making the statement of cash flow by direct method of FIG. 4 according to the preferable examples of the present invention.

FIG. 6 is a drawing of a mode of converting the journalization into the single journalization for the input mode of FIG. 5 according to the preferable examples of the present invention.

FIG. 7 is a drawing of a non-cash non-cash mode for the mode of converting the journalization into the single journalization of FIG. 6 according to the preferable examples of the present invention.

FIG. 8 is a drawing of a non-cash cash mode for the mode of converting the journalization into the single journalization of FIG. 6 according to the preferable examples of the present invention.

FIG. 9 is a drawing of a cash non-cash mode for the mode of converting the journalization into the single journalization of FIG. 6 according to the preferable examples of the present invention.

FIG. 10 is a drawing of a cash cash mode for the mode of converting the journalization into the single journalization of FIG. 6 according to the preferable examples of the present invention.

FIG. 11 is a drawing of journalization numbers 1 and 2 among the accounting information of FIG. 5 according to the preferable examples of the present invention.

FIG. 12 is a drawing of journalization number 1 among the accounting information of FIG. 5 according to the preferable examples of the present invention.

FIG. 13 is a drawing of examples of an input of the accounting information and an establishment of the item of the statement of cash flow with regard to journalization number 1 according to the preferable examples of the present invention.

FIG. 14 is a drawing of a resulting value of the non-cash non-cash mode of FIG. 8 with regard to account number 1 of journalization number 1.

FIG. 15 is a drawing of a resulting value of the non-cash cash mode of FIG. 9 with regard to account number 1 of journalization number 1.

FIG. 16 is a drawing of a resulting value of the cash non-cash mode of FIG. 10 with regard to account number 1 of journalization number 1.

FIG. 17 is a drawing of a resulting value of the cash cash mode of FIG. 11 with regard to account number 1 of journalization number 1.

FIG. 18 is a drawing of examples of an input of accounting information and an establishment of an item of the statement of cash flow with regard to journalization number 2 according to the preferable examples of the present invention.

FIG. 19 is a drawing of the resulting values of the non-cash non-cash mode, non-cash cash mode, cash non-cash mode, and cash cash mode of FIGS. 8, 9, 10, and 11 with regard to journalization number 2.

FIG. 20 is a flow chart of a detailed constitutional example of the establishing mode of the item of the statement of cash flow by direct method (debit) of FIG. 5 according to the preferable examples of the present invention.

FIG. 21 is a flow chart of a detailed constitutional example of the establishing mode of the item of the statement of cash flow by direct method (credit) of FIG. 5 according to the preferable examples of the present invention.

FIG. 22 is a flow chart of a detailed constitutional example of the establishing mode of the item of the statement of cash flow by indirect method (debit) of FIG. 5 according to the preferable examples of the present invention.

FIG. 23 is a flow chart of a detailed constitutional example of the establishment mode of the item of the statement of cash flow by indirect method (credit) of FIG. 5 according to the preferable examples of the present invention.

FIG. 24 is a drawing of the resulting values of performing the non-cash non-cash mode, non-cash cash mode, cash non-cash mode, and cash cash mode of FIGS. 8, 9, 10, and 11 with regard to journalization numbers 1 and 2 by the flow of indirect method.

FIG. 25 is a drawing of the input mode for making the statement of cash flow by indirect method of FIG. 4 according to the preferable examples of the present invention.

FIG. 26 is a drawing of constitutional examples of cash outflows data of the statement of cash flow and cash inflows data of the statement of cash flow by indirect method of FIG. 31 with regard to journalization number 1 according to the preferable examples of the present invention.

FIG. 27 is a drawing of constitutional examples of cash outflows data of the statement of cash flow and cash inflows data of the statement of cash flow by indirect method of FIG. 31 with regard to journalization number 2 according to the preferable examples of the present invention.

FIG. 28 is a drawing of the making mode for making the statement of cash flow by direct method of FIG. 4 according to the preferable examples of the present invention.

FIG. 29 is a drawing of constitutional examples of cash outflows data of the statement of cash flow and cash inflows data of the statement of cash flow by direct method of FIG. 28 with regard to journalization number 1 according to the preferable examples of the present invention.

FIG. 30 is a drawing of constitutional examples of cash outflows data of the statement of cash flow and cash inflows data of the statement of cash flow by direct method of FIG. 28 with regard to journalization number 2 according to the preferable examples of the present invention.

FIG. 31 is a drawing of the making mode for making the statement of cash flow by indirect method of FIG. 4 according to the preferable examples of the present invention.

FIG. 32 is a reference drawing to explain a process of automatically generating the statement of cash flow by direct method according to the preferable examples of the present invention.

FIG. 33 is a drawing of an example of the statement of cash flow by direct method, which is generated from the statement of cash flow by direct method of FIG. 32 according to the preferable examples of the present invention, by using the data of FIGS. 29 and 30.

FIG. 34 is a drawing of a supplementary statements number related to the example of the statement of cash flow by direct method, which is generated from the statement of cash flow by direct method of FIG. 32 according to the preferable examples of the present invention, by using the data of FIGS. 29 and 30.

FIG. 35 is a reference drawing to explain a process of automatically generating the statement of cash flow by indirect method according to the preferable examples of the present invention.

FIG. 36 is a drawing of an example of the statement of cash flow by indirect method, which is generated from the statement of cash flow by indirect method of FIG. 35 according to the preferable examples of the present invention, by using the data of FIGS. 26 and 27.

FIG. 37 is a drawing of the supplementary statements number related to the example of the statement of cash flow by indirect method, which is generated from the statement of cash flow by indirect method of FIG. 35 according to the preferable examples of the present invention, by using the data of FIGS. 26 and 27.

FIG. 38 is a reference drawing to explain a process of automatically generating supplementary statements of the statement of cash flow by direct method according to the preferable examples of the present invention.

FIG. 39 is a drawing of an example of supplementary statements of the statement of cash flow by direct method, which is generated from the statement of cash flow by direct method of FIG. 38 according to the preferable examples of the present invention, by using the data of FIGS. 29 and 30.

FIG. 40 is a drawing of the supplementary statements number related to the example of supplementary statements of the statement of cash flow by direct method, which is generated from the statement of cash flow by direct method of FIG. 38 according to the preferable examples of the present invention, by using the data of FIGS. 29 and 30.

FIG. 41 is a reference drawing to explain a process of automatically generating supplementary statements of the statement of cash flow by indirect method according to the preferable examples of the present invention.

FIG. 42 is a drawing of an example of the supplementary statements of the statement of cash flow by indirect method, which is generated from the statement of cash flow by indirect method of FIG. 41 according to the preferable examples of the present invention, by using the data of FIGS. 26 and 27.

FIG. 43 is a drawing of the supplementary statements number related to the example of supplementary statements of the statement of cash flow by indirect method, which is generated from the statement of cash flow by indirect method of FIG. 41 according to the preferable examples of the present invention, by using the data of FIGS. 26 and 27.

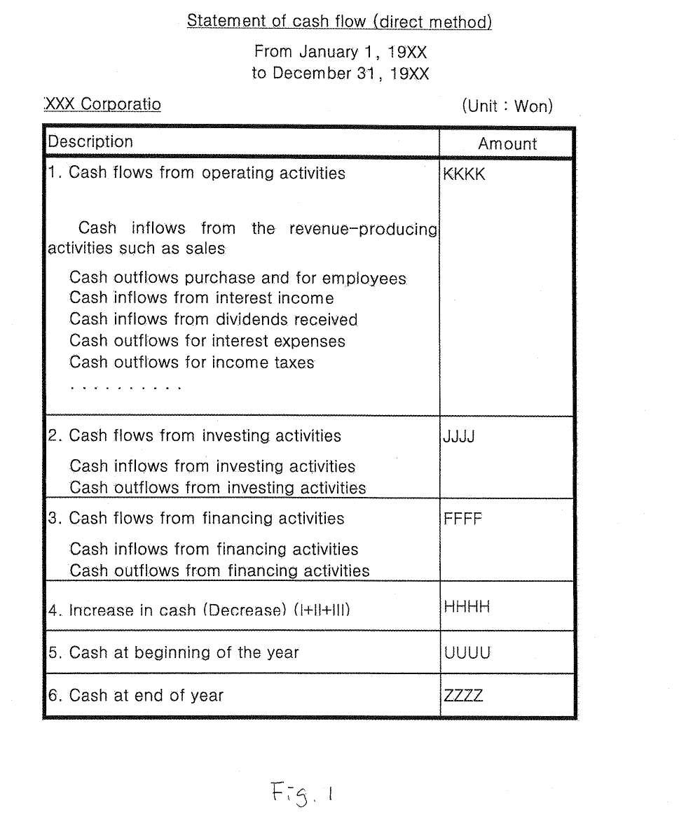

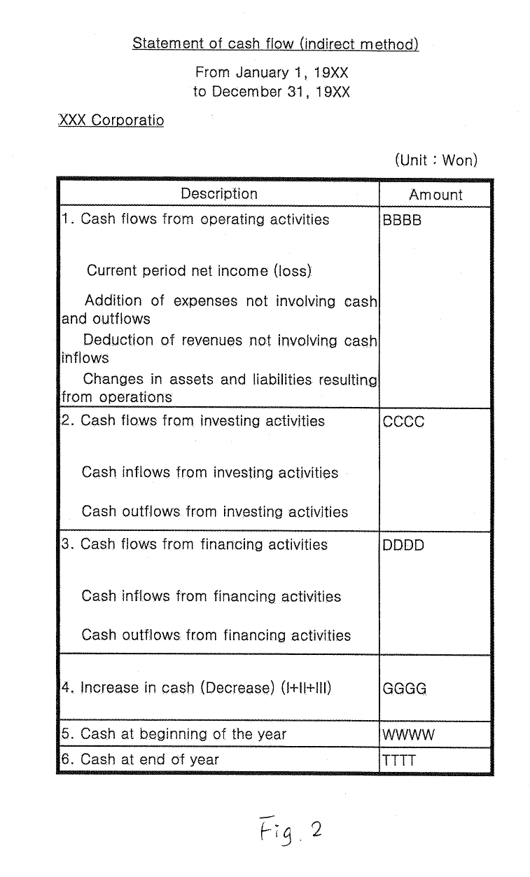

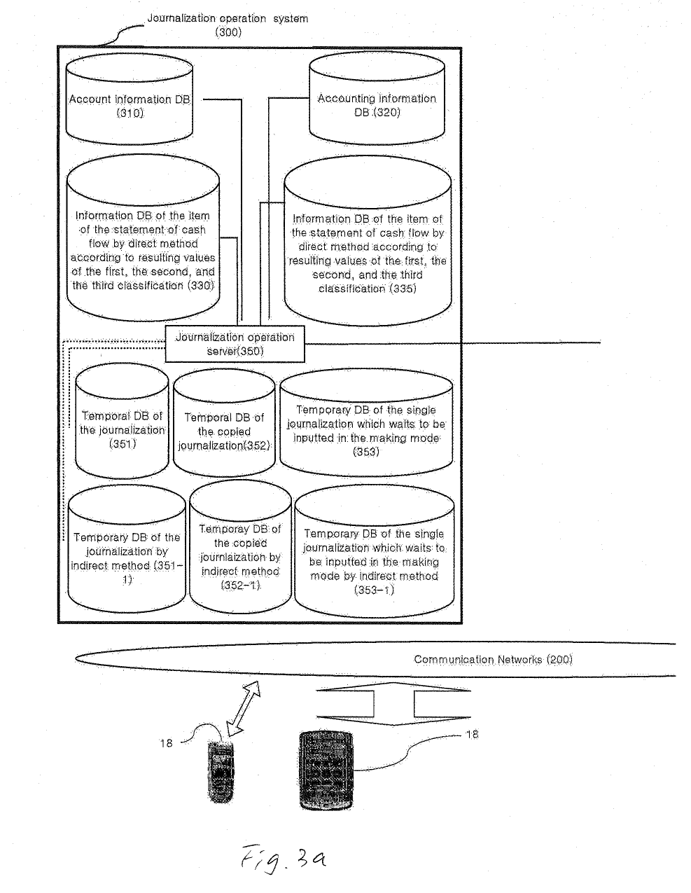

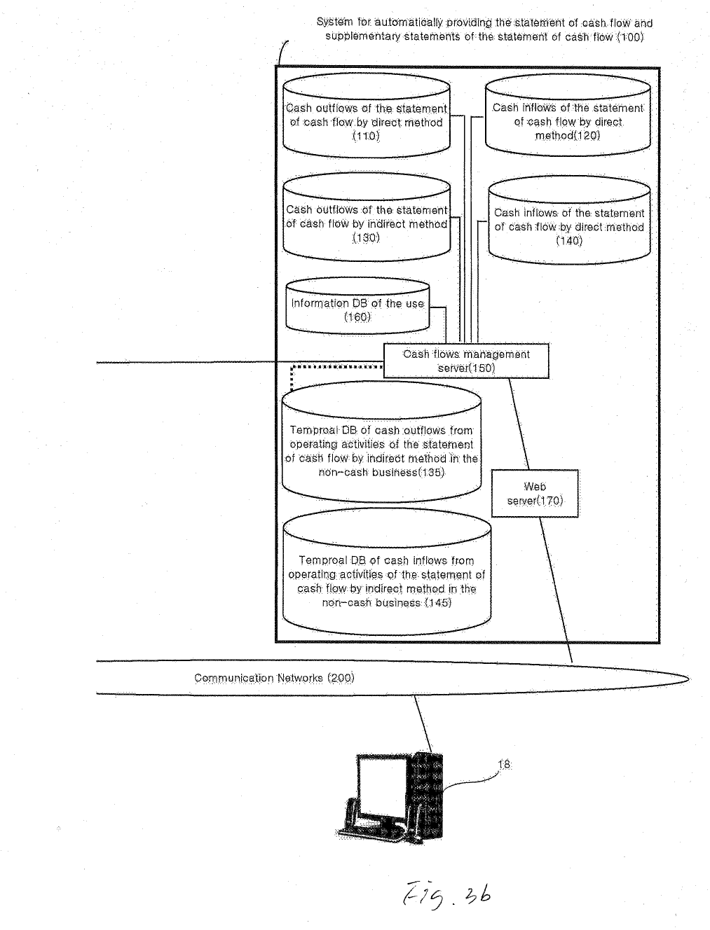

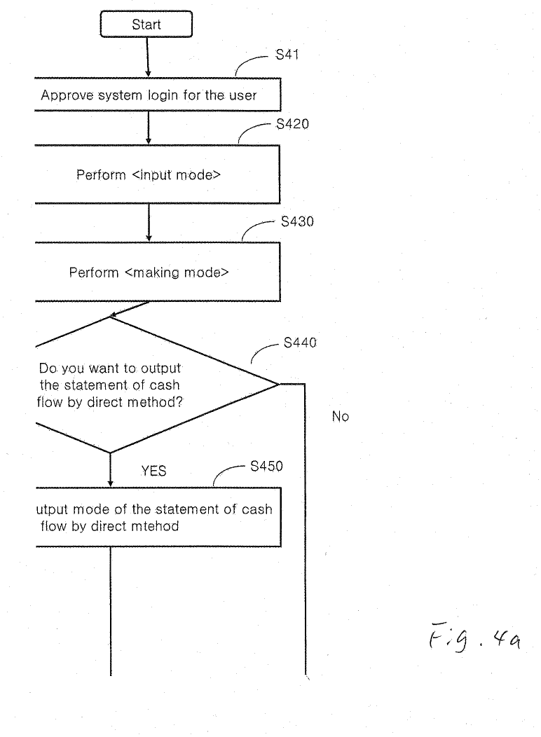

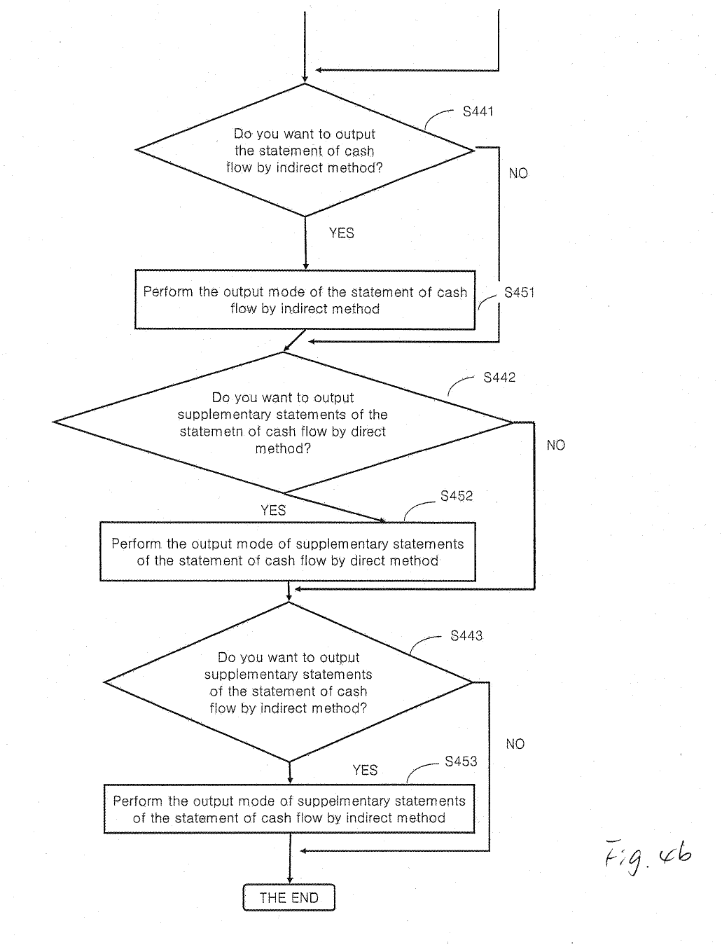

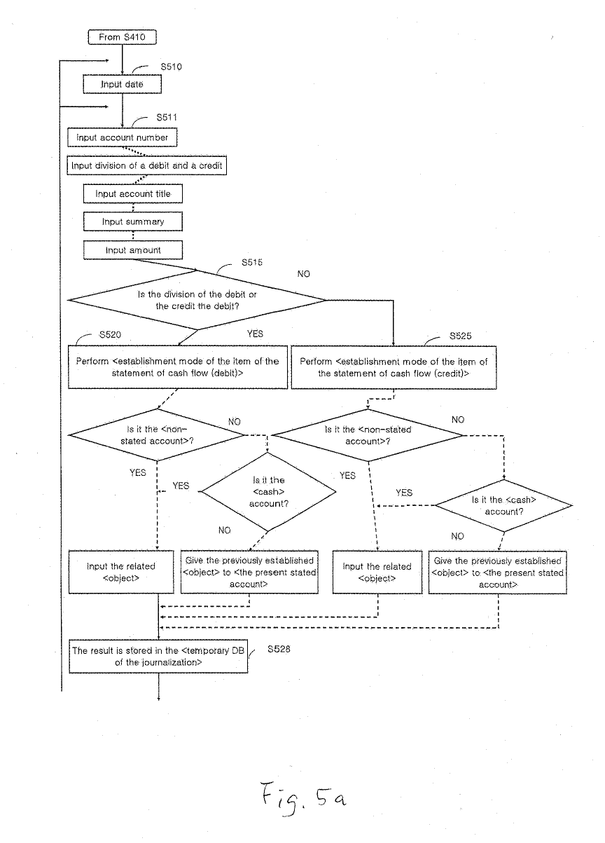

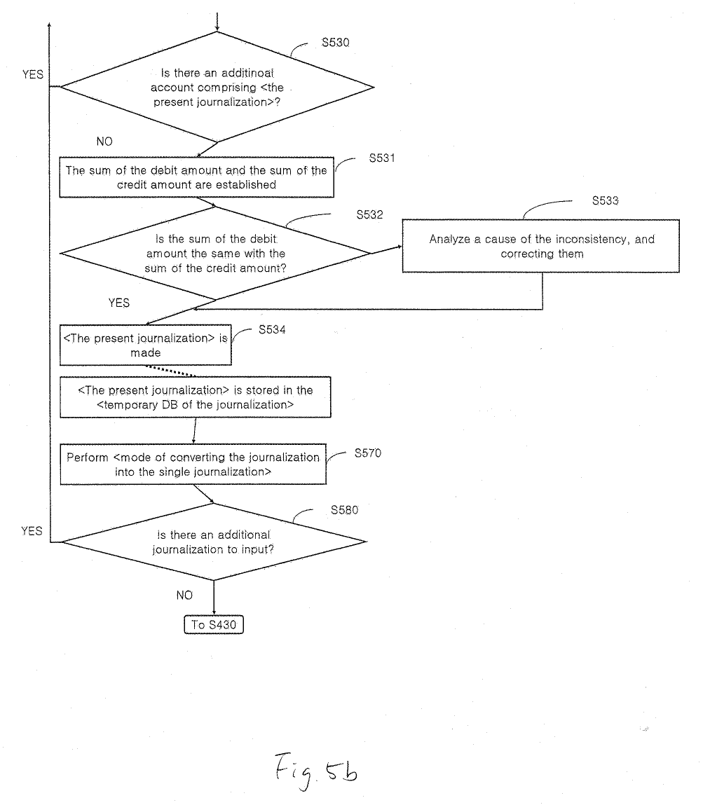

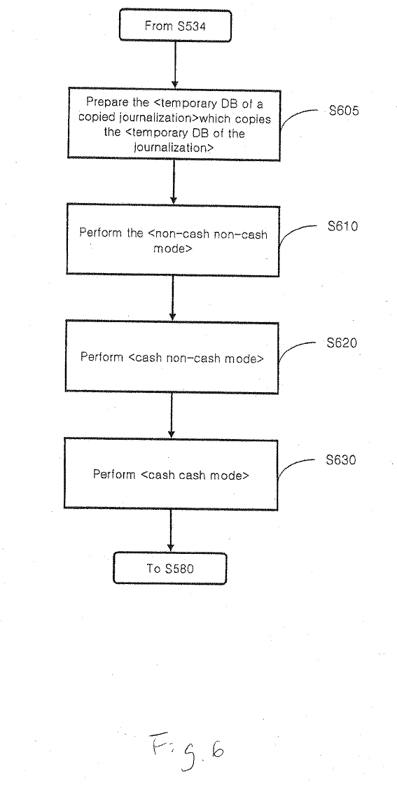

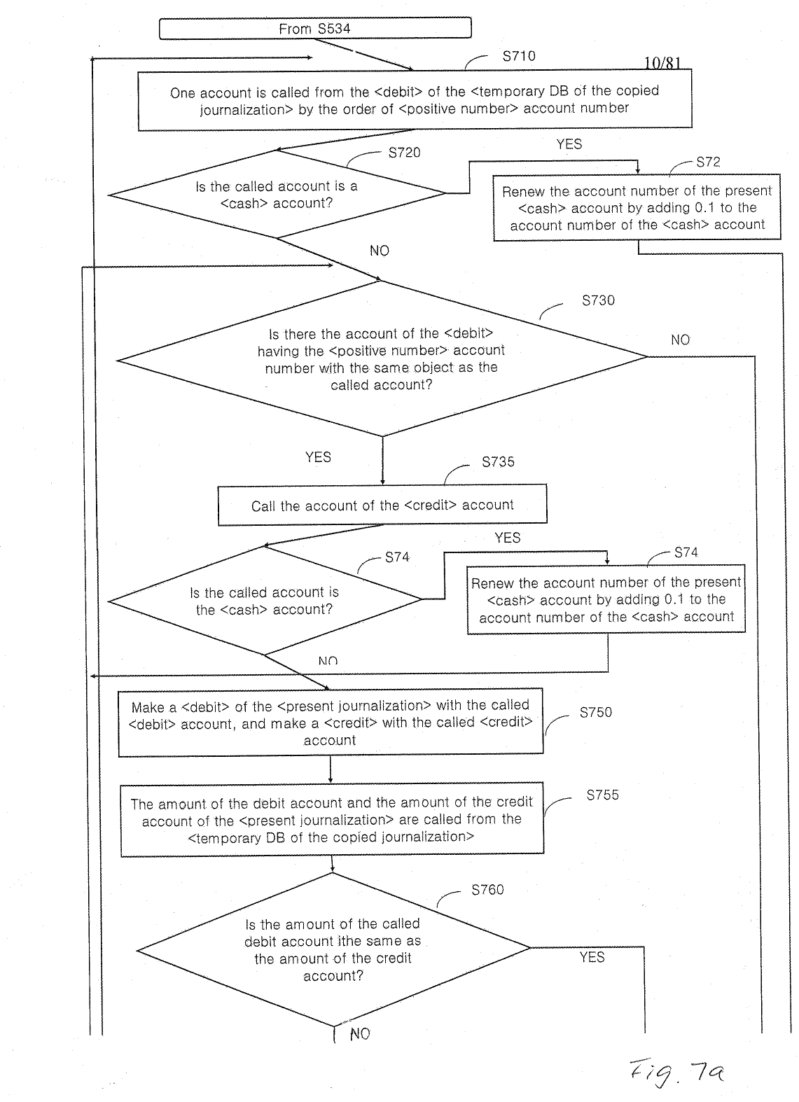

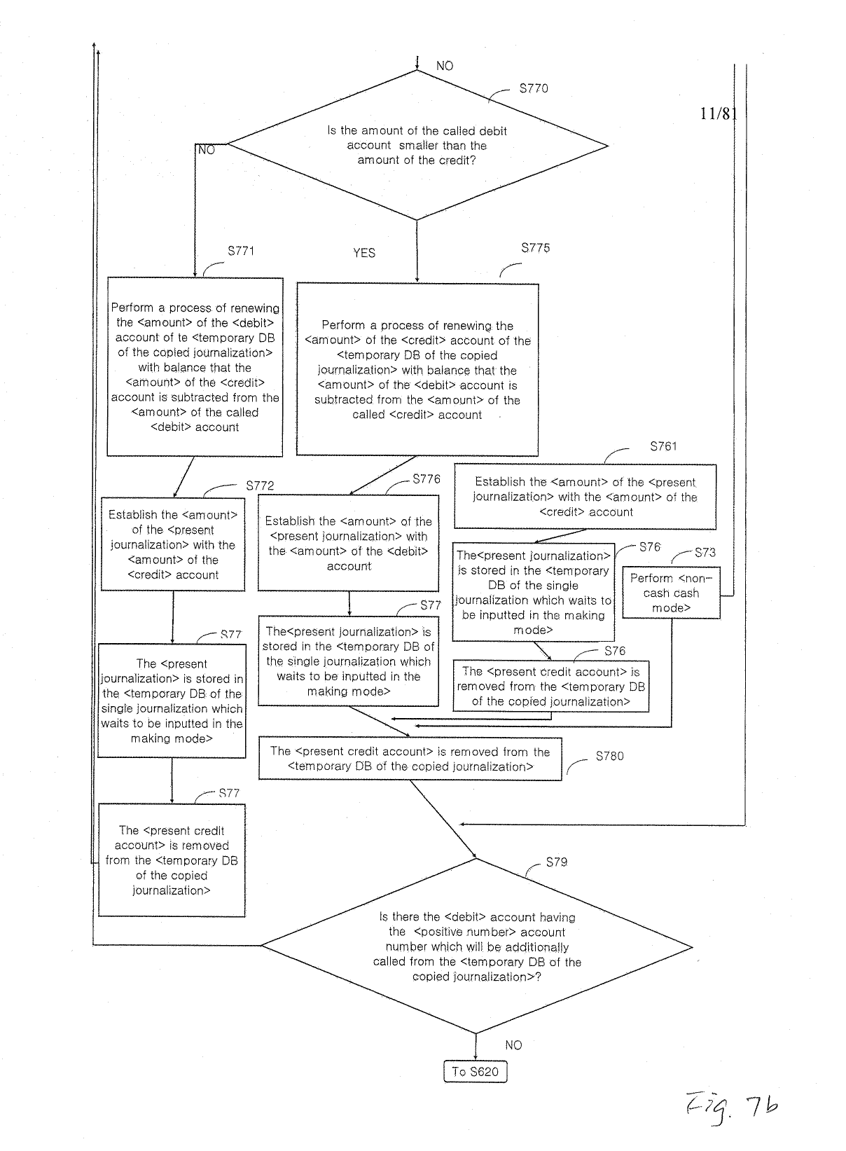

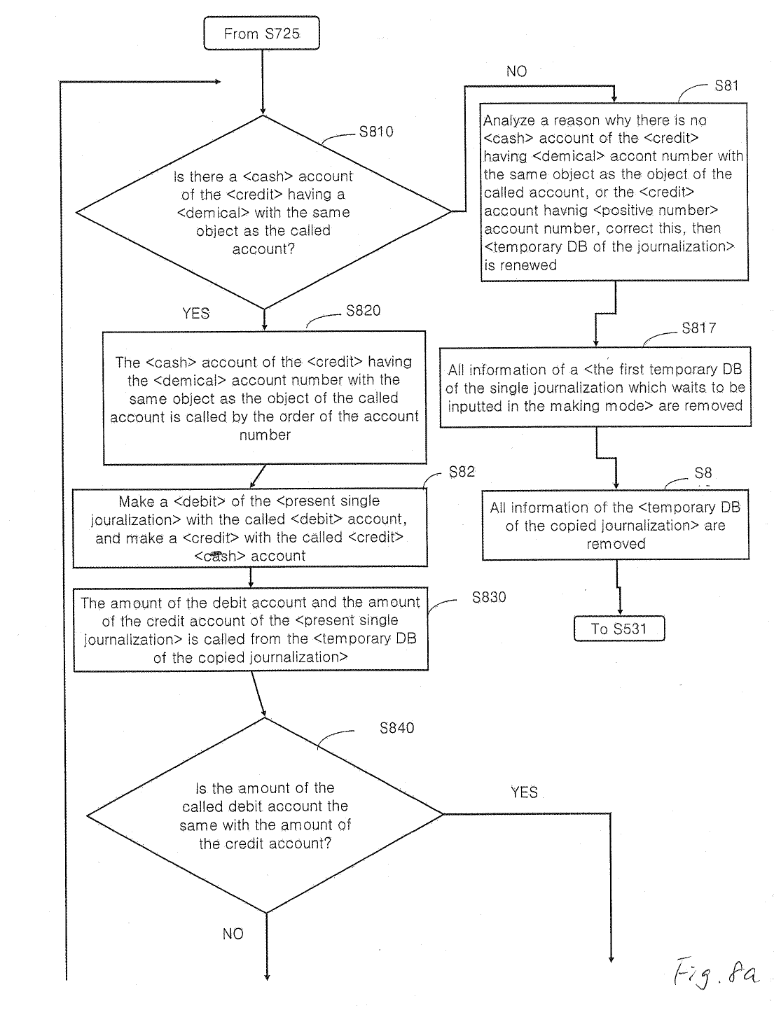

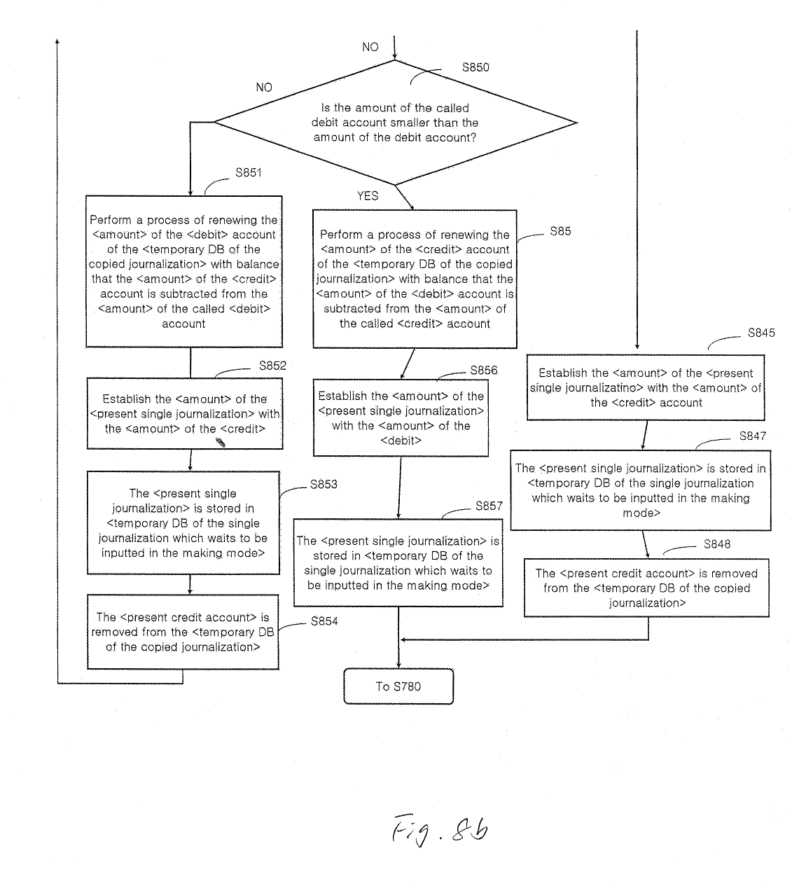

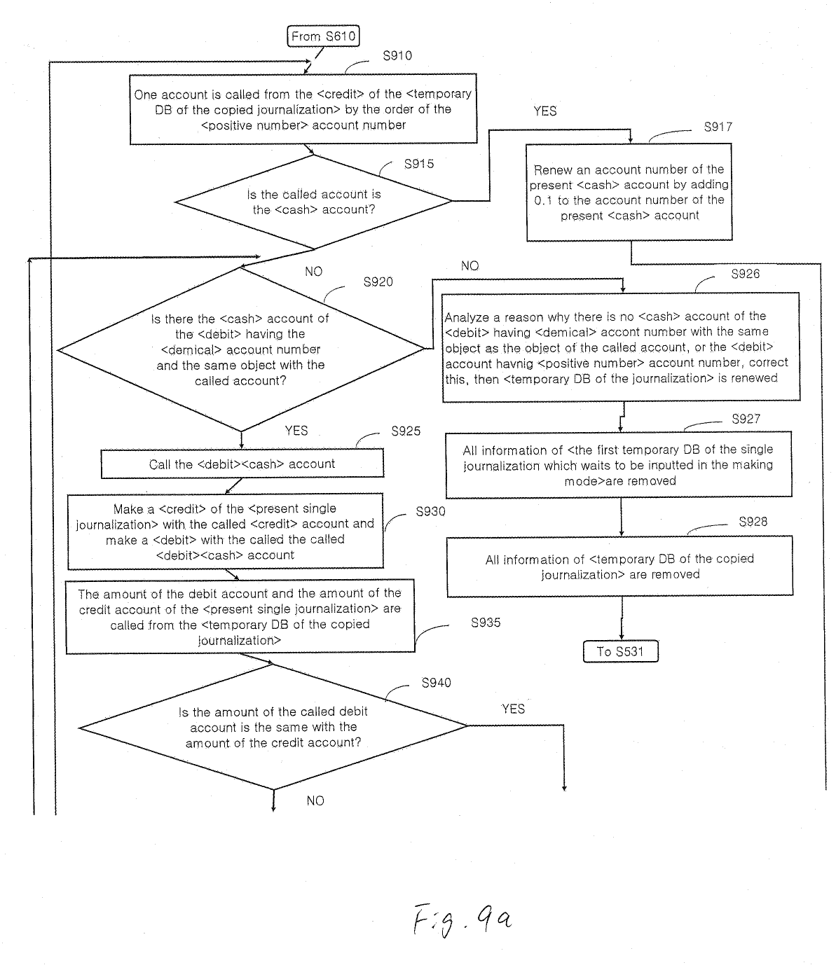

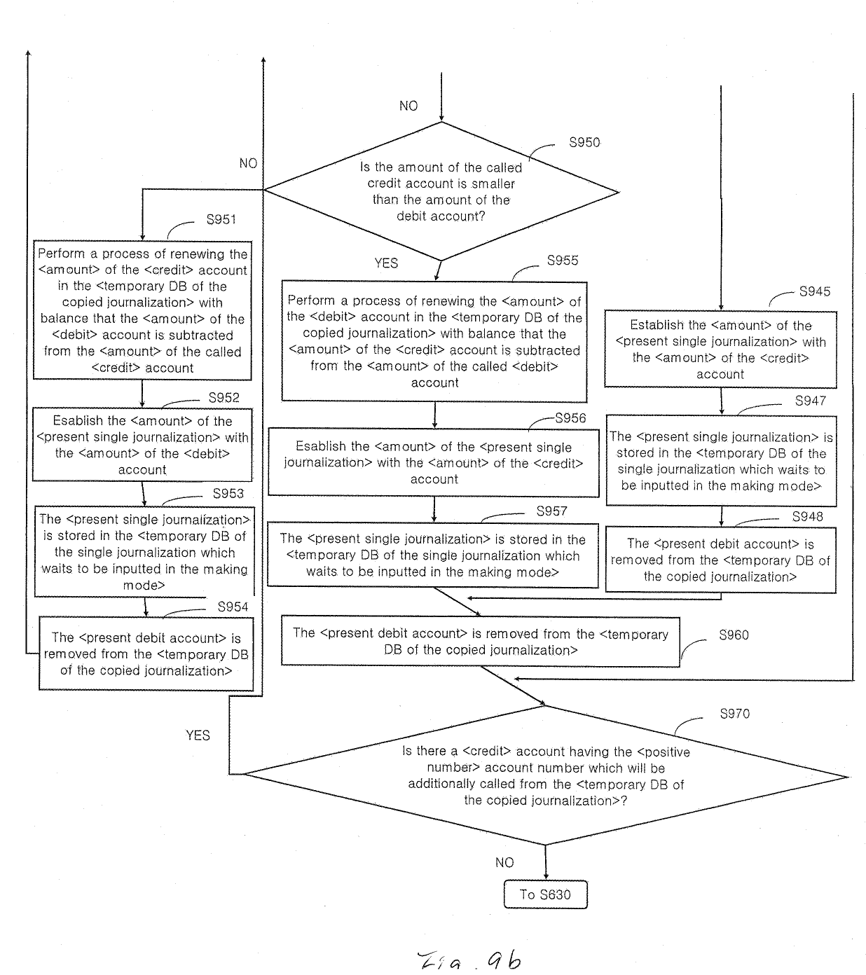

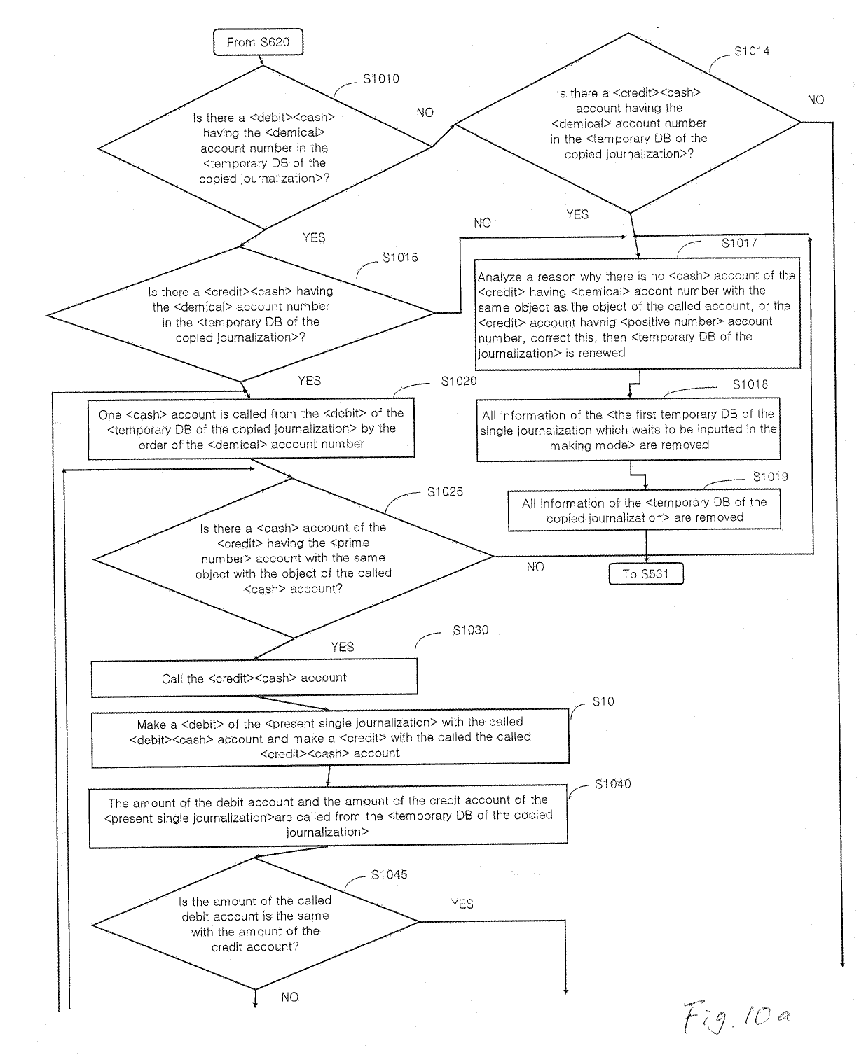

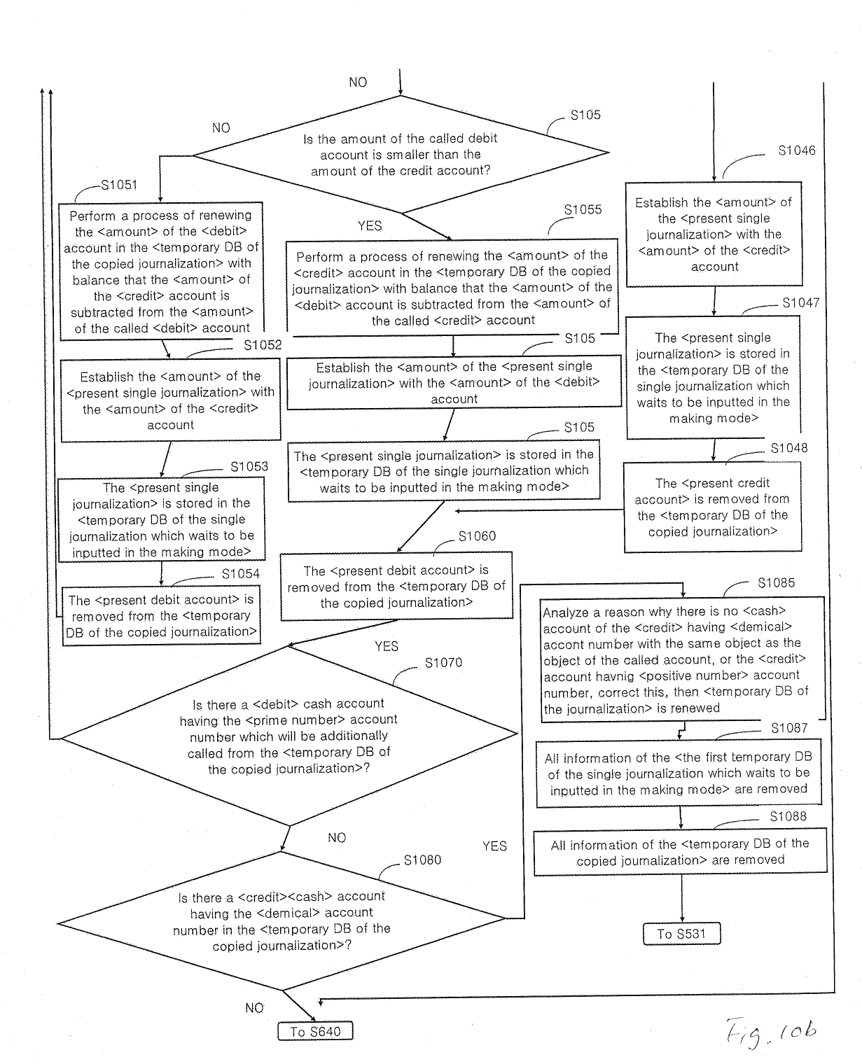

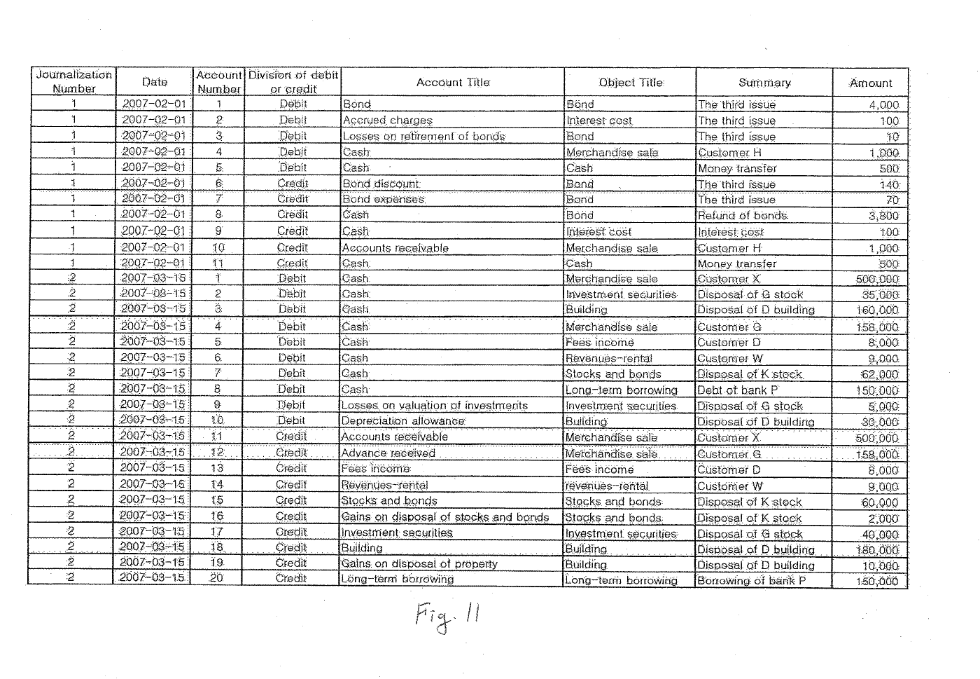

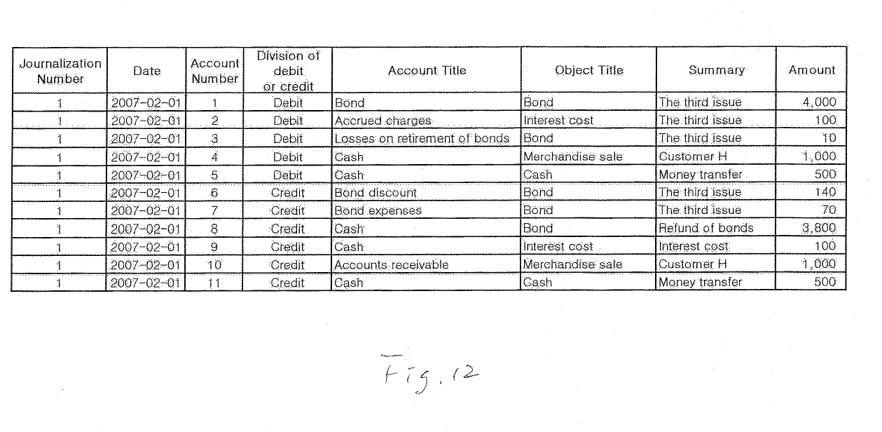

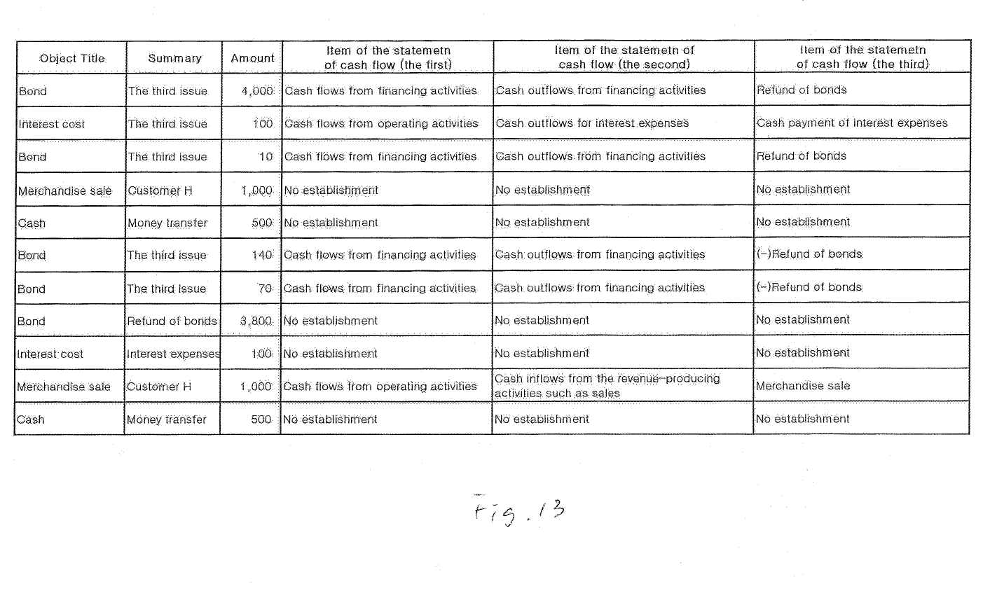

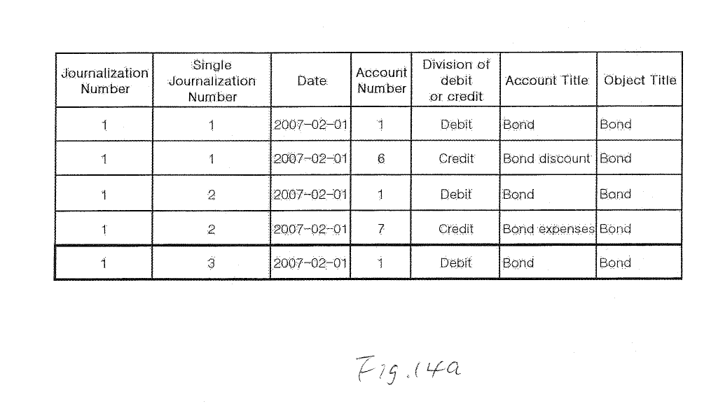

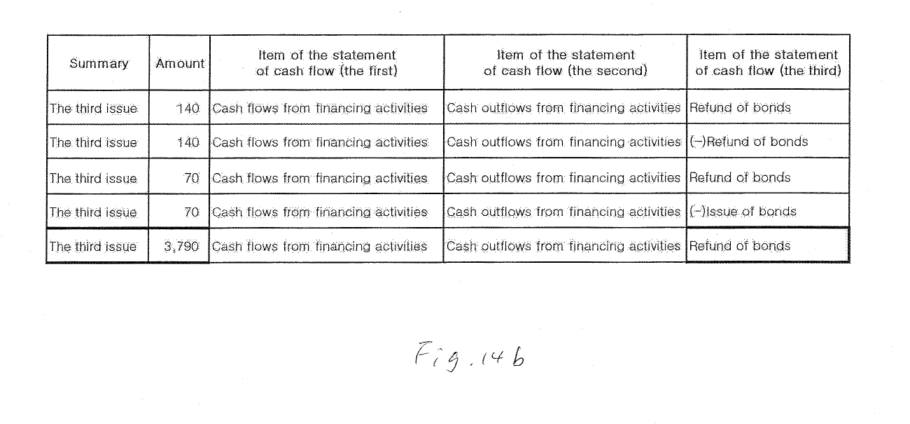

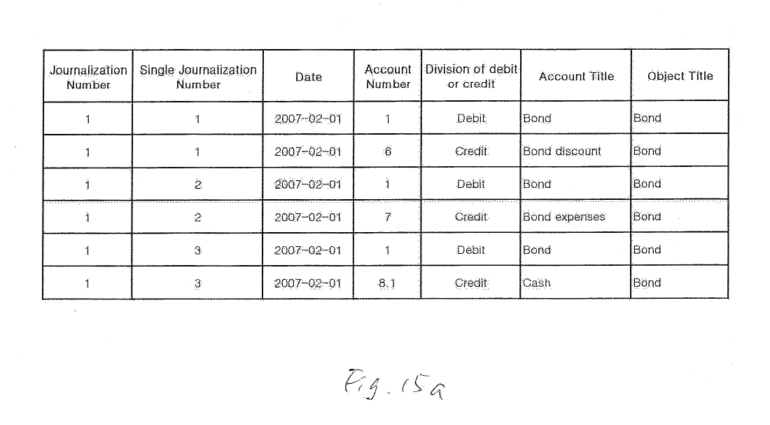

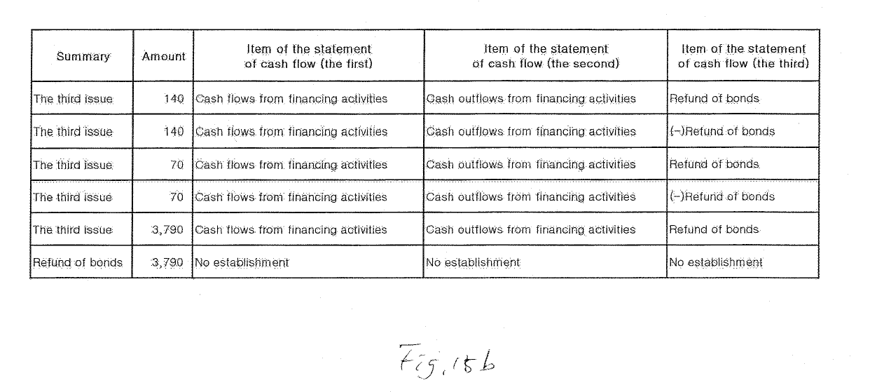

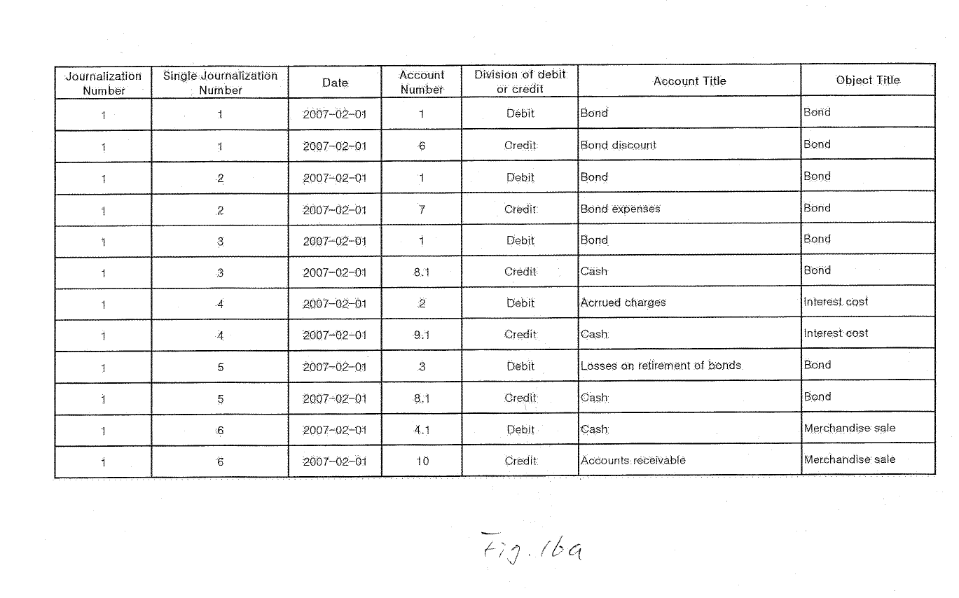

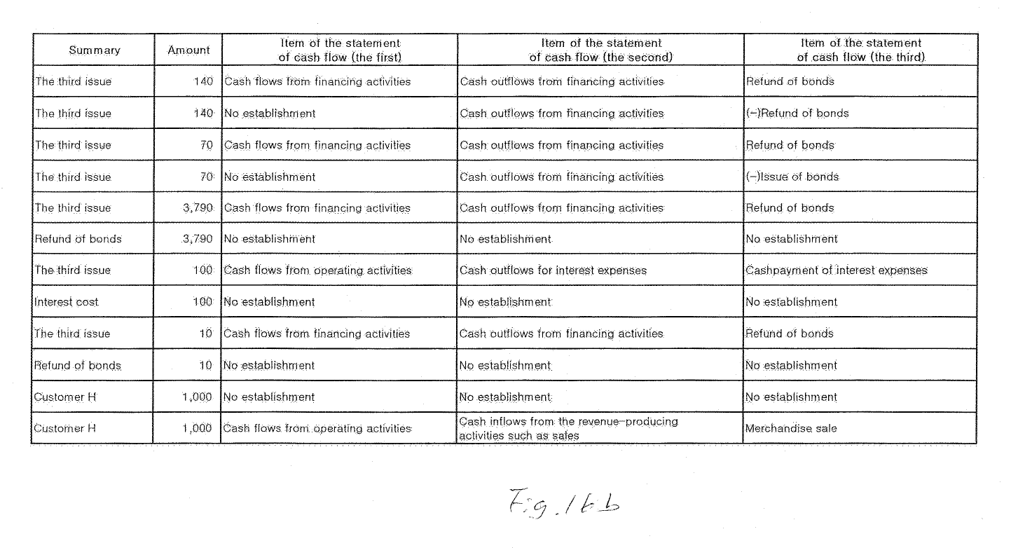

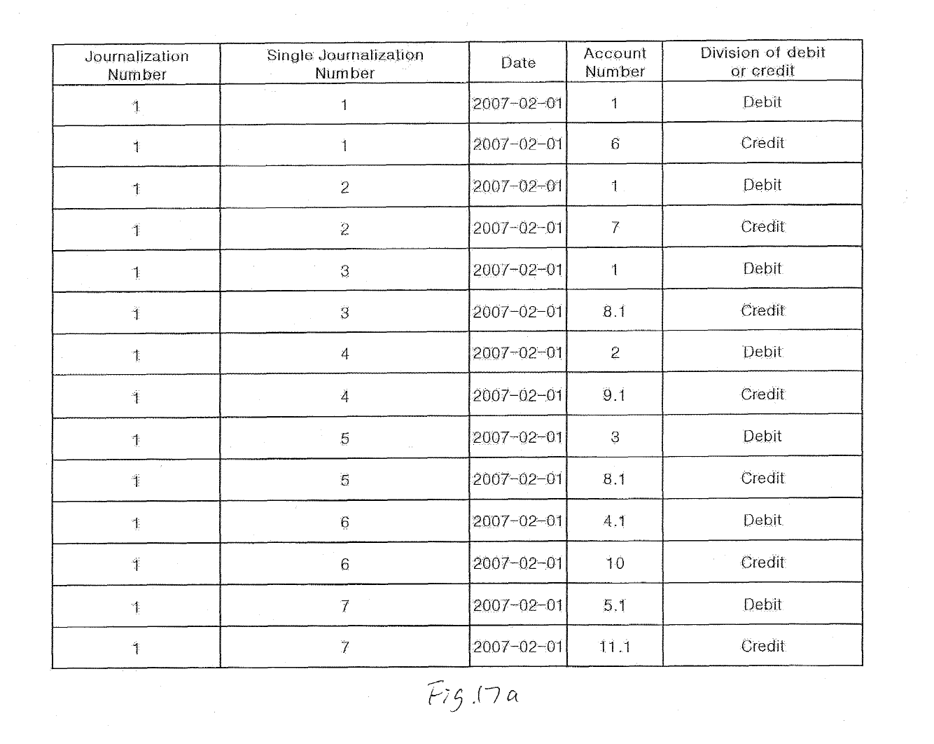

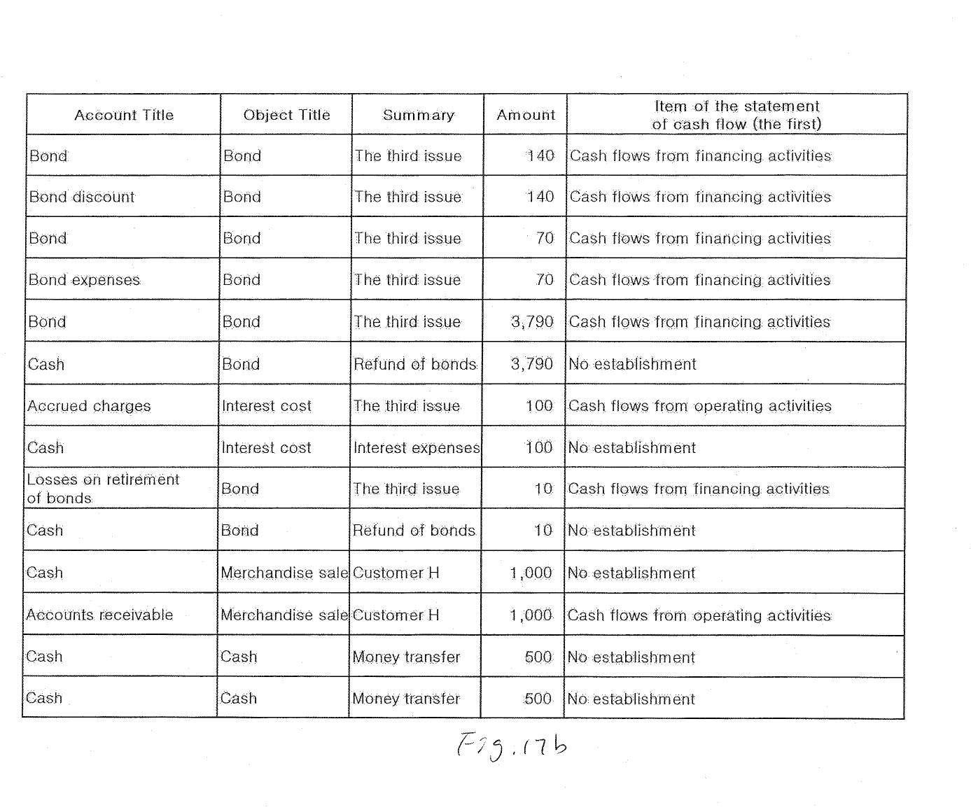

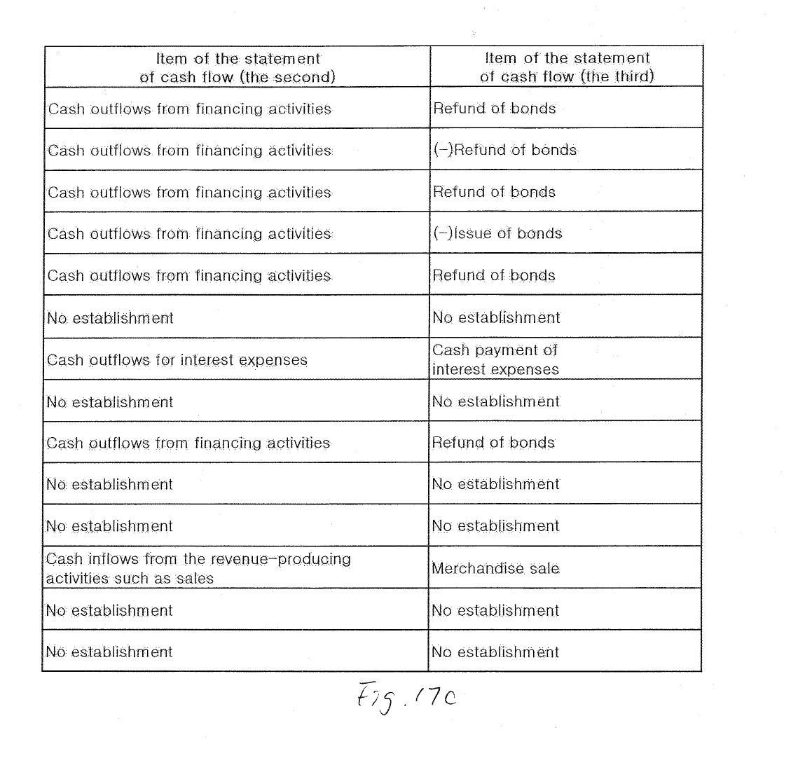

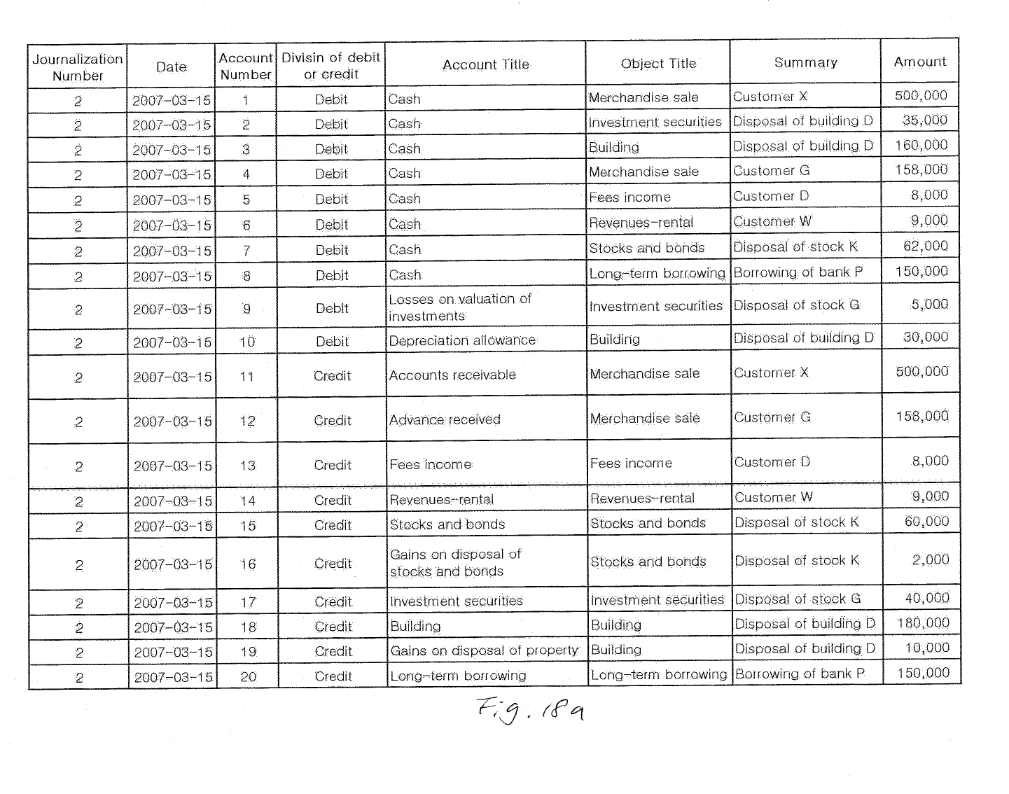

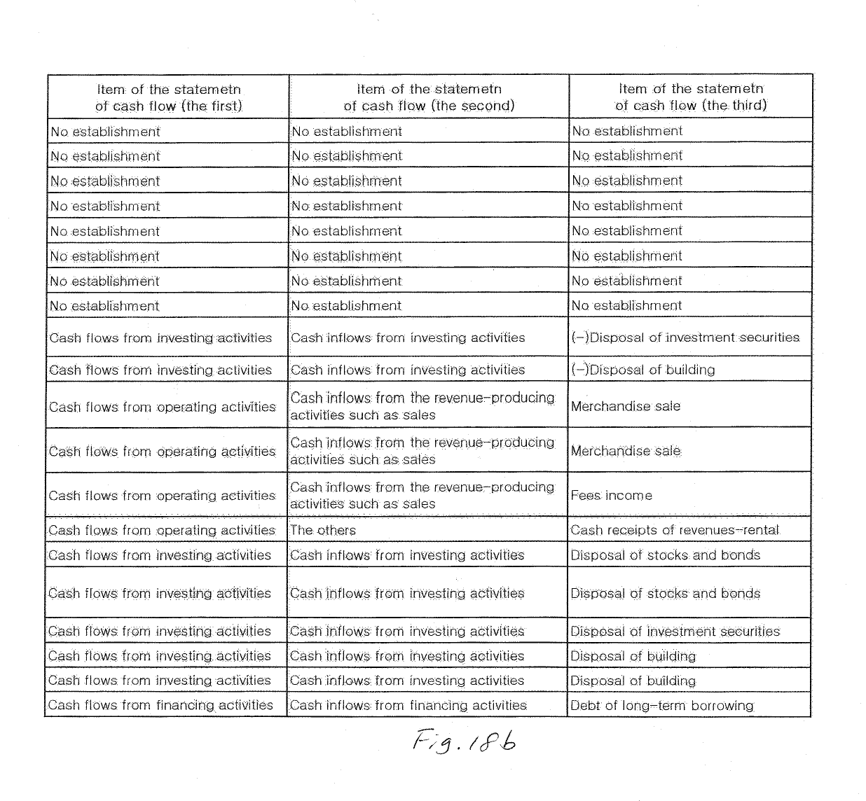

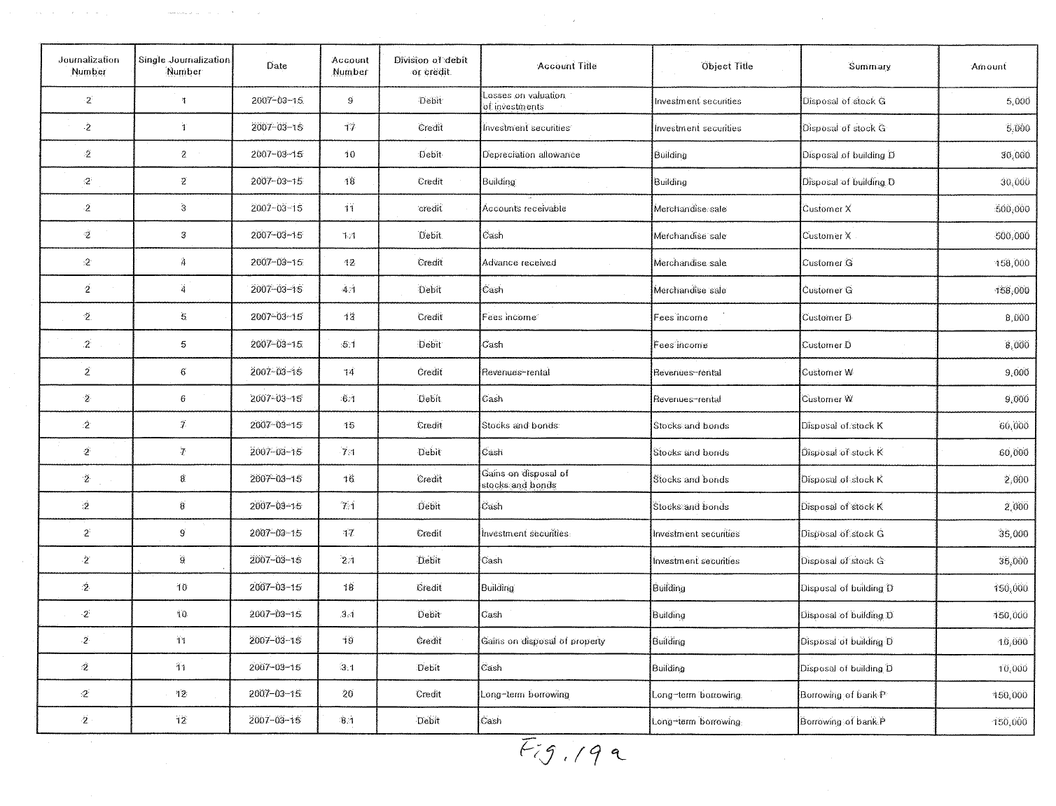

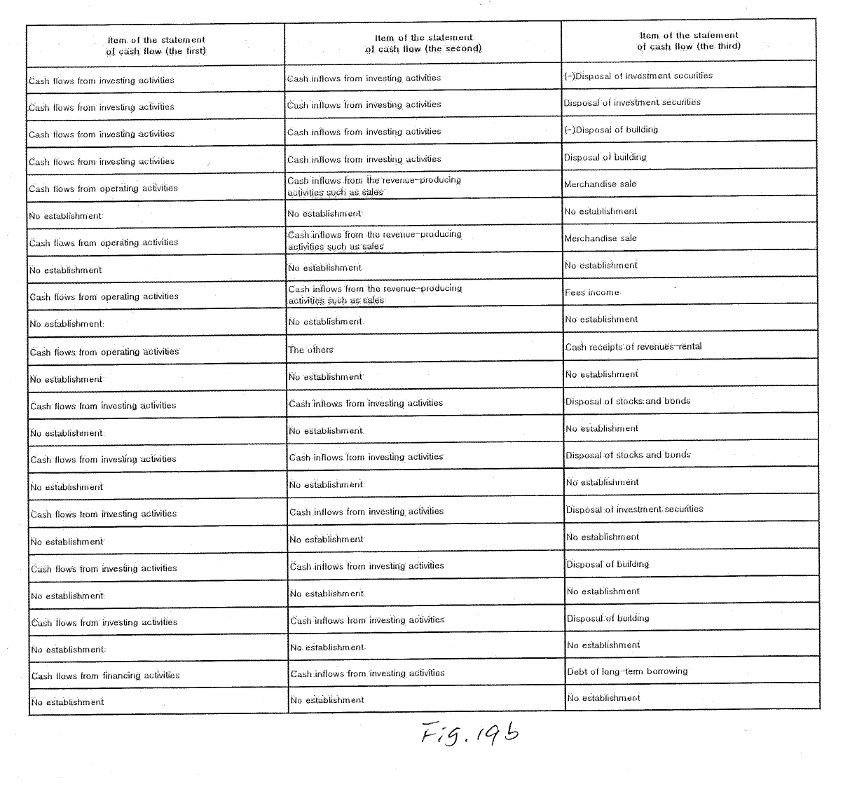

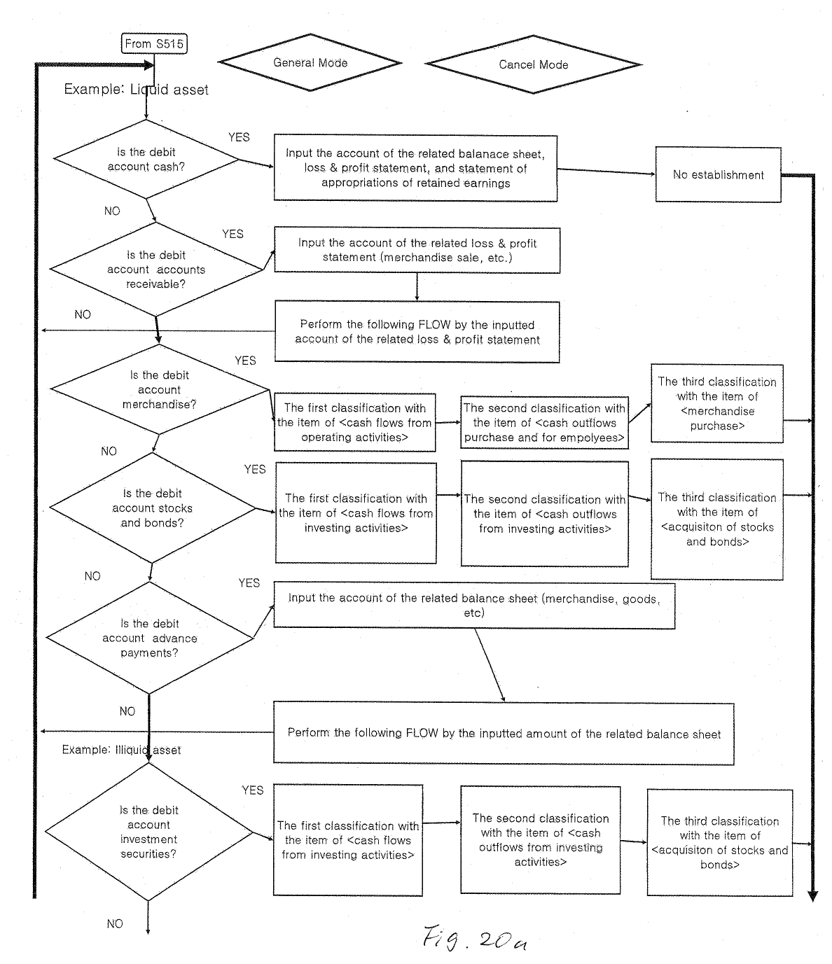

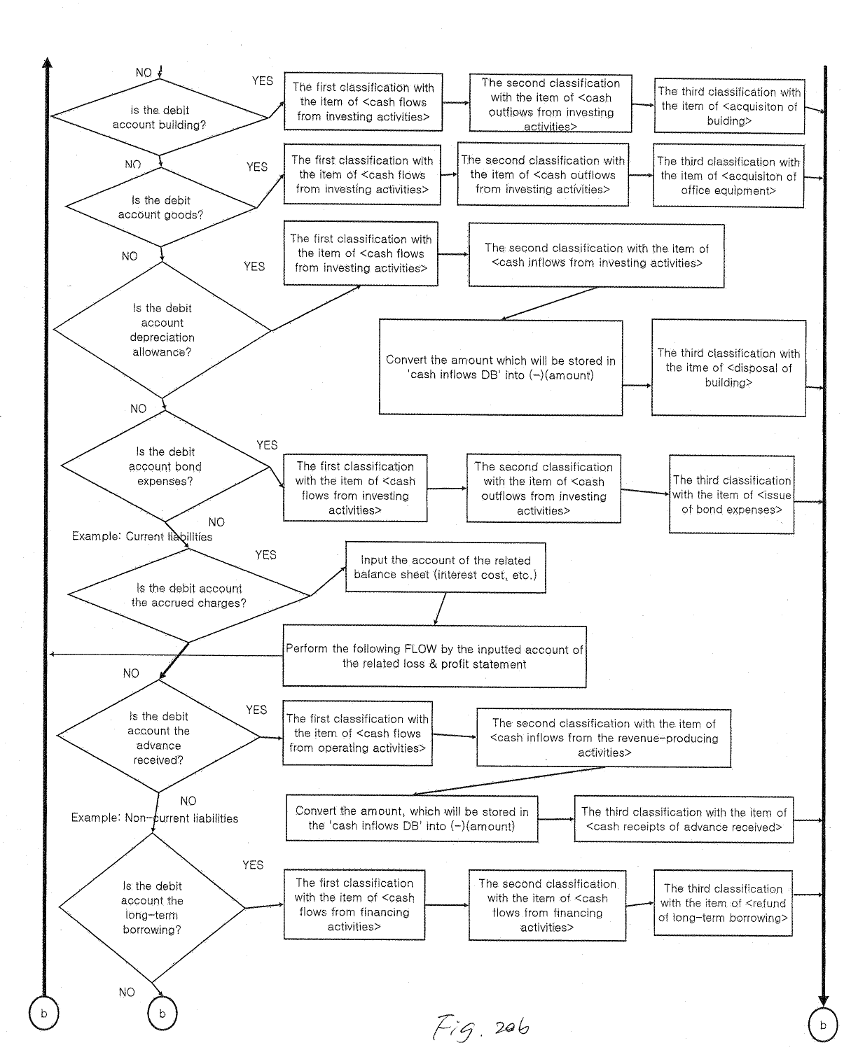

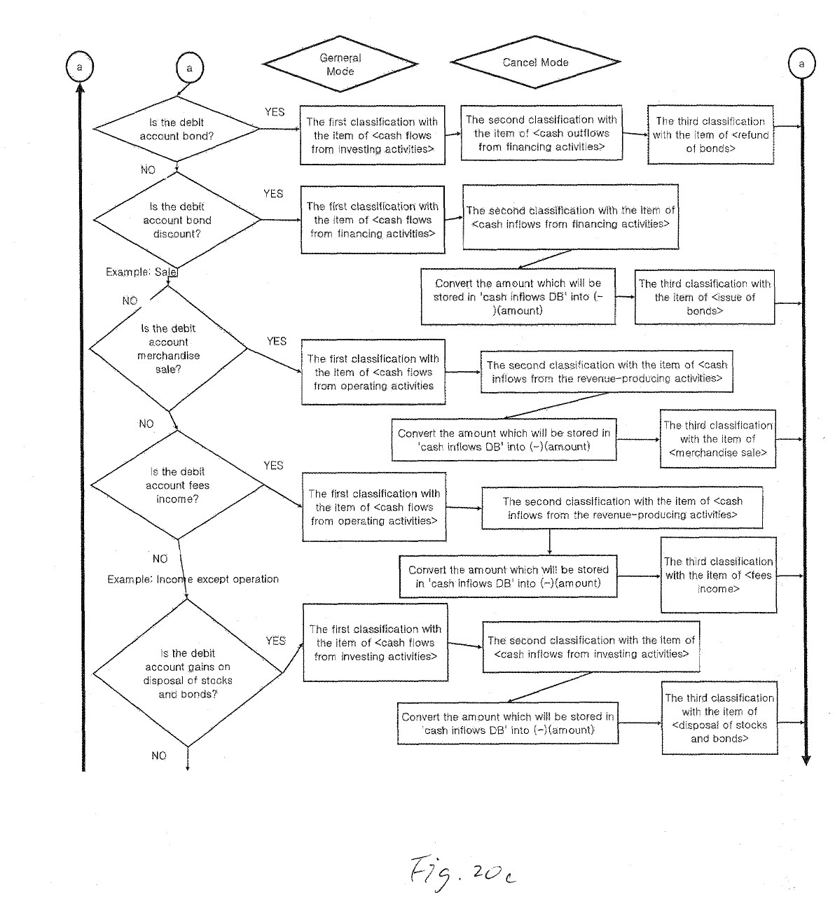

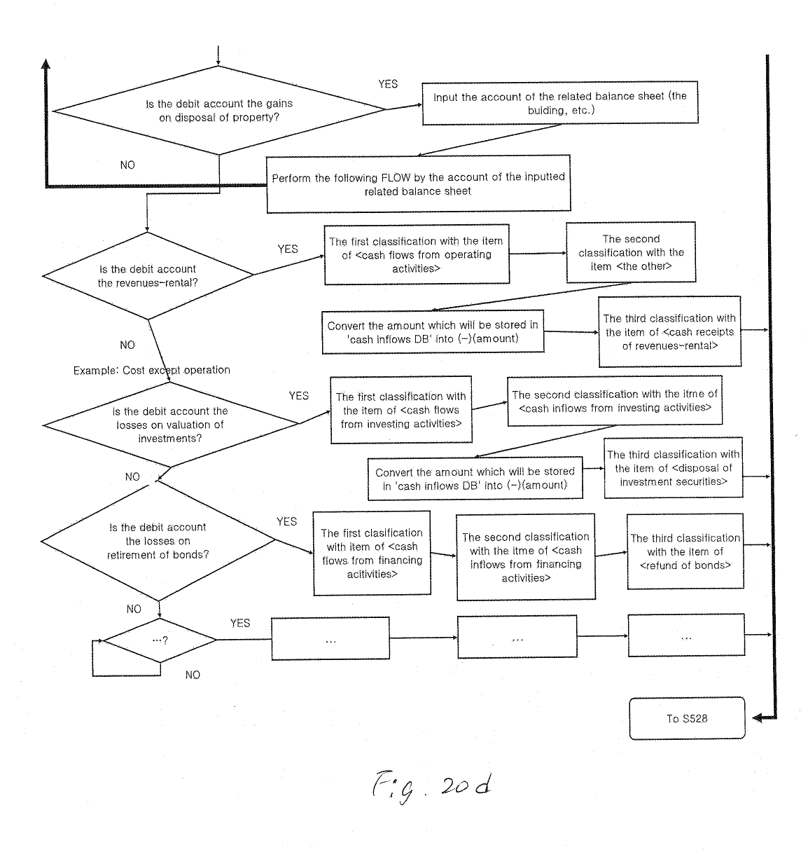

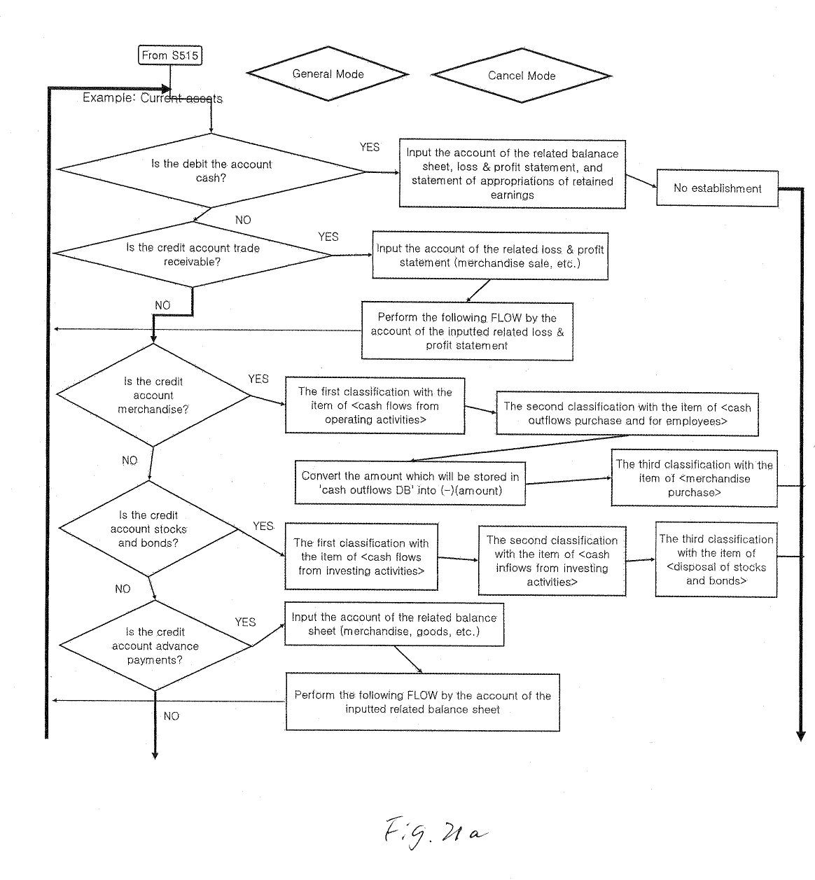

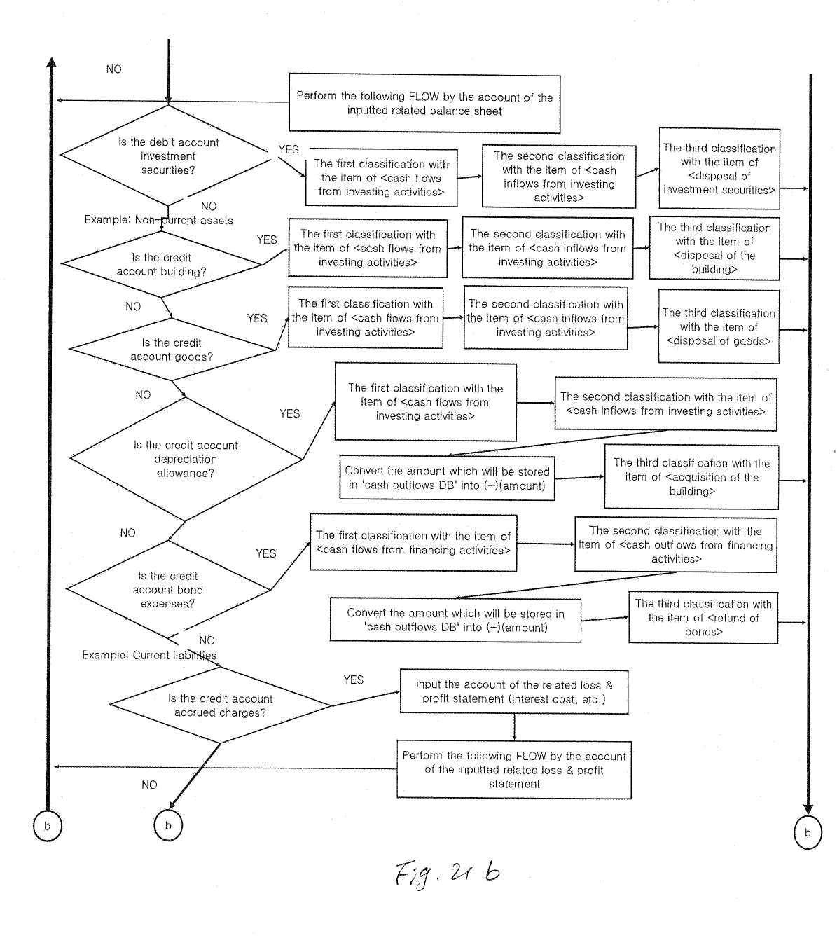

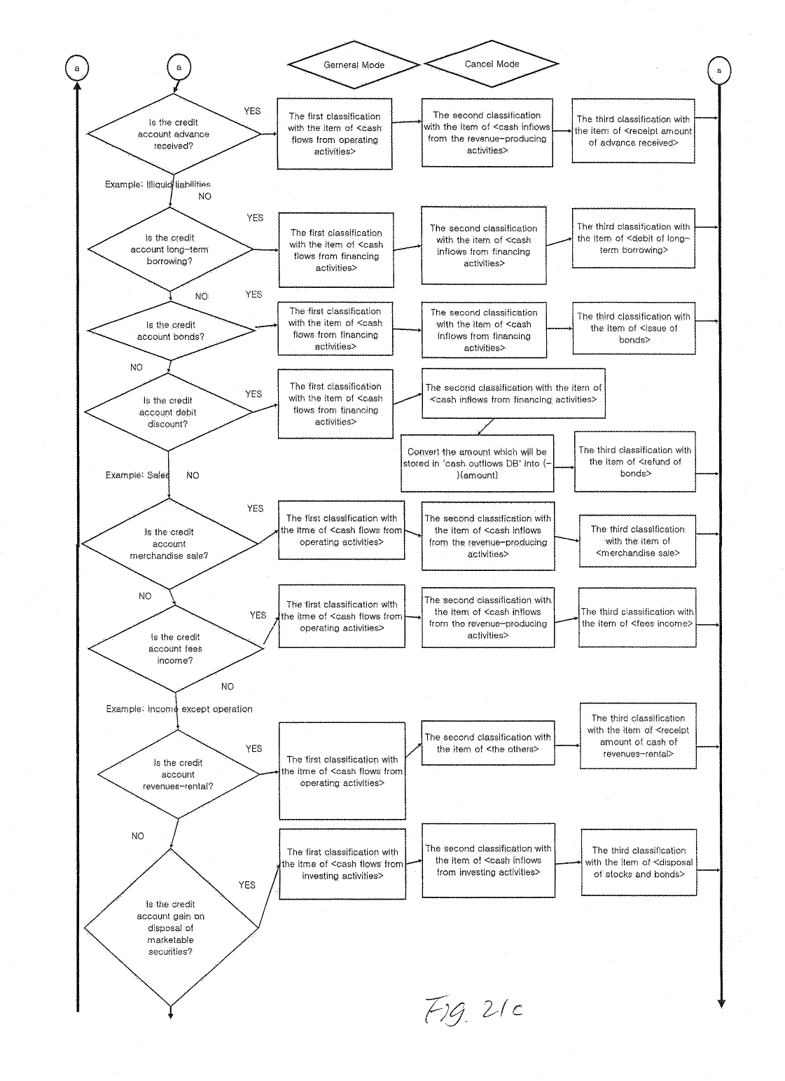

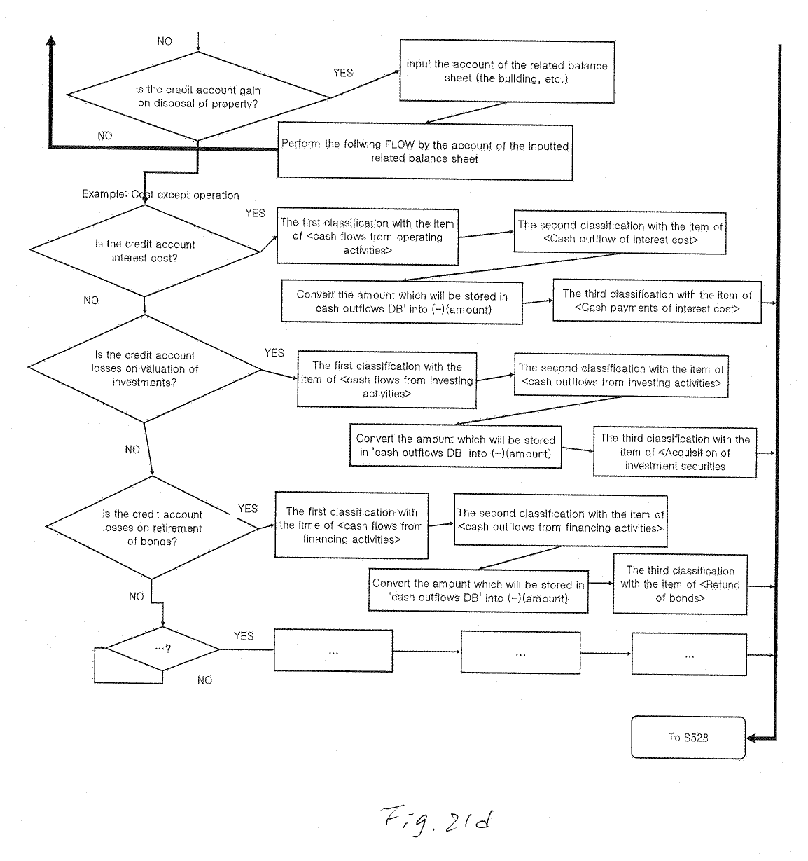

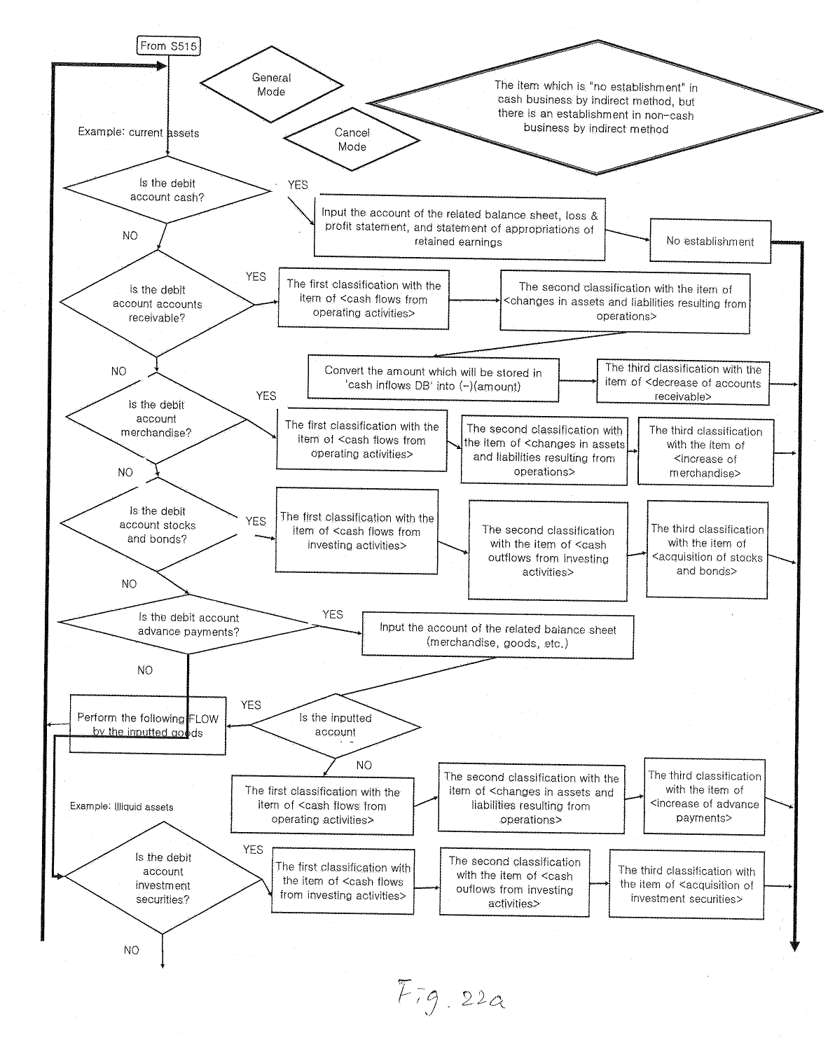

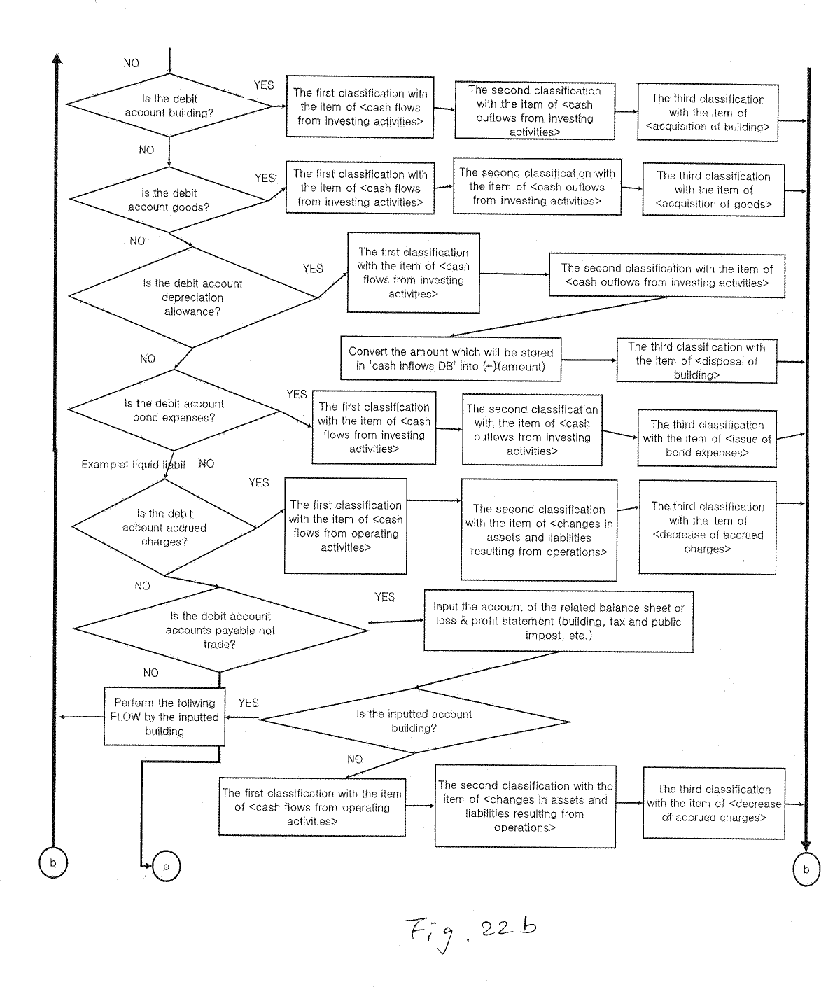

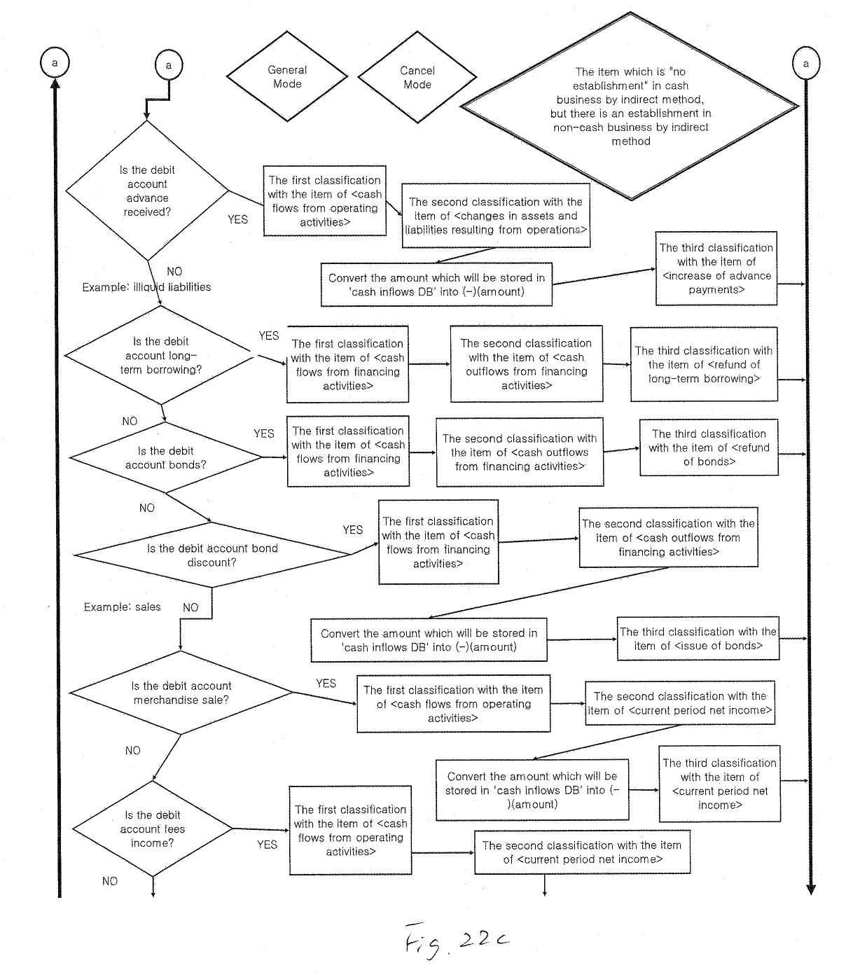

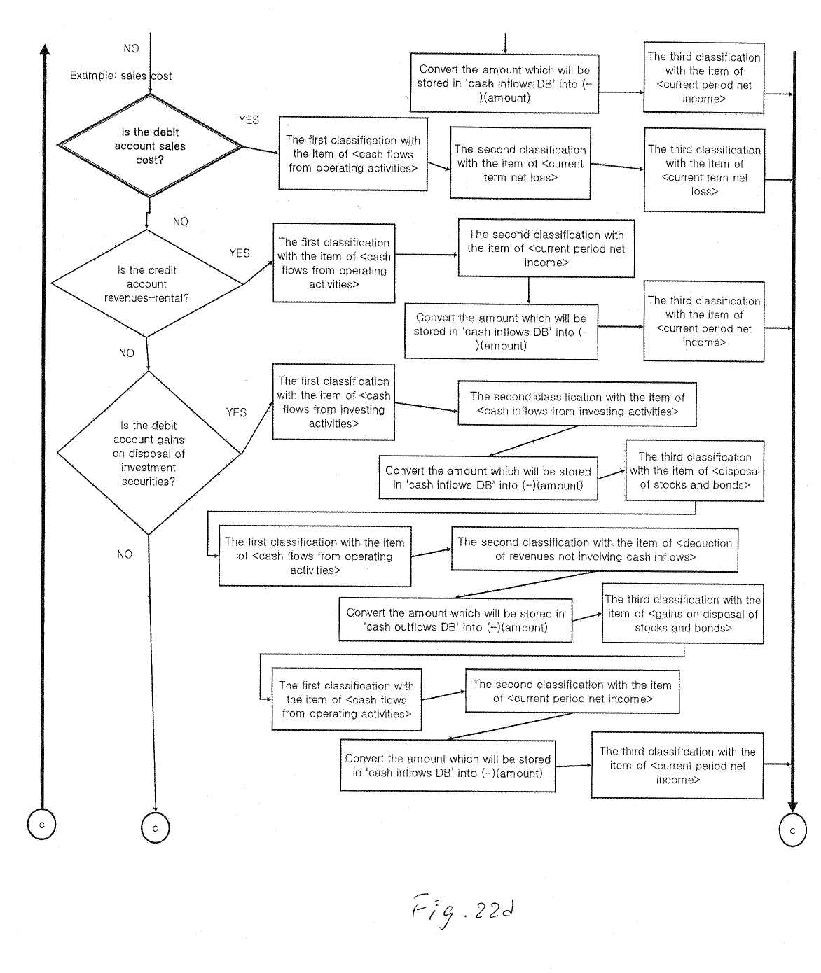

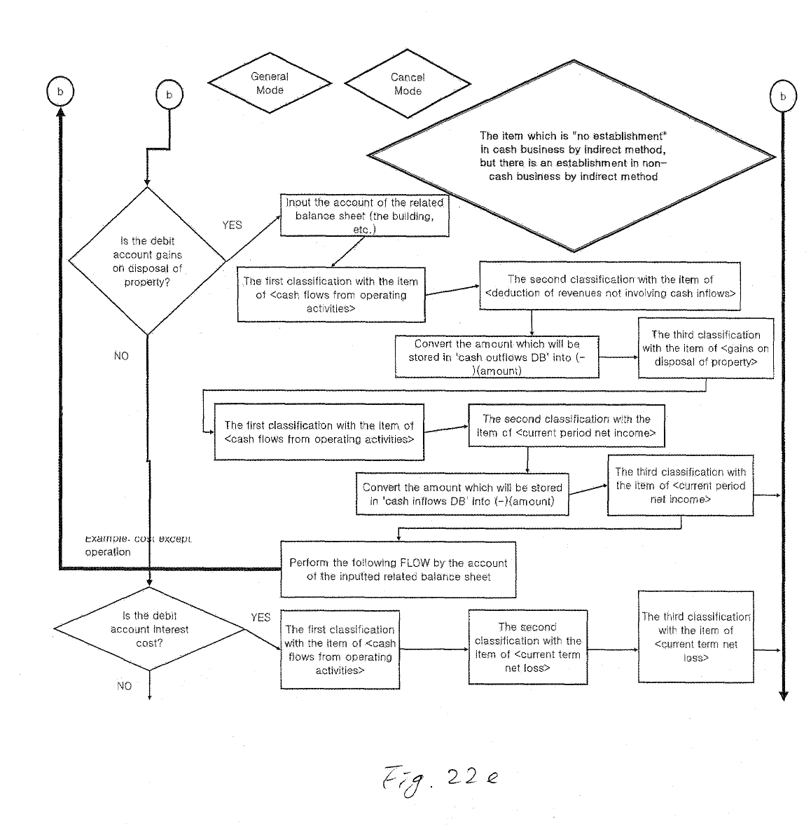

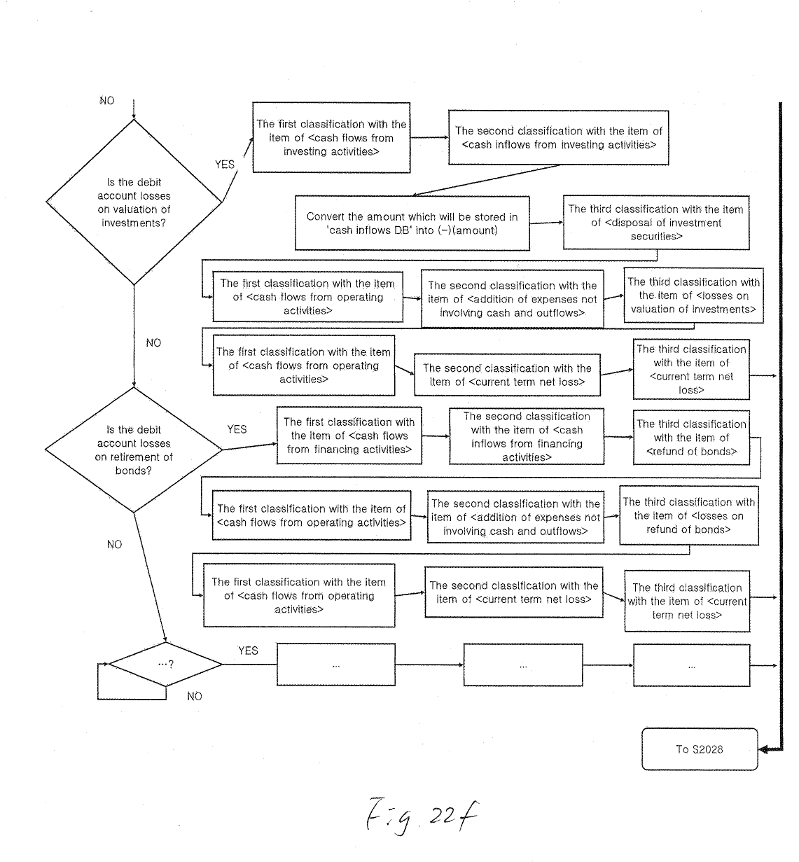

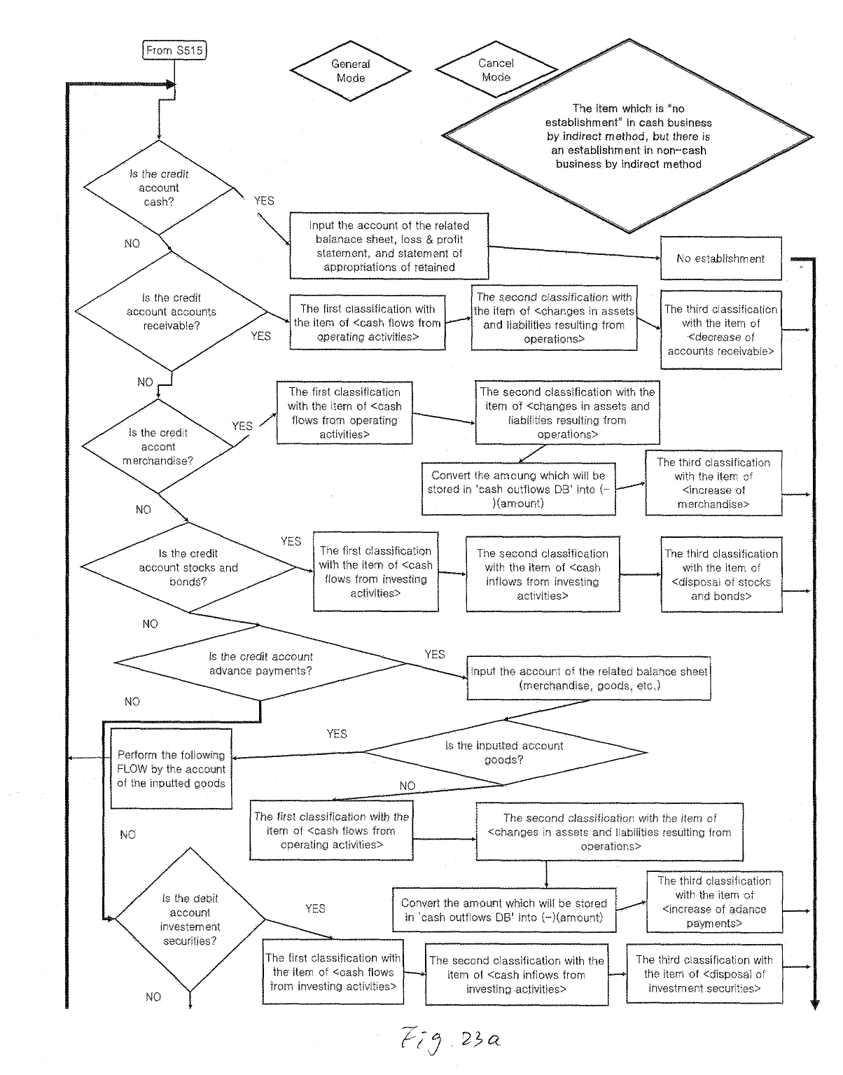

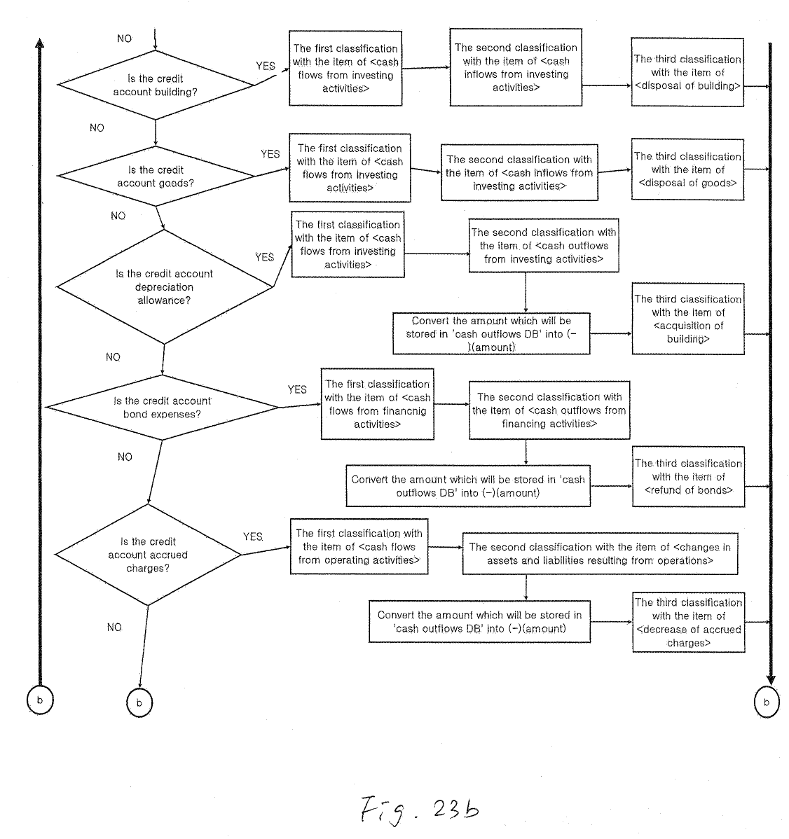

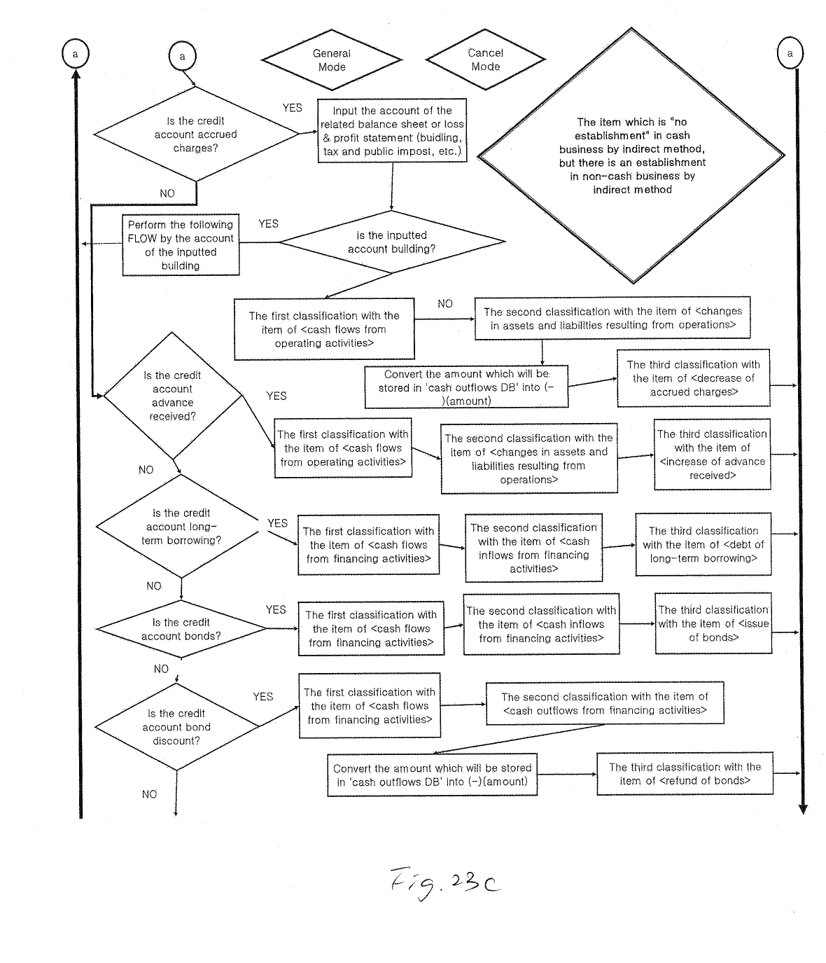

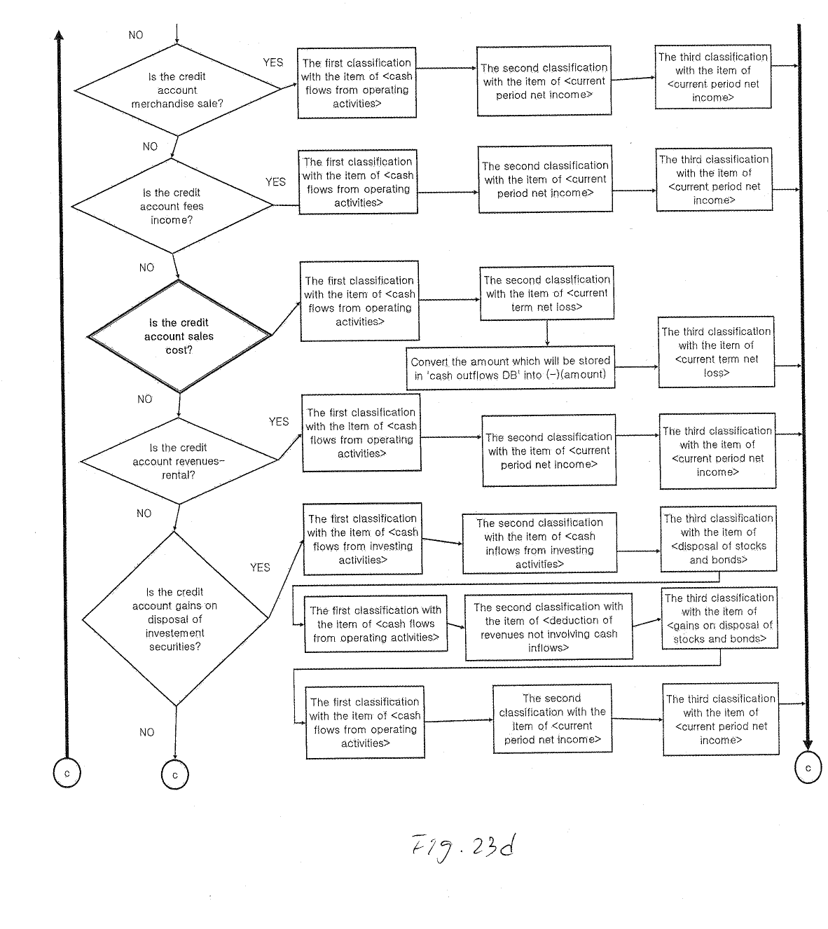

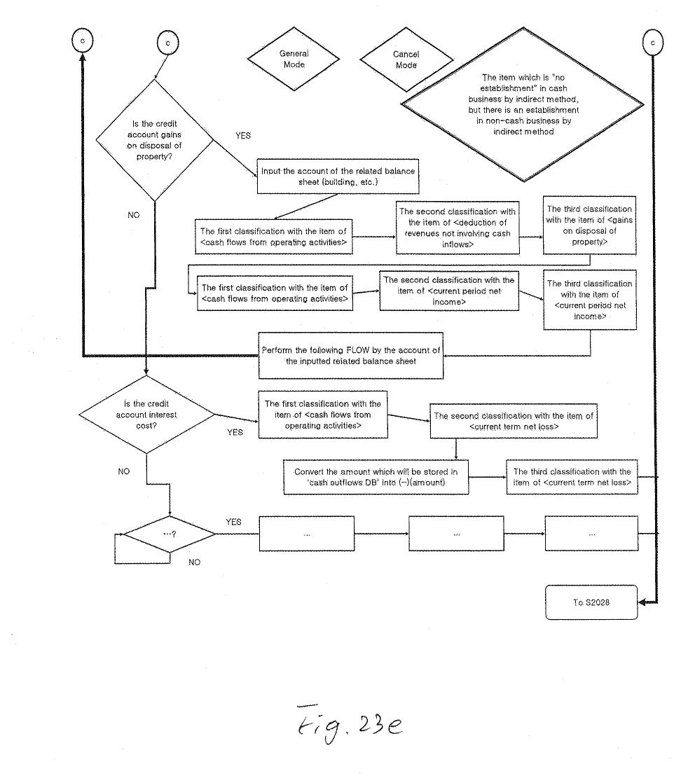

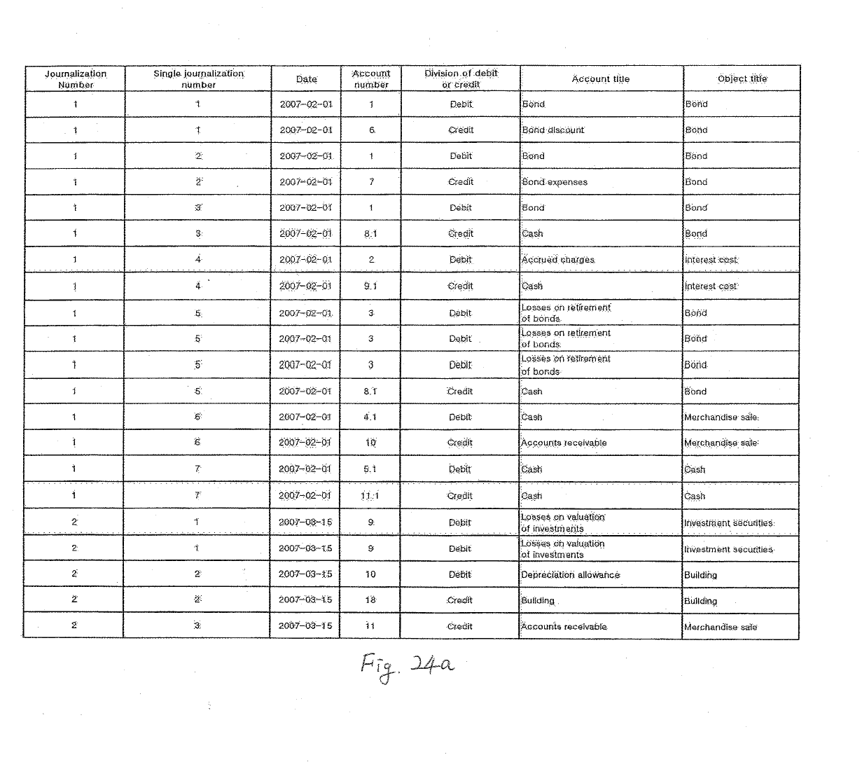

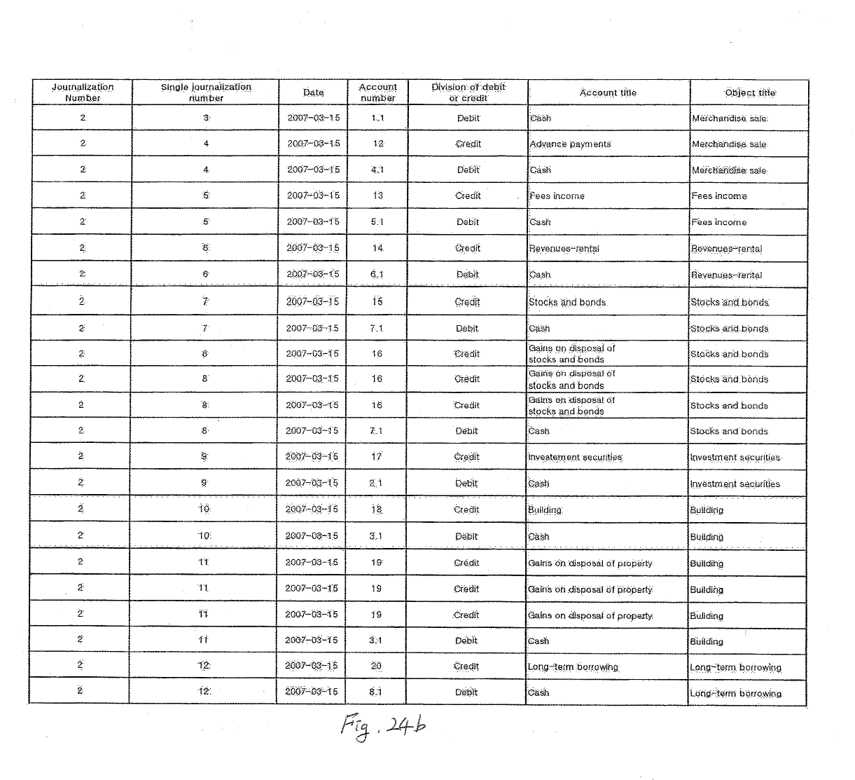

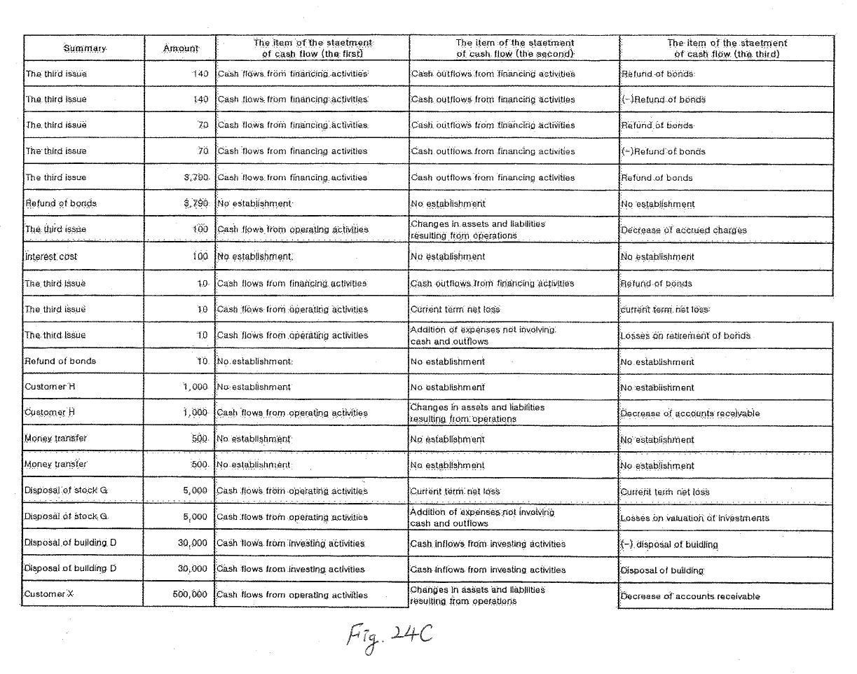

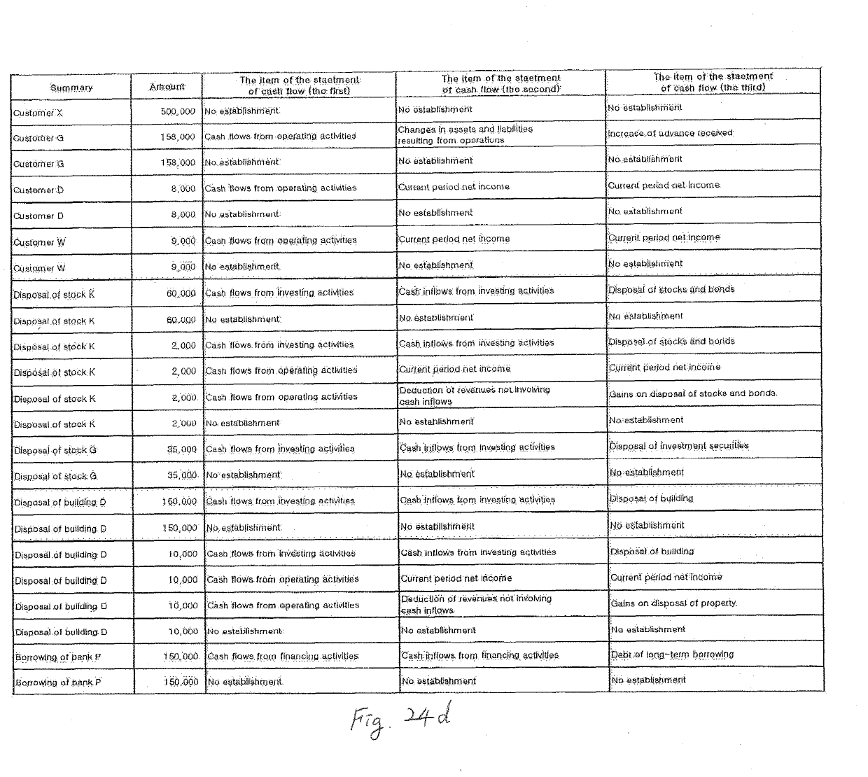

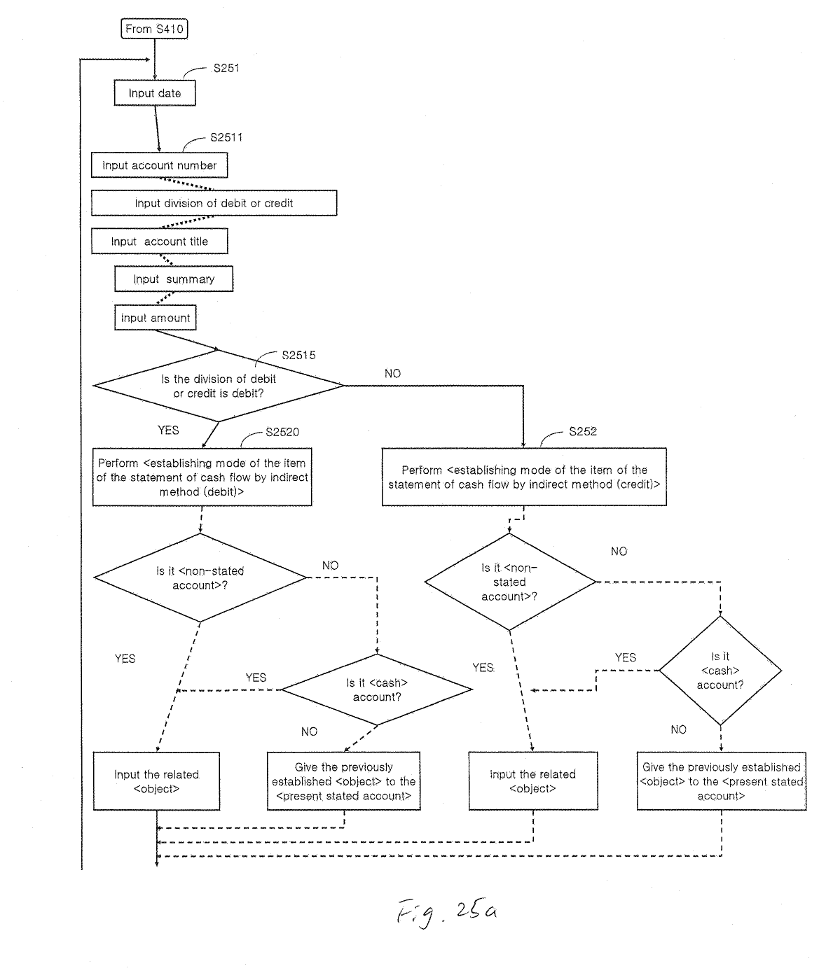

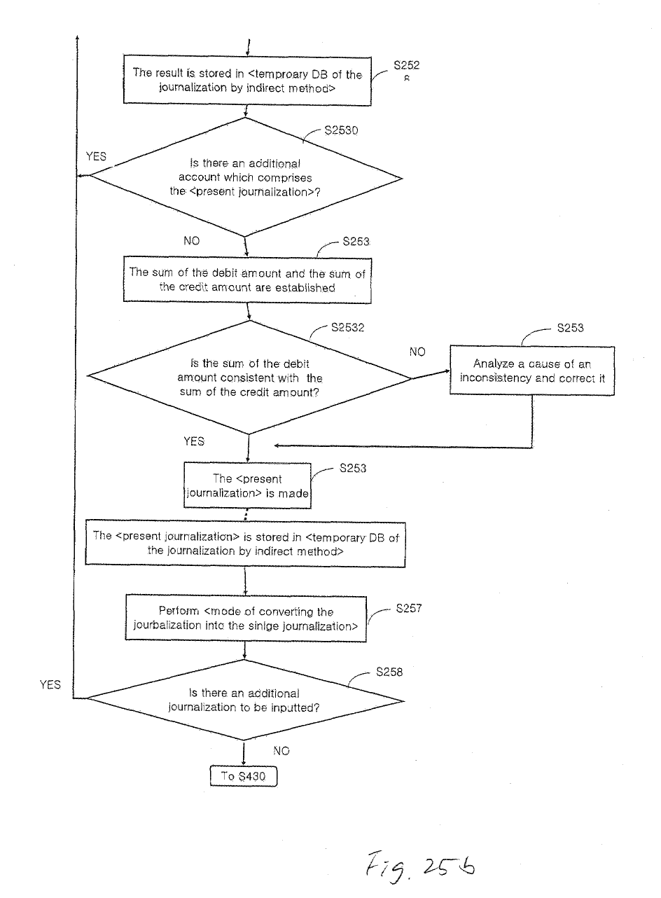

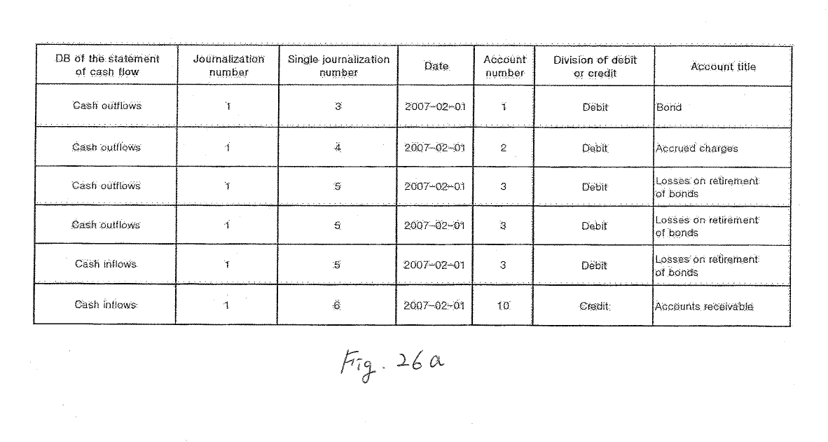

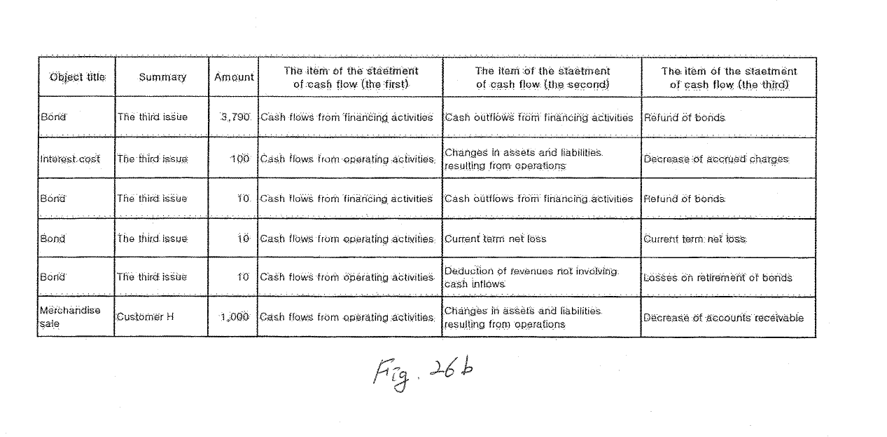

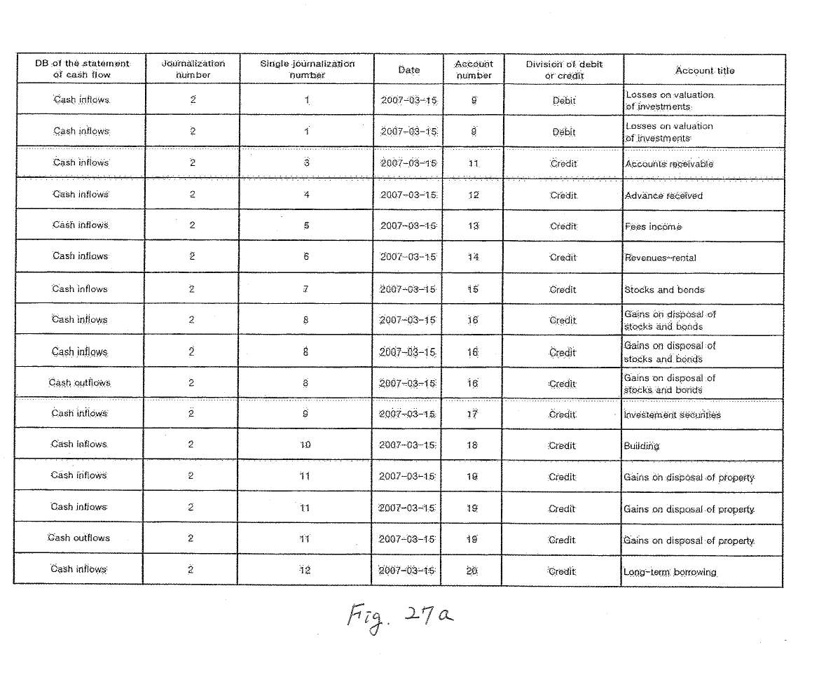

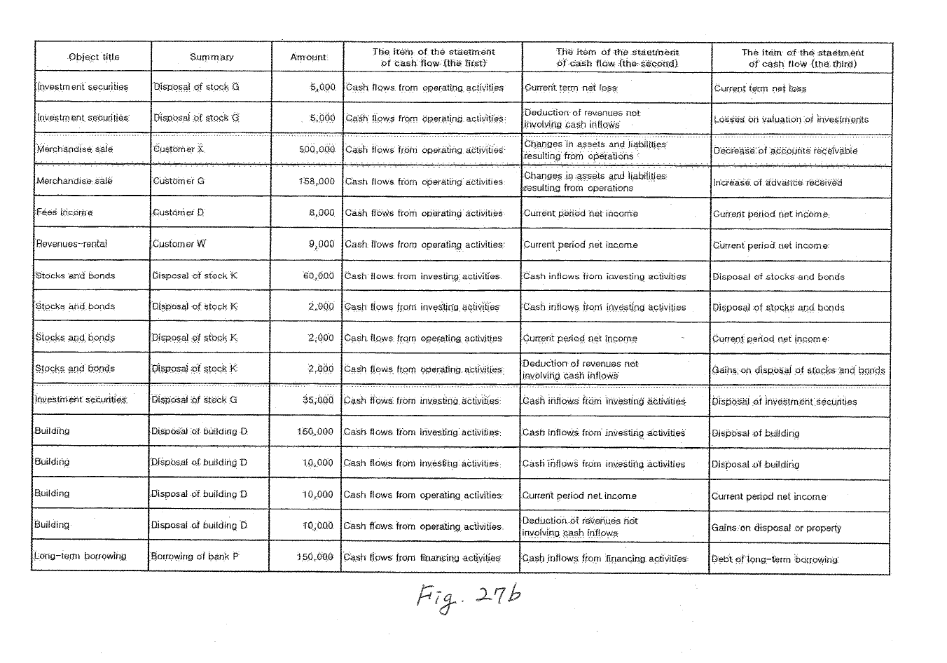

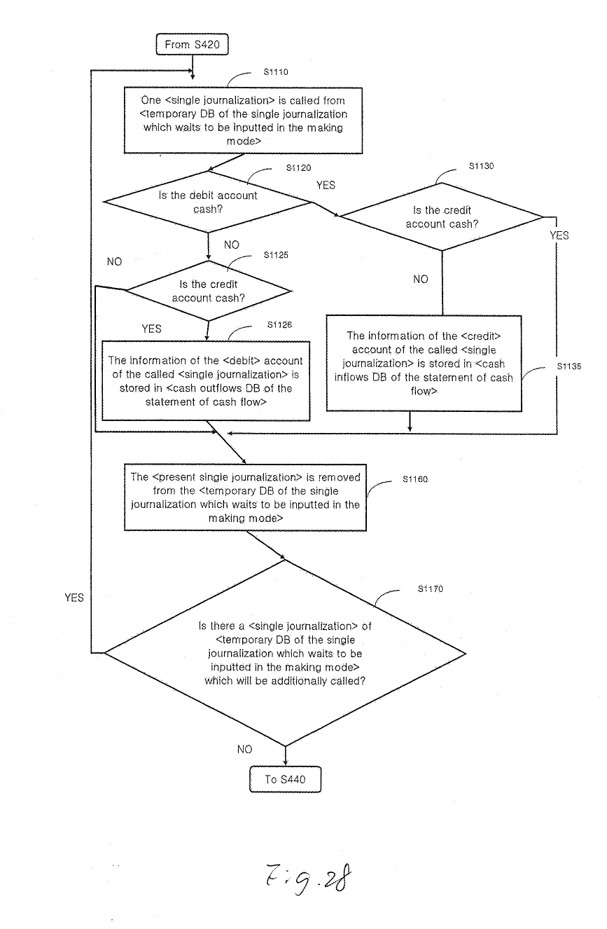

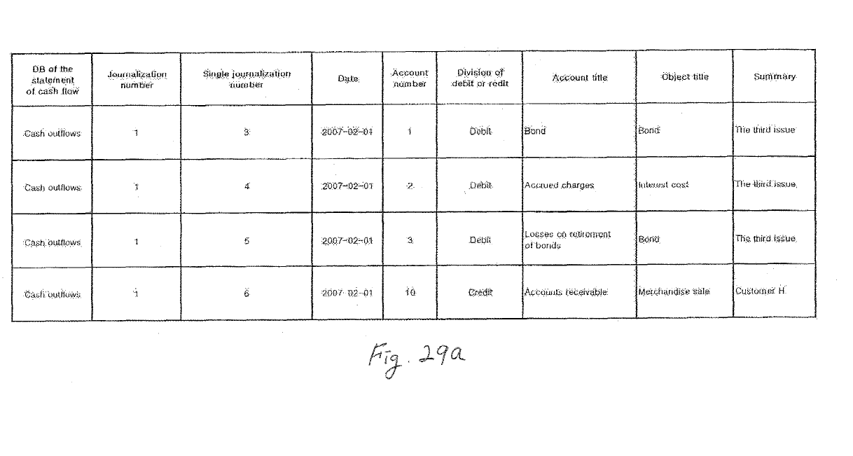

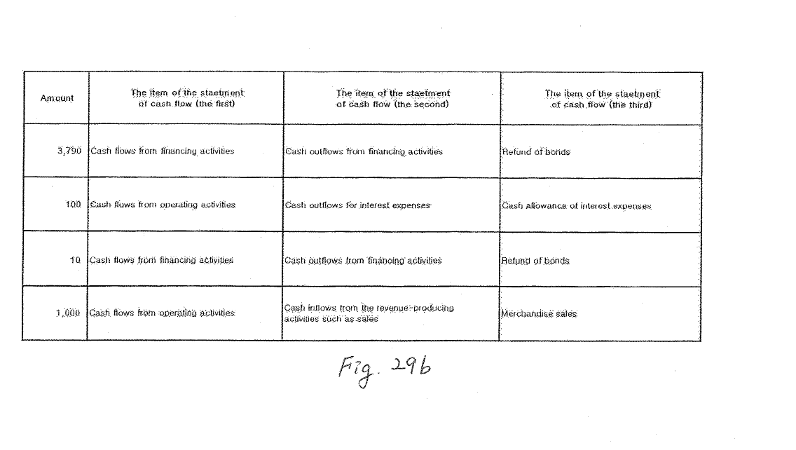

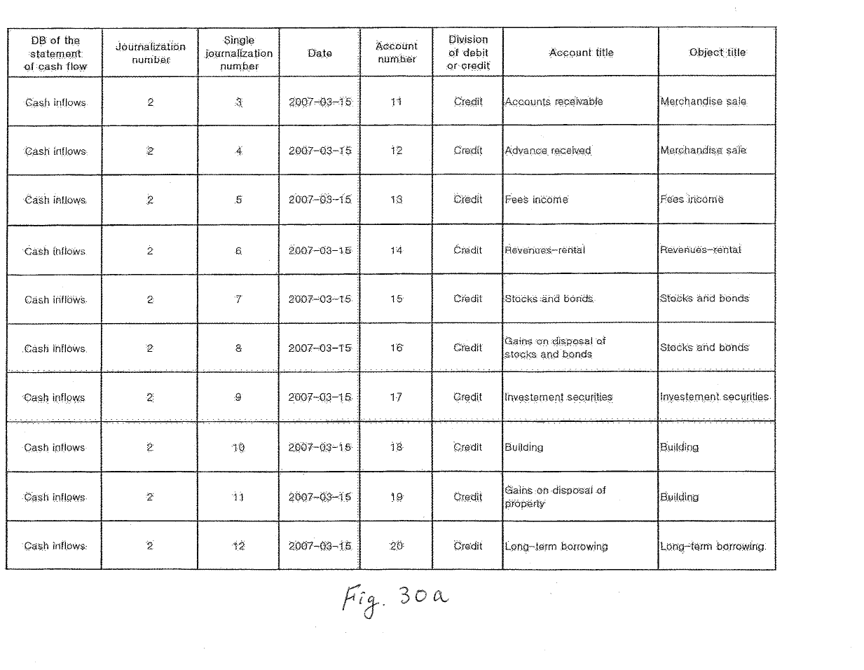

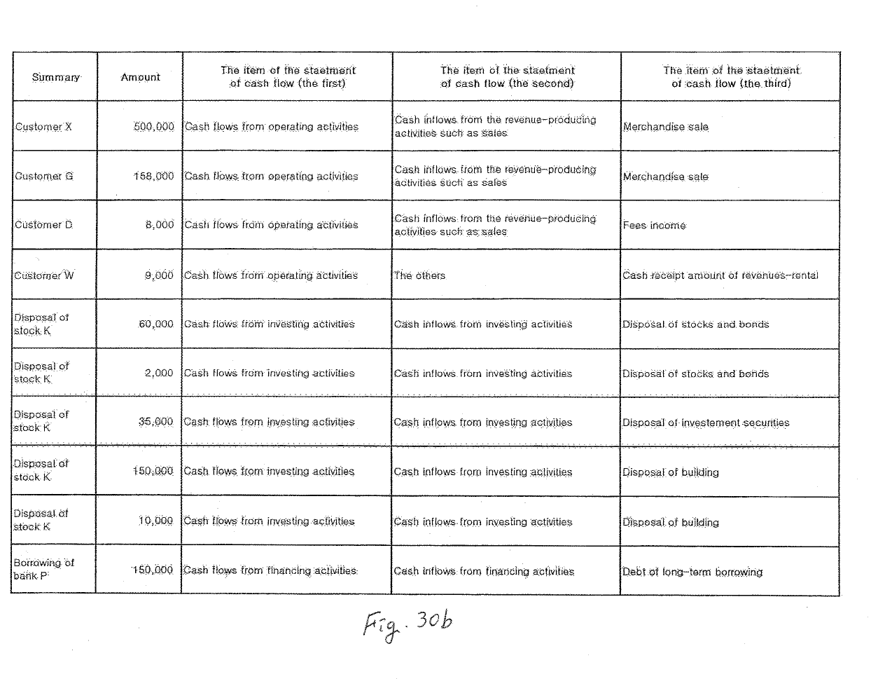

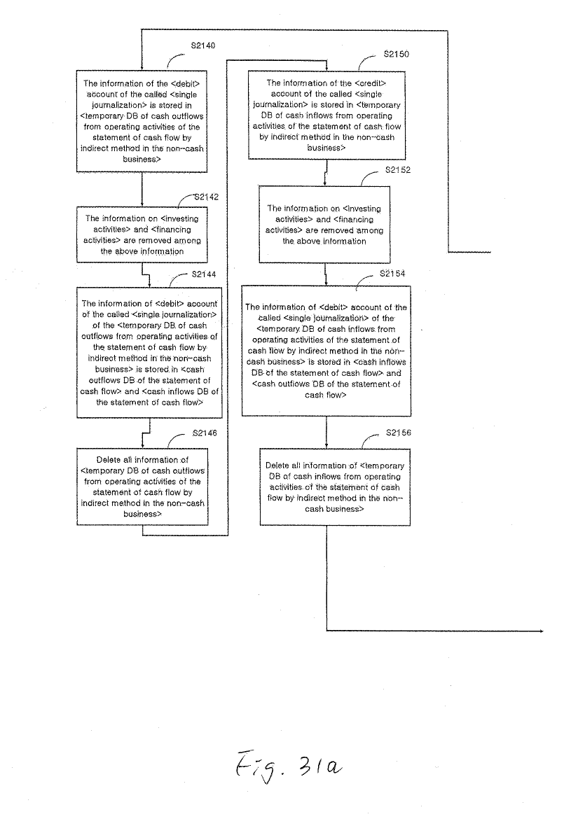

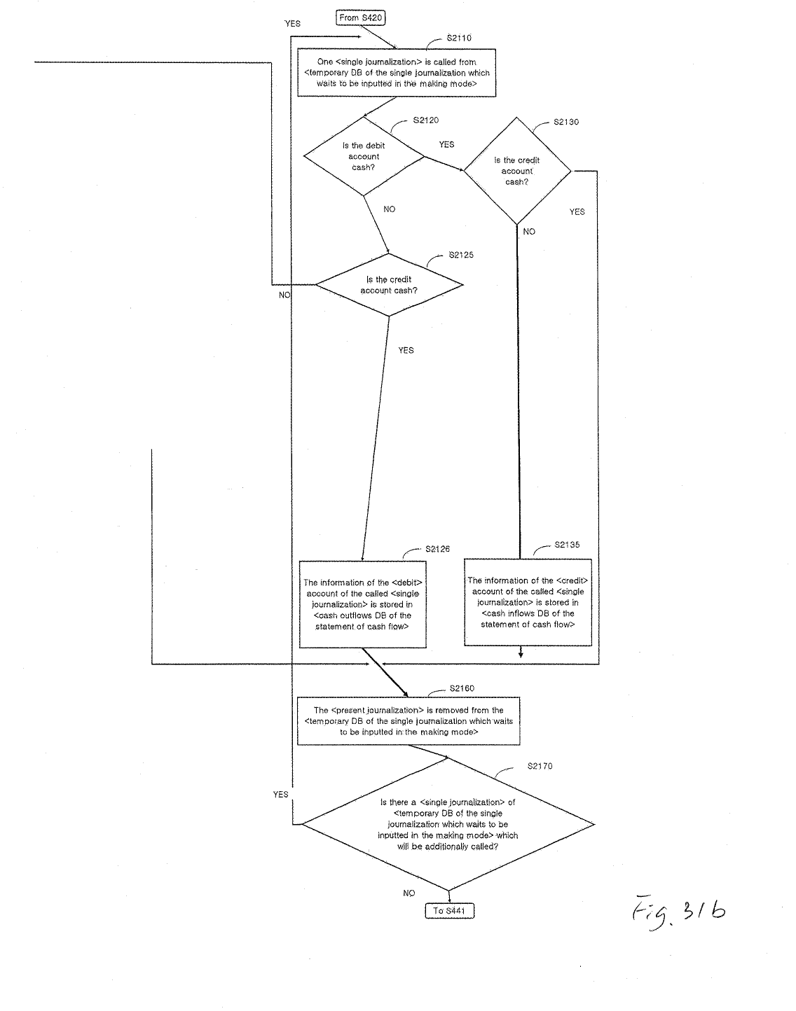

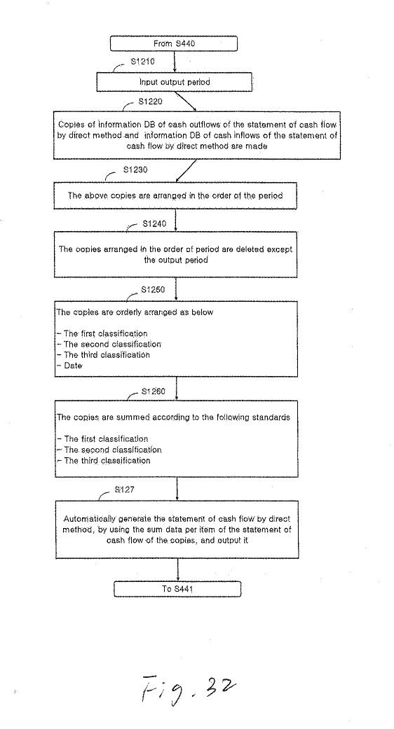

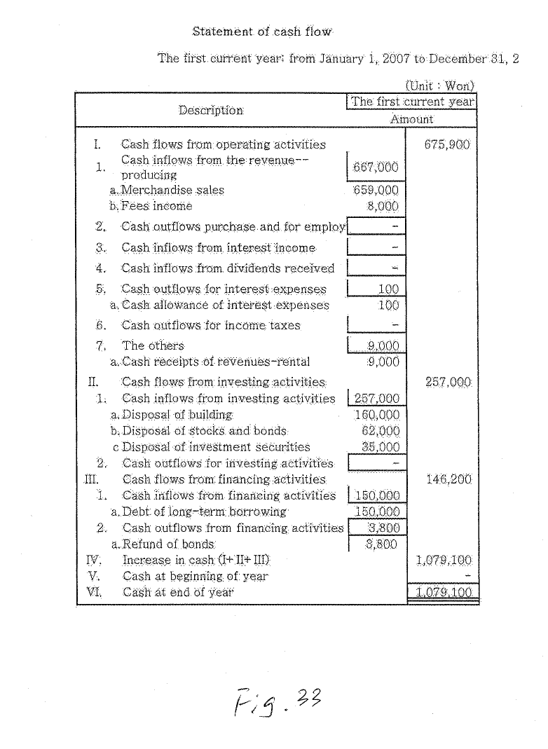

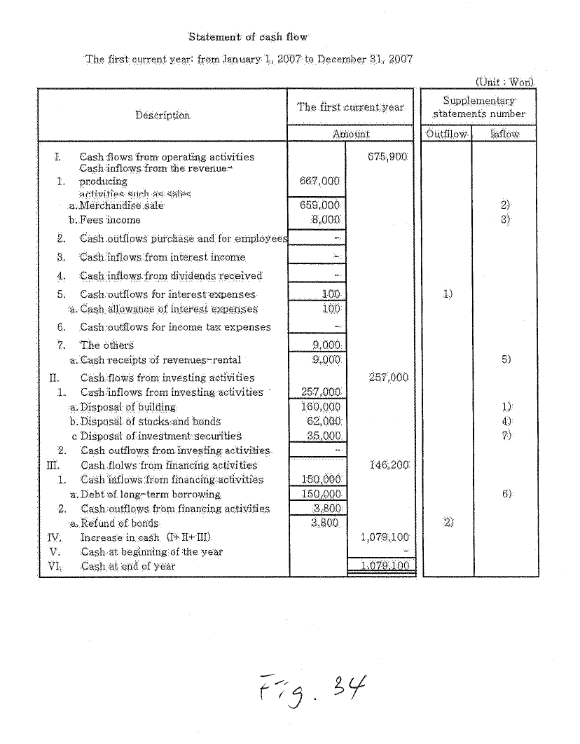

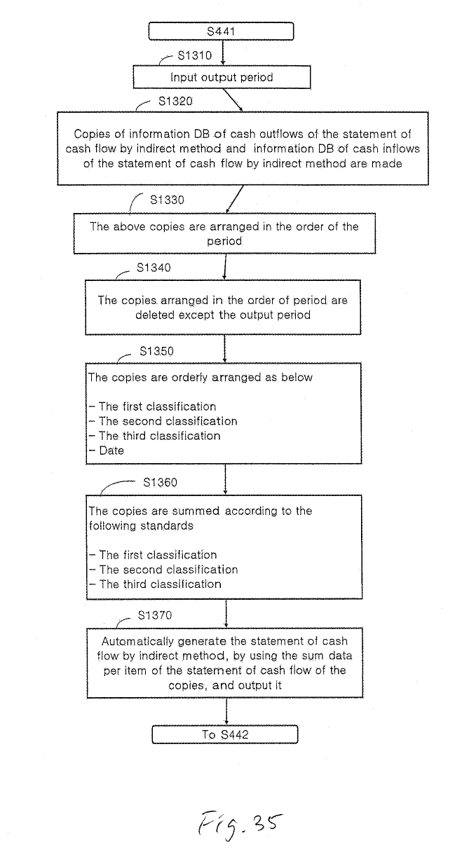

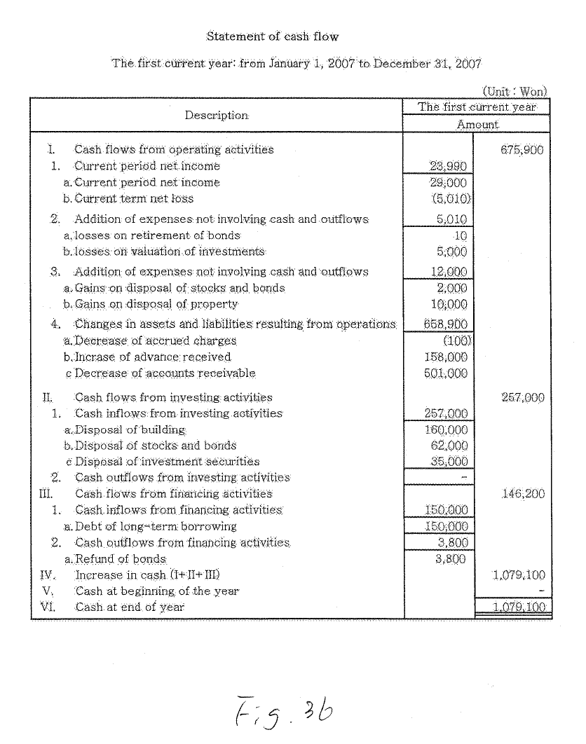

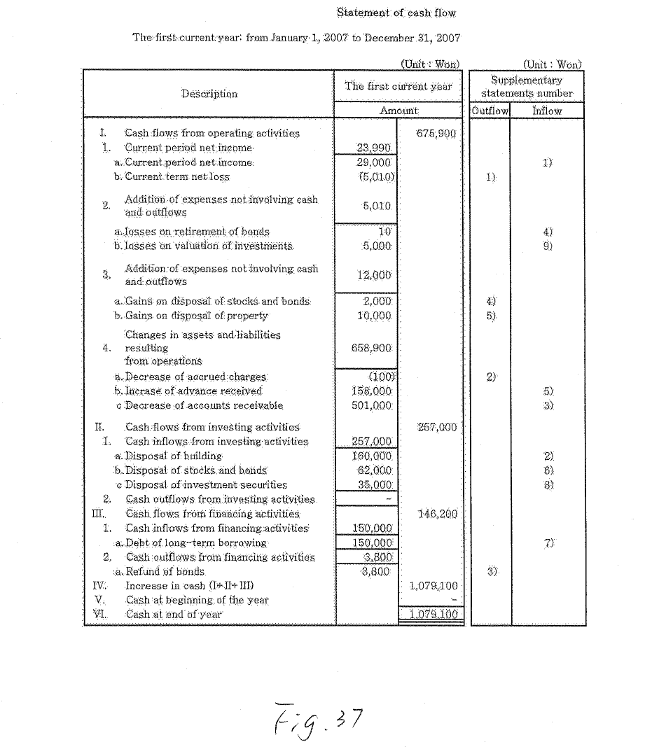

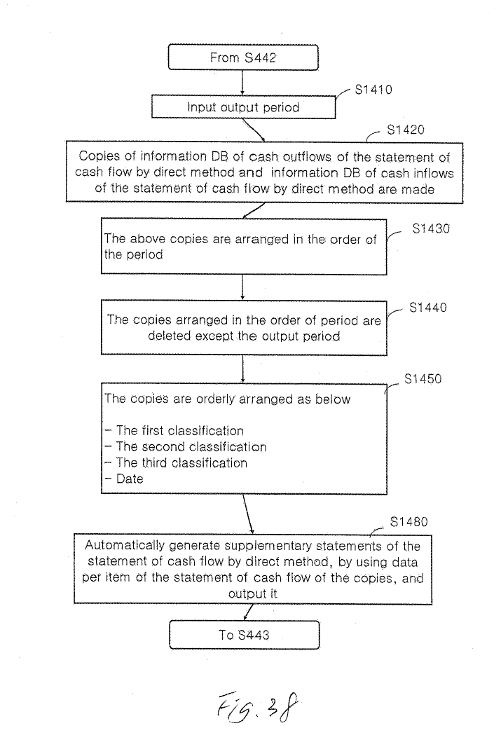

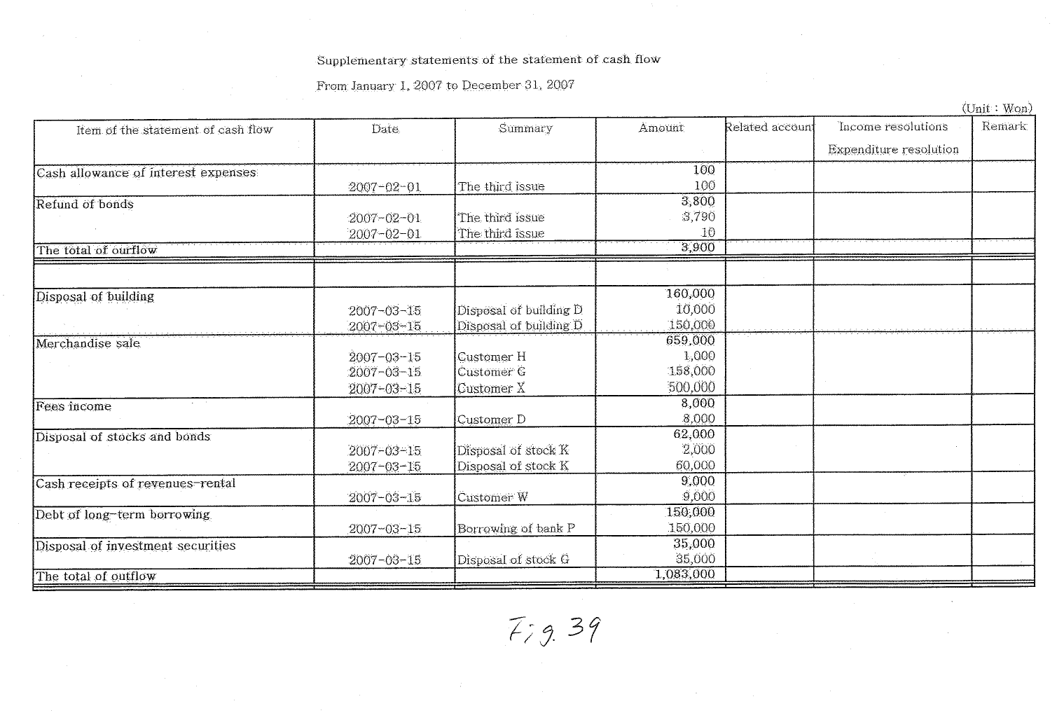

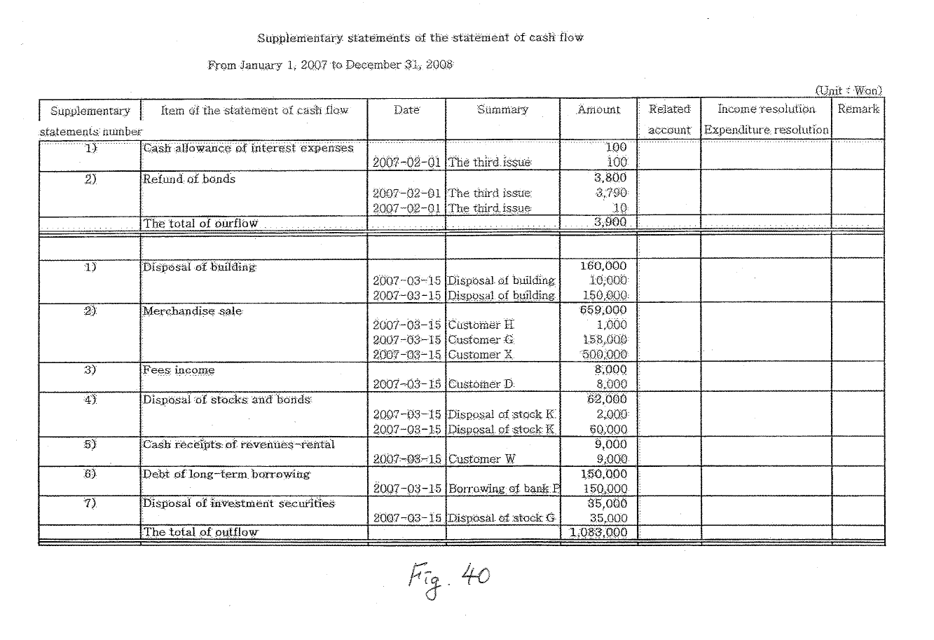

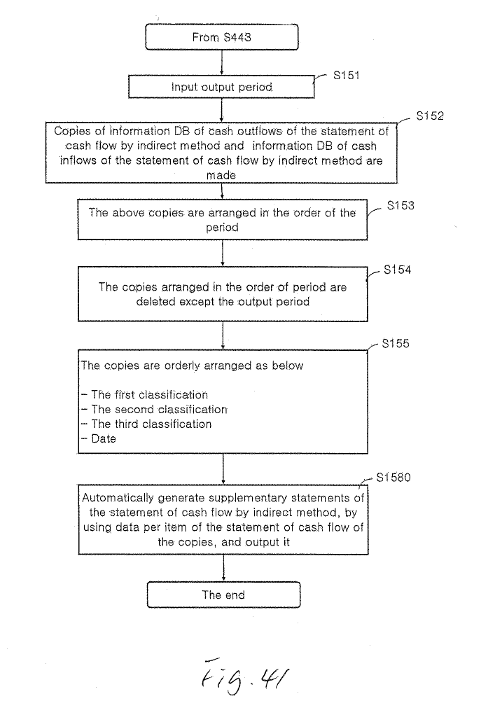

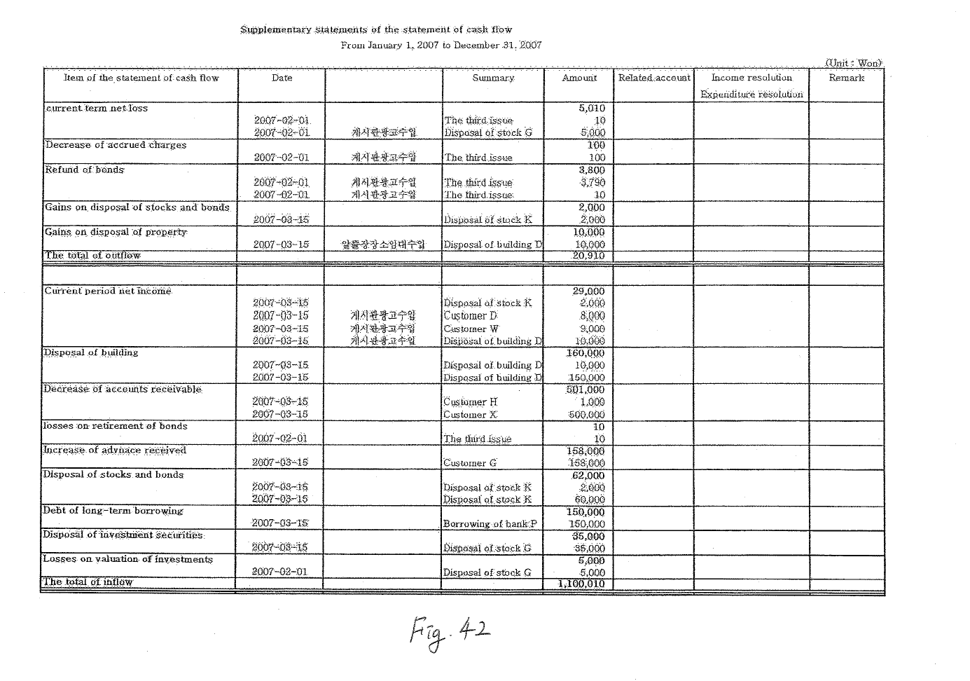

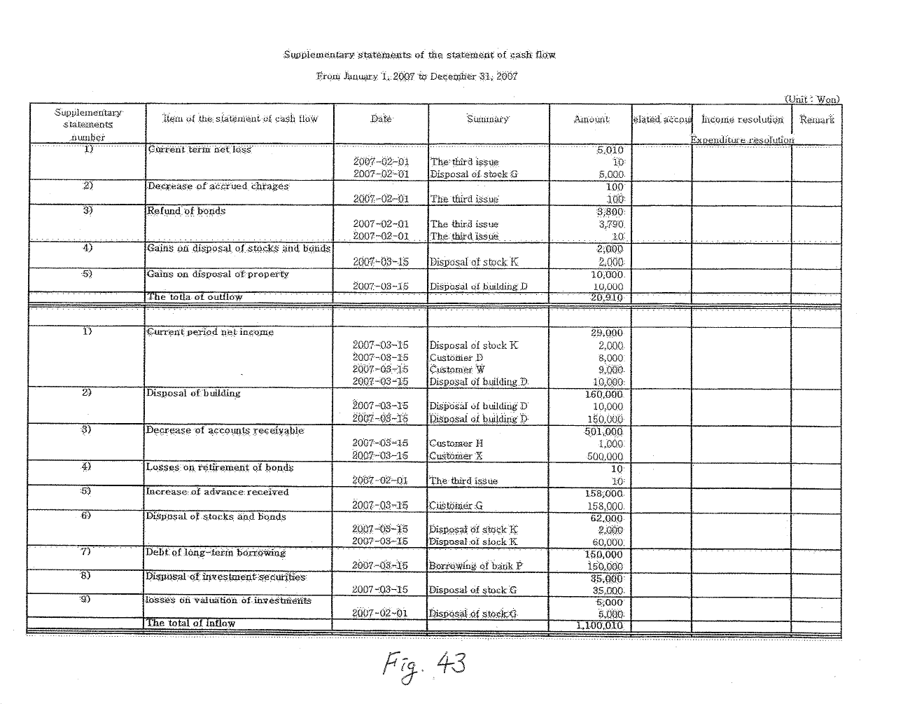

### DESCRIPTION OF REFERENCE NUMERALS

100: System for automatically providing the statement of cash flow and supplementary statements of the statement of cash flow
110: Cash outflows DB of the statement of cash flow by direct method
120: Cash inflows DB of the statement of cash flow by direct method
130: Cash outflows DB of the statement of cash flow by indirect method
135: Temporary DB of cash outflows from operating activities of the statement of cash flow by indirect method in the non-cash business
140: Cash inflows DB of the statement of cash flow by indirect method
145: Temporary DB of cash inflows from operating activities of the statement of cash flow by indirect method in the non-cash business
150: Cash flow management server
160: Information DB of the user
170: Web server
181, 182, 183: User interfaces
200: Communication networks
300: Journalization operation system
310: Account information DB
320: Accounting information DB
330: Information DB of the item of the statement of cash flow by direct method according to the resulting values of the first, the second, and the third classification.
335: Information DB of the item of the statement of cash flow by indirect method according to the resulting values of the first, the second, and the third classification.
350: Journalization operation server
351: Temporary DB of the journalization
352: Temporary DB of the copied journalization
353: Temporary DB of the single journalization which waits to be inputted in the making mode
351-1: Temporary DB of the journalization by indirect method
351-2: Temporary DB of the copied journalization by indirect method
353-1: Temporary DB of the single journalization which waits to be inputted in the making mode by indirect method

What is claimed is:

1. A method for providing a statement of cash flow and supplementary statements of the statement of cash flow, characterized in providing an item of the statement of cash flow based on cash basis, by converting inputted one journalization into a group of a single journalization when one journalization having a division of debit or credit, an account, an object, and a trading amount based on the accrual basis is inputted.

2. The method according to claim 1, wherein converting into the group of the single journalization is characterized in comparing the object of the inputted debit account with that of the credit account, and appointing them as the accounts of the debit and the credit of the single journalization when the objects are the same.

3. The method according to claim 2, wherein giving an amount of the single journalization is characterized in establishing a smaller one between the amount of the account of the debit and the amount of the account of the credit as the amount of the single journalization, and subtracting the distributed amount from the amount of the corresponding account.

4. The method according to claim 1, characterized in providing the item of the statement of cash flow, by abstracting the information of the item of the statement of cash flow according to the resulting values of the first, the second, and the third classification, which are previously appointed with regard to each account or object of the arranged single journalization.

5. The method according to claim 1, characterized in that if the debit is the cash and the credit is not the cash, provide them as the items of cash inflows, if the debit is not the cash and the credit is the cash, provide them as the items of cash outflows, and there is no provide except the above cases.

6. The method according to claim 1, characterized in that if the debit is the cash and the credit is not the cash, provide them as the items of cash inflows, if the debit is not the cash and the credit is the cash, provide them as the items of cash outflows, if the debit is the cash and the credit is the cash, provide them as the items of cash inflows and cash outflows, and there is no provide except the above cases.

7. The method according to claim 5, characterized in further comprising the step of directly making the statement of cash flow by using the provided items of the statement of cash flow.

8. The method according to claim 5, characterized in further comprising the step of directly making the supplementary statements of the statement of cash flow by using the provided items of the statement of cash flow.

9. The method according to claim 1, characterized in further receiving the item of the statement of cash flow by indirect method, by receiving cash flows from investing activities and cash flows from financial activities from the single journalization, having the cash account only at one side between the debit account and credit account, which the corporation previously traded, and by receiving cash flows from operating activities from the single journalization having the cash account only at one side between the debit account and credit account, which the corporation previously traded, and from a part of the single journalization having the non-cash account at both sides of the debit account and credit account, which the corporation previously traded.

10. A system for providing the statement of cash flow and supplementary statements of the statement of cash flow, which is connected with the user interfaces, in which the account information, the accounting information, and the information of the item of the statement of cash flow according to the resulting values of the first, the second, and the third classification become database and are previously stored, and is connected with the journalization operation system, wherein the journalization operation system is characterized in providing the item of the statement of cash flow based on cash basis, by converting inputted one journalization into a group of the single journalization when one journalization having the division of debit or credit, the account, the object, and the amount based on accrual basis is inputted through the user interfaces.

11. The system according to claim 10, wherein the account information comprises the division of debit or credit, the account, and the code data of the object.

12. The system according to claim 10, wherein the accounting information comprises the journalization number, the trading date (or trading time), the account number, the division of debit or credit, the account, the object, and the item of the business amount.

13. The system according to claim 10, wherein converting into the group of the single journalization is characterized in comparing the object of the inputted debit account with that of the credit account, and appointing them as the accounts of the debit and the credit of the single journalization when the objects are the same.

14. The system according to claim 13, wherein giving an amount of the single journalization is characterized in establishing a smaller one between the amount of the account of the debit and the amount of the account of the credit as the amount of the single journalization, and subtracting the distributed amount from the amount of the corresponding account.

15. The system according to claim 10, characterized in providing the item of the statement of cash flow, by abstracting the information of the item of the statement of cash flow according to the resulting values of the first, the second, and the third classification, which are previously appointed with regard to each account or object of the arranged single journalization.

16. The system according to claim 10, characterized in that if the debit is the cash and the credit is not the cash, provide them as the items of cash inflows, if the debit is not the cash and the credit is the cash, provide them as the items of cash outflows, and there is no provide except the above cases.

17. The system according to claim 10, characterized in that if the debit is the cash and the credit is not the cash, provide them as the items of cash inflows, if the debit is not the cash and the credit is the cash, provide them as the items of cash outflows, if the debit is the cash and the credit is the cash, provide them as the items of cash inflows and cash outflows, and there is no provide except the above cases.

18. The system according to claim 16, characterized in further comprising the step of directly making the statement of cash flow by using the provided items of the statement of cash flow.

19. The system according to claim 16, characterized in further comprising the step of directly making the supplementary statements of the statement of cash flow by using the provided items of the statement of cash flow.

20. The system according to claim 10, characterized in further receiving the item of the statement of cash flow by indirect method, by receiving cash flows from investing activities and cash flows from financial activities from the single journalization, having the cash account only at one side between the debit account and credit account, which the corporation previously traded, and by receiving cash flows from operating activities from the single journalization having the cash account only at one side between the debit account and credit account, which the corporation previously traded, and from a part of the single journalization having the non-cash account at both sides of the debit account and credit account, which the corporation previously traded.
